(19) United States
(12) Patent Application Publication
(10) Pub. No.: US 2014/0027683 A1
(43) Pub. Date: Jan. 30, 2014

(54) COLORED COMPOSITION, COLORED CURED FILM, COLOR FILTER, METHOD FOR PRODUCING COLOR FILTER, LIQUID CRYSTAL DISPLAY DEVICE, SOLID-STATE IMAGING DEVICE, AND NOVEL DIPYRROMETHENE METAL COMPLEX COMPOUND OR TAUTOMER THEREOF

(71) Applicant: FUJIFILM CORPORATION, Tokyo (JP)

(72) Inventor: Daisuke SASAKI, Shizuoka-ken (JP)

(73) Assignee: FUJIFILM CORPORATION, Tokyo (JP)

(21) Appl. No.: 14/042,730

(22) Filed: Oct. 1, 2013

Related U.S. Application Data
(63) Continuation of application No. PCT/JP2012/059013, filed on Apr. 2, 2012.

(30) Foreign Application Priority Data
Apr. 4, 2011 (JP) 2011-082425

(51) Int. Cl. G02B 1/04

(52) U.S. Cl. CPC G02B 1/04
USPC 252/586; 548/403; 430/5

(57) ABSTRACT

A colored composition includes at least one selected from the group consisting of a compound represented by the following Formula (I) and a tautomer thereof:

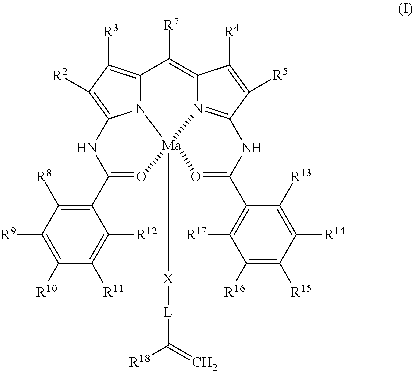

wherein, in Formula (I), R² to R⁵ and R⁸ to R¹⁷ each independently represent a hydrogen atom or a monovalent substituent; pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring; R⁷ represents a hydrogen atom, a halogen atom, an alkyl group, an aryl group, or a heterocyclic group; Ma represents a metal or a metal compound; X represents a group necessary for neutralizing the charge of Ma; L represents a single bond or a divalent linking group; and R¹⁸ represents a hydrogen atom or a methyl group.

### CROSS-REFERENCE TO RELATED APPLICATIONS

This application is a continuation application of International Application No. PCT/JP2012/059013, filed Apr. 2, 2012, the disclosure of which is incorporated herein by reference in its entirety. Further, this application claims priority from Japanese Patent Application No. 2011-082425, filed Apr. 4, 2011, the disclosure of which is incorporated herein by reference in its entirety.

### TECHNICAL FIELD

The present invention relates to a colored composition, a colored cured film, a color filter, a method for producing a color filter, a liquid crystal display device, a solid-state imaging device, and a novel dipyrromethene metal complex compound or a tautomer thereof.

### BACKGROUND ART

Conventionally, color filters are produced by preparing a colored composition including a pigment dispersion composition obtained by dispersing an organic pigment or an inorganic pigment, a polyfunctional monomer, a polymerization initiator, an alkali-soluble resin and, as necessary, other components, and forming a colored pattern using the colored composition in accordance with photolithography, an inkjet method, or the like.

Recently, there is a trend toward greater utilization of color filters not only in monitors but also in televisions (TVs) in the application to liquid crystal display devices (LCDs). With the trend of this expanding utilization, color filters are required to have high-grade color characteristics in terms of chromaticity, contrast, and the like. Further, also concerning color filters for use in image sensors (solid-state imaging devices), there has been a demand for further improvement in color characteristics such as reduction of color unevenness or improvement of color resolution.

However, color filters using conventional pigment dispersion systems tend to cause problems such as occurrence of scattering due to coarse particles of a pigment or an increase in viscosity due to poor dispersion stability, and thus, it is often difficult to further improve contrast and brightness.

Therefore, not only the use of a pigment but also the use of a dye as a coloring agent has been conventionally studied (see, for example, Japanese Patent Application Laid-Open (JP-A) No. H6-75375). It is said that the use of a dye as a coloring agent is useful since the hue or brightness of the display image in displaying an image can be improved due to the color purity of the dye itself or the vividness of its hue, and also the contrast can be improved because of nonexistence of coarse particles.

As examples of the dye, compounds having various kinds of dye base including a dipyrromethene dye, a pyrimidine azo dye, a pyrazole azo dye, a xanthene dye, and the like are known (see, for example, JP-A Nos. 2008-292970, 2007-039478, and Japanese Patent No. 3387541).

### SUMMARY OF INVENTION

### Technical Problem

However, in a case in which a dye is used in a colored composition for producing a color filter, as compared with the case of using a conventional pigment, deterioration in light resistance and heat resistance is likely to occur and, when a color filter including a dye is applied to a liquid crystal display device, lowering of voltage holding ratio is likely to occur. Particularly, since the lowering of voltage holding ratio causes a raise in drive voltage, an increase in power consumption, deterioration in contrast, display unevenness, or discoloration, it is desired to reduce the amount of dye used, if at all possible.

Further, with regard to the above compounds which are conventionally known dyes, in the case of producing a color filter by using a colored composition including the compound, the heat resistance is insufficient and, when the color filter is applied to a liquid crystal display device, the voltage holding ratio is insufficient, and improvement in display image quality has been demanded.

The present invention has been made in view of the above circumstances and aims to accomplish the following. Namely, the object of the present invention is to provide a colored composition which is useful for the production of a color filter, has high color purity, can be formed into a thin film having a high absorption coefficient, can be formed into a colored film having excellent fastness (especially, heat resistance and light resistance), and provides an excellent voltage holding ratio when voltage is applied to a liquid crystal display device equipped with a color filter having the colored film; a colored cured film obtained by using the colored composition; a color filter and a method for producing the same; a liquid crystal display device which provides a display image with vivid colors and high contrast; and a solid-state imaging device with reduced color unevenness and improved color resolution.

Furthermore, the present invention has the object of providing a novel dipyrromethene metal complex compound and a tautomer thereof which exhibit excellent color purity, can be formed into a thin layer, have a high absorption coefficient, have excellent fastness (especially, heat resistance and light resistance), and are useful for forming a colored film included in a color filter, and the aim of the invention is to achieve this object.

### Solution to Problem

Means for addressing the above problems are as follows.

<1> A colored composition, comprising at least one selected from the group consisting of a compound represented by the following Formula (I) and a tautomer thereof:

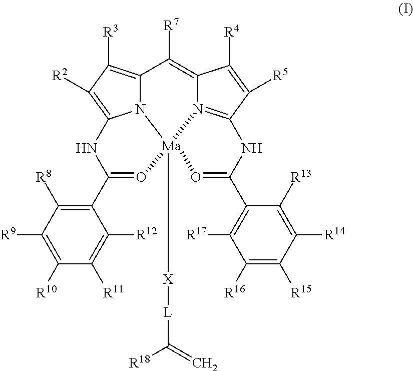

wherein, in Formula (I), R² to R⁵ and R⁸ to R¹⁷ each independently represent a hydrogen atom or a monovalent substituent; pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring; R⁷ represents a hydrogen atom, a halogen atom, an alkyl group, an aryl group, or a heterocyclic group; Ma represents a metal or a metal compound; X represents a group necessary for neutralizing the charge of Ma; L represents a single bond or a divalent linking group; and R¹⁸ represents a hydrogen atom or a methyl group.

<2> The colored composition according to <1>, wherein Ma in Formula (I) represents Fe, Zn, Co, V═O, or Cu.

<3> The colored composition according to <1> or <2>, further comprising a polymerizable compound and a photopolymerization initiator.

<4> The colored composition according to any one of <1> to <3>, further comprising a pigment or an anthraquinone compound, or both a pigment and an anthraquinone compound.

<5> The colored composition according to <4>, wherein the anthraquinone compound is a compound represented by the following Formula (IX):

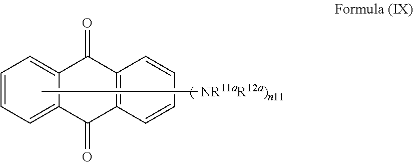

wherein, in Formula (IX), R^{11a} and R^{12a} each independently represent a hydrogen atom, an alkyl group, an aryl group, or a heterocyclic group; R^{11a} and R^{12a} do not represent a hydrogen atom at the same time; and n¹¹ represents an integer of from 1 to 4.

<6> The colored composition according to any one of <1> to <5>, wherein the content of the at least one selected from the group consisting of a compound represented by Formula (I) and a tautomer thereof is from 0.1% by mass to 30% by mass with respect to the total solid content of the colored composition.

<7> A compound represented by the following Formula (I) or a tautomer thereof:

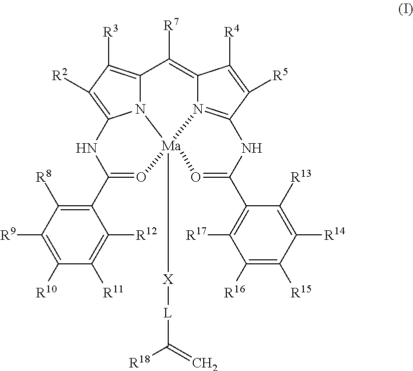

wherein, in Formula (I), R² to R⁵ and R⁸ to R¹⁷ each independently represent a hydrogen atom or a monovalent substituent; pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring; R⁷ represents a hydrogen atom, a halogen atom, an alkyl group, an aryl group, or a heterocyclic group; Ma represents a metal or a metal compound; X represents a group necessary for neutralizing the charge of Ma; L represents a single bond or a divalent linking group; and R¹⁸ represents a hydrogen atom or a methyl group.

<8> A colored cured film obtained by curing the colored composition according to any one of <1> to <6>.

<9> A color filter, comprising the colored cured film according to <8>.

<10> A method for producing a color filter, the method comprising a process of applying the colored composition according to any one of <1> to <6> onto a support to form a colored composition layer, and a process of pattern-wise exposing and developing the formed colored composition layer to form a patterned colored region.

<11> A liquid crystal display device, comprising the color filter according to <9> or a color filter produced by the method for producing a color filter according to <10>.

<12> A solid-state imaging device, comprising the color filter according to <9> or a color filter produced by the method for producing a color filter according to <10>.

### Advantage Effects of Invention

According to the present invention, a colored composition which is useful for the production of a color filter, has high color purity, can be formed into a thin film having a high absorption coefficient, can be formed into a colored film having excellent fastness (especially, heat resistance and light resistance), and provides an excellent voltage holding ratio when voltage is applied to a liquid crystal display device equipped with a color filter having the colored film, a colored cured film obtained by using the colored composition, a color filter, and a method for producing the same can be provided.

According to the present invention, a liquid crystal display device which provides a display image with vivid colors and high contrast, and a solid-state imaging device with reduced color unevenness and improved color resolution can be provided.

According to the present invention, a novel dipyrromethene metal complex compound and a tautomer thereof which have excellent color purity, can be formed into a thin layer, have a high absorption coefficient, have excellent fastness (especially, heat resistance and light resistance), and are useful for forming a colored film included in a color filter can be provided.

### DESCRIPTION OF EMBODIMENT

Hereinafter, a colored composition, a colored cured film obtained by curing the colored composition, a color filter and a method for producing the same, a liquid crystal display device and a solid-state imaging device, and a novel dipyrromethene metal complex compound and a tautomer thereof, according to the present invention are described in detail.

Since problems that could not been addressed by color resists using a conventionally known dye are addressed, the colored composition of the present invention and the novel dipyrromethene metal complex compound and a tautomer thereof are particularly useful for color filters that are used in solid-state imaging devices or image display devices (for example, liquid crystal display devices, organic EL display devices, or the like).

Explanation of the structural elements of the present invention, which is described below, is based on representative exemplary embodiments of the present invention; however, the present invention is not limited to such exemplary embodiments.

In the colored composition of the present invention, the term “total solid content” refers to a total mass of components obtained by excluding the organic solvent from the whole composition of the colored composition.

In this specification, a numerical range described by using the term “to” or “-” represents a range including numerical values described in front of and behind “to” or “-” as the minimum value and the maximum value.

In the specification, for example, an “alkyl group” indicates a “straight chain, branched, or cyclic” alkyl group. Further, in the expression of a group (atomic group) in the specification, when a group (atomic group) is denoted without specifying whether substituted or unsubstituted, the group includes both a group that does not have a substituent and a group that has a substituent. For example, “an alkyl group” includes not only an alkyl group (an unsubstituted alkyl group) that does not have a substituent, but also an alkyl group (a substituted alkyl group) that has a substituent.

Further, in the specification, “(meth)acrylate” denotes both or one of acrylate and methacrylate, “(meth)acryl” denotes both or one of acryl and methacryl, and “(meth)acryloyl” denotes both or one of acryloyl and methacryloyl.

Moreover, in the specification, the term “TANRYOTAI” in Japanese has the same definition as “monomer”. The “monomer” in the specification is distinguished from “oligomer” and “polymer”, and refers to a compound that has a weight average molecular weight of 2,000 or less.

In the specification, the term “polymerizable compound” refers to a compound having a polymerizable functional group, and may be a monomer, an oligomer, or a polymer. The “polymerizable functional group” refers to a group that takes part in a polymerization reaction.

In the specification, the term “process” includes not only an independent process, but also a case which cannot by clearly distinguished from other process, as long as the predetermined action is achieved.

In the present invention, the term “radiation” means radiation including visible ray, ultraviolet ray, far-ultraviolet ray, electron beam, X-ray, and the like.

<Colored Composition, Compound Represented by Formula (I) and Tautomer Thereof>

The colored composition of the present invention contains at least one selected from the group consisting of a compound represented by Formula (I) and a tautomer compound thereof (hereinafter, referred to as “specific metal complex compound” as appropriate), and preferably, the colored composition is configured to further include a polymerizable compound and a photopolymerization initiator, thereby having photosensitivity.

Further, it is preferable that the colored composition of the present invention further contains a binder of, for example, an alkali-soluble resin or the like, and an organic solvent; and, as needs arise, the colored composition may contain various additives.

In the present invention, in the dipyrromethene metal complex compound, particularly, a ligand that coordinates to the metal or metal compound has a carbon-carbon unsaturated double bond group. The colored composition of the present invention contains at least one selected from the group consisting of a compound represented by Formula (I), the compound being a dipyrromethene metal complex compound that has a ligand having a carbon-carbon unsaturated double bond group, and a tautomer thereof (specific metal complex compound). The specific metal complex compound is a novel compound, and is contained in the colored composition of the present invention as a coloring agent.

The specific metal complex compound according to the present invention has a carbon-carbon unsaturated double bond group in its ligand, and by the inclusion of the specific metal complex compound as a coloring agent, a colored composition capable of forming a colored cured film (colored pattern) having excellent heat resistance, light resistance, voltage holding ratio, contrast, and brightness, and further, a color filter containing the same can be provided. Particularly, in a case in which the specific metal complex compound according to the present invention is contained in a colored composition for producing a color filter or the like, the specific metal complex compound exhibits an excellent effect on the improvement in voltage holding ratio, compared to various known dye compounds that have been used as a coloring agent.

Such an excellent effect, which is exhibited by the specific metal complex compound according to the present invention and the colored composition containing the same, is based on the following knowledge obtained by the present inventors.

In a case in which a conventionally known dye compound is included in a colored composition for producing a color filter or the like, the voltage holding ratio is lowered depending on the kind of the dye compound. In the case of applying a conventionally known dye compound, the mechanism of action relating to the occurrence of lowering of voltage holding ratio is not clear, but it is thought as follows. Namely, due to the electric field applied when formed into a color filter, the metal complex compound is ionized to produce ions, thereby causing lowering of voltage holding ratio.

The specific metal complex compound according to the present invention is characterized in that, in Formula (I), the ligand has a carbon-carbon unsaturated double bond group. Accordingly, although the theory is not necessarily clear, it is thought that, by the covalent bonding of the polymerizable compound in the colored composition and the ligand of the specific metal complex compound according to the present invention, even if the metal complex compound is ionized due to the electric field, ions are less likely to liberate freely. Further, it is surprising that the voltage holding ratio is improved when this specific metal complex compound alone, not in the colored composition, is cured by irradiation with ultraviolet ray or the like.

However, it is thought that, when CH₃COO⁻, which is a metal ligand, is used, since the stability (bonding strength between metal and ligand) of the metal complex compound is low, the metal complex compound tends to be ionically dissociated, and free ions that can move freely, tend to cause lowering of voltage holding ratio. Further, it is thought the heat resistance and light resistance of the specific metal complex compound according to the present invention are also excellent, since the stability of the metal complex is high from the same reason, and therefore, a color filter that does not cause lowering of brightness by heat or light and exhibits little color change can be obtained.

<Compound Represented by Formula (I) and Tautomer Thereof>

The colored composition of the present invention contains at least one selected from the group consisting of a compound represented by the following Formula (I) and a tautomer thereof (specific metal complex compound).

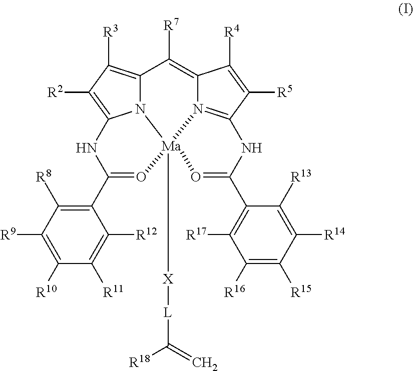

In Formula (I), R² to R⁵ and R⁸ to R¹⁷ each independently represent a hydrogen atom or a monovalent substituent. Pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring. R⁷ represents a hydrogen atom, a halogen atom, an alkyl group, an aryl group, or a heterocyclic group. Ma represents a metal or a metal compound. X represents a group necessary for neutralizing the charge of Ma, L represents a single bond or a divalent linking group, and R¹⁸ represents a hydrogen atom or a methyl group.

In Formula (I), examples of the monovalent substituent represented by R² to R⁵ or R⁸ to R¹⁷ include a halogen atom (for example, a fluorine atom, a chlorine atom, or a bromine atom), an alkyl group (preferably a straight chain, branched, or cyclic alkyl group having from 1 to 48 carbon atoms, and more preferably from 1 to 24 carbon atoms; examples thereof include a methyl group, an ethyl group, a propyl group, an isopropyl group, a butyl group, a t-butyl group, a pentyl group, a hexyl group, a heptyl group, an octyl group, a 2-ethylhexyl group, a dodecyl group, a hexadecyl group, a cyclopropyl group, a cyclopentyl group, a cyclohexyl group, a 1-norbornyl group, and a 1-adamantyl group.), an alkenyl group (preferably an alkenyl group having from 2 to 48 carbon atoms, and more preferably from 2 to 18 carbon atoms; examples thereof include a vinyl group, an allyl group, and a 3-buten-1-yl group.), an aryl group (preferably an aryl group having from 6 to 48 carbon atoms, and more preferably from 6 to 24 carbon atoms; examples thereof include a phenyl group and a naphthyl group.), a heterocyclic group (preferably a heterocyclic group having from 1 to 32 carbon atoms, and more preferably from 1 to 18 carbon atoms; examples thereof include a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group.), a silyl group (preferably a silyl group having from 3 to 38 carbon atoms, and more preferably from 3 to 18 carbon atoms; examples thereof include a trimethylsilyl group, a triethylsilyl group, a tributylsilyl group, a t-butyldimethylsilyl group, and a t-hexyldimethylsilyl group.), a hydroxyl group, a cyano group, a nitro group, an alkoxy group (preferably an alkoxyl group having from 1 to 48 carbon atoms, and more preferably from 1 to 24 carbon atoms; examples thereof include a methoxy group, an ethoxy group, a 1-butoxy group, a 2-butoxy group, an isopropoxy group, a t-butoxy group, a dodecyloxy group, and a cycloalkyloxy group (for example, a cyclopentyloxy group or a cyclohexyloxy group).), an aryloxy group (preferably an aryloxy group having from 6 to 48 carbon atoms, and more preferably from 6 to 24 carbon atoms; examples thereof include a phenoxy group and a 1-naphthoxy group.), a heterocyclic oxy group (preferably a heterocyclic oxy group having from 1 to 32 carbon atoms, and more preferably from 1 to 18 carbon atoms; examples thereof include a 1-phenyltetrazol-5-oxy group and a 2-tetrahydropyranyloxy group.),

a silyloxy group (preferably a silyloxy group having from 1 to 32 carbon atoms, and more preferably from 1 to 18 carbon atoms; examples thereof include a trimethylsilyloxy group, a t-butyldimethylsilyloxy group, and a diphenylmethylsilyloxy group.), an acyloxy group (preferably an acyloxy group having from 2 to 48 carbon atoms, and more preferably from 2 to 24 carbon atoms; examples thereof include an acetoxy group, a pivaloyloxy group, a benzoyloxy group, and a dodecanoyloxy group.), an alkoxycarbonyloxy group (preferably an alkoxycarbonyloxy group having from 2 to 48 carbon atoms, and more preferably from 2 to 24 carbon atoms; examples thereof include an ethoxycarbonyloxy group, a t-butoxycarbonyloxy group, and a cycloalkyloxycarbonyloxy group (for example, a cyclohexyloxycarbonlyoxy group or the like).), an aryloxycarbonyloxy group (preferably an aryloxycarbonyloxy group having from 7 to 32 carbon atoms, and more preferably from 7 to 24 carbon atoms; examples thereof include a phenoxycarbonyloxy group.), a carbamoyloxy group (preferably a carbamoyloxy group having from 1 to 48 carbon atoms, and more preferably from 1 to 24 carbon atoms; examples thereof include an N,N-dimethylcarbamoyloxy group, an N-butylcarbamoyloxy group, an N-phenylcarbamoyloxy group, and an N-ethyl-N-phenylcarbamoyloxy group.), a sulfamoyloxy group (preferably a sulfamoyloxy group having from 1 to 32 carbon atoms, and more preferably from 1 to 24 carbon atoms; examples thereof include an N,N-diethylsulfamoyloxy group and an N-propylsulfamoyloxy group.), an alkylsulfonyloxy group (preferably an alkylsulfonyloxy group having from 1 to 38 carbon atoms, and more preferably from 1 to 24 carbon atoms; examples thereof include a methylsulfonyloxy group, a hexadecylsulfonyloxy group, and a cyclohexylsulfonyloxy group.), an arylsulfonyloxy group (preferably an arylsulfonyloxy group having from 6 to 32 carbon atoms, and more preferably from 6 to 24 carbon atoms; examples thereof include a phenylsulfonyloxy group.),

an acyl group (preferably an acyl group having from 1 to 48 carbon atoms, and more preferably from 1 to 24 carbon atoms; examples thereof include a formyl group, an acetyl group, a pivaloyl group, a benzoyl group, a tetradecanoyl group, and a cyclohexanoyl group.), an alkoxycarbonyl group (preferably an alkoxycarbonyl group having from 2 to 48 carbon atoms, and more preferably from 2 to 24 carbon atoms; examples thereof include a methoxycarbonyl group, an ethoxycarbonyl group, an octadecyloxycarbonyl group, a cyclohexyloxycarbonly group, and a 2,6-di-tert-butyl-4-methylcyclohexyloxycarbonyl group.), an aryloxycarbonyl group (preferably an aryloxycarbonyl group having from 7 to 32 carbon atoms, and more preferably from 7 to 24 carbon atoms; examples thereof include a phenoxycarbonyl group.), a carbamoyl group (preferably a carbamoyl group having from 1 to 48 carbon atoms, and more preferably from 1 to 24 carbon atoms; examples thereof include a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group.), an amino group (preferably an amino group having 32 or less carbon atoms, and more preferably 24 or less carbon atoms; examples thereof include an amino group, a methylamino group, an N,N-dibutylamino group, a tetradecylamino group, a 2-ethylhexyl amino group, and a cyclohexylamino group.), an anilino group (preferably an anilino group having from 6 to 32 carbon atoms, and more preferably from 6 to 24 carbon atoms; examples thereof include an anilino group and an N-methylanilino group.), a heterocyclic amino group (preferably a heterocyclic amino group having from 1 to 32 carbon atoms, and more preferably from 1 to 18 carbon atoms; examples thereof include a 4-pyridylamino group.), a carbonamido group (preferably a carbonamido group having from 2 to 48 carbon atoms, and more preferably from 2 to 24 carbon atoms; examples thereof include an acetamido group, a benzamido group, a tetradecaneamido group, a pivaloylamido group, and a cyclohexaneamido group.), a ureido group (preferably a ureido group having from 1 to 32 carbon atoms, and more preferably from 1 to 24 carbon atoms; examples thereof include a ureido group, an N,N-dimethylureido group, and an N-phenylureido group.), an imido group (preferably an imido group having 36 or less carbon atoms, and more preferably 24 or less carbon atoms; examples thereof include an N-succinimido group and an N-phthalimido group.),

an alkoxycarbonylamino group (preferably an alkoxycarbonylamino group having from 2 to 48 carbon atoms, and more preferably from 2 to 24 carbon atoms; examples thereof include a methoxycarbonylamino group, an ethoxycarbonylamino group, a t-butoxycarbonylamino group, an octadecyloxycarbonylamino group, and a cyclohexyloxycarbonylamino group.), an aryloxycarbonylamino group (preferably an aryloxycarbonylamino group having from 7 to 32 carbon atoms, and more preferably from 7 to 24 carbon atoms; examples thereof include a phenoxycarbonylamino group.), a sulfonamido group (preferably a sulfonamido group having from 1 to 48 carbon atoms, and more preferably from 1 to 24 carbon atoms; examples thereof include a methanesulfonamido group, a butanesulfonamido group, a benzenesulfonamido group, a hexadecanesulfonamido group, and a cyclohexanesulfonamido group.), a sulfamoylamino group (preferably a sulfamoylamino group having from 1 to 48 carbon atoms, and more preferably from 1 to 24 carbon atoms; examples thereof include an N,N-dipropylsulfamoylamino group and an N-ethyl-N-dodecylsulfamoylamino group.), an azo group (preferably an azo group having from 1 to 32 carbon atoms, and more preferably from 1 to 24 carbon atoms; examples thereof include a phenylazo group and a 3-pyrazolylazo group.), an alkylthio group (preferably an alkylthio group having from 1 to 48 carbon atoms, and more preferably from 1 to 24 carbon atoms; examples thereof include a methylthio group, an ethylthio group, an octylthio group, and a cyclohexylthio group.), an arylthio group (preferably an arylthio group having from 6 to 48 carbon atoms, and more preferably from 6 to 24 carbon atoms; examples thereof include a phenylthio group.), a heterocyclic thio group (preferably a heterocyclic thio group having from 1 to 32 carbon atoms, and more preferably from 1 to 18 carbon atoms; examples thereof include a 2-benzothiazolylthio group, a 2-pyridylthio group, and a 1-phenyltetrazolylthio group.),

an alkylsulfinyl group (preferably an alkylsulfinyl group having from 1 to 32 carbon atoms, and more preferably from 1 to 24 carbon atoms; examples thereof include a dodecanesulfinyl group.), an arylsulfinyl group (preferably an arylsulfinyl group having from 6 to 32 carbon atoms, and more preferably from 6 to 24 carbon atoms; examples thereof include a phenylsulfinyl group.), an alkylsulfonyl group (preferably an alkylsulfonyl group having from 1 to 48 carbon atoms, and more preferably from 1 to 24 carbon atoms; examples thereof include a methylsulfonyl group, an ethylsulfonyl group, a propylsulfonyl group, a butylsulfonyl group, an isopropylsulfonyl group, a 2-ethylhexyl sulfonyl group, a hexadecylsulfonyl group, an octylsulfonyl group, and a cyclohexylsulfonyl group.), an arylsulfonyl group (preferably an arylsulfonyl group having from 6 to 48 carbon atoms, and more preferably from 6 to 24 carbon atoms; examples thereof include a phenylsulfonyl group and a 1-naphthylsulfonyl group.), a sulfamoyl group (preferably a sulfamoyl group having 32 or less carbon atoms, and more preferably 24 or less carbon atoms; examples thereof include a sulfamoyl group, an N,N-dipropylsulfamoyl group, an N-ethyl-N-dodecylsulfamoyl group, an N-ethyl-N-phenylsulfamoyl group, and an N-cyclohexylsulfamoyl group.), a sulfo group, a phosphonyl group (preferably a phosphonyl group having from 1 to 32 carbon atoms, and more preferably from 1 to 24 carbon atoms; examples thereof include a phenoxyphosphonyl group, an octyloxyphosphonyl group, and a phenylphosphonyl group.), and a phosphinoylamino group (preferably a phosphinoylamino group having from 1 to 32 carbon atoms, and more preferably from 1 to 24 carbon atoms; examples thereof include a diethoxyphosphinoylamino group and a dioctyloxyphosphinoylamino group.).

In Formula (I), in a case in which the monovalent substituent represented by R² to R⁵ or R⁸ to R¹⁷ is a group capable of being further substituted, the group may have a substituent which is described as the monovalent substituent represented by R² to R⁵ or R⁸ to R¹⁷; and in a case in which the group has two or more substituents, these substituents may be the same or different.

In Formula (I), pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring.

Examples of the 5-membered, 6-membered, or 7-membered saturated ring or unsaturated ring include a pyrrole ring, a furan ring, a thiophene ring, a pyrazole ring, an imidazole ring, a triazole ring, an oxazole ring, a thiazole ring, a pyrrolidine ring, a piperidine ring, a cyclopentene ring, a cyclohexene ring, a benzene ring, a pyridine ring, a pyrazine ring, and a pyridazine ring; and a benzene ring and a pyridine ring are preferred.

In a case in which the 5-membered, 6-membered, or 7-membered ring formed is a group capable of being further substituted, the group may be substituted with a substituent which is described as the monovalent substituent represented by R² to R⁵ or R⁸ to R¹⁷; and in the case of being substituted with two or more substituents, these substituents may be the same or different.

In Formula (I), R⁷ represents a hydrogen atom, a halogen atom, an alkyl group, an aryl group, or a heterocyclic group.

In a case in which R⁷ represents a halogen atom, an alkyl group, an aryl group, or a heterocyclic group, preferable ranges of these groups are the same as the preferable ranges of R² to R⁵ or R⁸ to R¹⁷ represented by the halogen atom, alkyl group, aryl group, and heterocyclic group described above.

In a case in which the alkyl group, aryl group, or heterocyclic group represented by R⁷ is a group capable of being further substituted, the group may be substituted with a substituent which is described as the monovalent substituent represented by R² to R⁵ or R⁸ to R¹⁷; and in the case of being substituted with two or more substituents, these substituents may be the same or different.

In Formula (I), as the substituent represented by R² or R⁵, among the groups described above, an alkoxycarbonyl group, an aryloxycarbonyl group, a carbamoyl group, an alkylsulfonyl group, an arylsulfonyl group, a cyano group, an imido group, and a carbamoylsulfonyl group are preferable; an alkoxycarbonyl group, an aryloxycarbonyl group, a carbamoyl group, an alkylsulfonyl group, a cyano group, an imido group, and a carbamoylsulfonyl group are more preferable; an alkoxycarbonyl group, an aryloxycarbonyl group, a carbamoyl group, a cyano group, an imido group, and a carbamoylsulfonyl group are even more preferable; and an alkoxycarbonyl group, an aryloxycarbonyl group, and a carbamoyl group are particularly preferable.

In Formula (I), R³, R⁴ and R⁸ to R¹⁷ preferably represent, among the groups described above, a substituted or unsubstituted alkyl group, a substituted or unsubstituted aryl group, or a substituted or unsubstituted heterocyclic group, and more preferably a substituted or unsubstituted alkyl group, or a substituted or unsubstituted aryl group.

In Formula (I), in a case in which R³, R⁴ and R⁸ to R¹⁷ represent an alkyl group, the alkyl group is preferably a straight chain, branched, or cyclic, substituted or unsubstituted alkyl group having from 1 to 12 carbon atoms; more specifically, examples thereof include a methyl group, an ethyl group, an n-propyl group, an isopropyl group, a cyclopropyl group, an n-butyl group, an i-butyl group, a t-butyl group, a cyclobutyl group, a cyclopentyl group, a cyclohexyl group, and a benzyl group; more preferably a branched, or cyclic, substituted or unsubstituted alkyl group having from 1 to 12 carbon atoms (specific examples thereof include an isopropyl group, a cyclopropyl group, an i-butyl group, a t-butyl group, a cyclobutyl group, a cyclopentyl group, and a cyclohexyl group.); and even more preferably a secondary or tertiary, substituted or unsubstituted alkyl group having from 1 to 12 carbon atoms (specific examples thereof include an isopropyl group, a cyclopropyl group, an i-butyl group, a t-butyl group, a cyclobutyl group, and a cyclohexyl group.).

In Formula (I), in a case in which R³, R⁴ and R⁸ to R¹⁷ represent an aryl group, the aryl group is preferably a substituted or unsubstituted phenyl group, or a substituted or unsubstituted naphthyl group, and more preferably a substituted or unsubstituted phenyl group.

In a case in which R³, R⁴ and R⁸ to R¹⁷ represent a heterocyclic group, the heterocyclic group is preferably a substituted or unsubstituted 2-thienyl group, a substituted or unsubstituted 4-pyridyl group, a substituted or unsubstituted 3-pyridyl group, a substituted or unsubstituted 2-pyridyl group, a substituted or unsubstituted 2-furyl group, a substituted or unsubstituted 2-pyrimidinyl group, a substituted or unsubstituted 2-benzothiazolyl group, a substituted or unsubstituted 1-imidazolyl group, a substituted or unsubstituted 1-pyrazolyl group, or a substituted or unsubstituted benzotriazol-1-yl group; and more preferably a substituted or unsubstituted 2-thienyl group, a substituted or unsubstituted 4-pyridyl group, a substituted or unsubstituted 2-furyl group, a substituted or unsubstituted 2-pyrimidinyl group, or a substituted or unsubstituted 1-imidazolyl group.

Ma in Formula (I) represents a metal atom or a metal compound.

The metal atom or metal compound may be any metal atom or metal compound as long as it is a metal atom or metal compound capable forming a complex, and a divalent metal atom, a divalent metal oxide, a divalent metal hydroxide, and a divalent metal chloride are included. For example, in addition to Zn, Mg, Si, Sn, Rh, Pt, Pd, Mo, Mn, Pb, Cu, Ni, Co, Fe, B, and the like, metal chlorides such as AlCl, InCl, FeCl, TiCl₂, SnCl₂, SiCl₂, and GeCl₂, metal oxides such as TiO and VO, and metal hydroxides such as Si(OH)₂ are also included.

Among them, from the viewpoints of stability, spectral characteristics, heat resistance, light resistance, production suitability, and the like of the complex, Fe, Zn, Mg, Si, Pt, Pd, Mo, Mn, Cu, Ni, Co, TiO, B, or VO is preferable, Fe, Zn, Mg, Si, Pt, Pd, Cu, Ni, Co, B, or VO is more preferable, and Fe, Zn, Cu, Co, or VO (V═O) is most preferable. Among them, Zn is particularly preferable.

In Formula (I), X represents a group necessary for neutralizing the charge of Ma; for example, X represents a hydroxyl group, a carboxylic acid group, a phosphoric acid group, a sulfonic acid group, or a group obtained by dissociating one hydrogen atom from R—CONHCO—R (each R independently represents an alkyl group, an aryl group, or a heterocyclic group.), R—CONHSO₂—R (each R independently represents an alkyl group, an aryl group, or a heterocyclic group.), or the like; and among them, from the viewpoint of manufacturing, a hydroxyl group, a carboxylic acid group, a sulfonic acid group, and groups obtained by dissociating one hydrogen atom from R—CONHCO—Ror R—CONHSO₂—R are preferable, and a hydroxyl group, a carboxylic acid group, and a group obtained by dissociating one hydrogen atom from R—CONHCO—R are more preferable.

In Formula (I), L represents a single bond or a divalent linking group.

In a case in which L represents a divalent linking group, preferable examples of the divalent linking group include an alkylene group having from 1 to 20 carbon atoms, an arylene group having from 6 to 20 carbon atoms, a divalent group obtained by removing two hydrogen atoms from a heterocycle, —O—, —S—, —NR— (R represents a hydrogen atom or a monovalent substituent.), —SO₂—, —CO—, —CS—, —C(═NH)—, and a divalent linking group formed by combining two or more of these groups. The divalent linking group is more preferably an alkylene group having from 1 to 12 carbon atoms, a phenylene group having from 6 to 12 carbon atoms, —O—, —S—, —NR— (R represents a hydrogen atom or a monovalent substituent.), —CO—, or a divalent linking group formed by combining two or more of these groups, and particularly preferably an alkylene group having from 1 to 6 carbon atoms, a phenylene group having 6 carbon atoms, —O—, —NR— (R represents a hydrogen atom or a monovalent substituent.), —CO—, or a divalent linking group formed by combining two or more of these groups.

In Formula (I), R¹⁸ represents a hydrogen atom or a methyl group.

The compound represented by Formula (I) may be a tautomer.

The tautomer of the compound represented by Formula (I) may be any tautomer, as long as it is a compound having a structure which can be formed by a movement of one hydrogen atom in the molecule, and for example, the specific metal complex compound represented by Formula (I) may have a structure represented by the following Formula (A) to Formula (F), or the like.

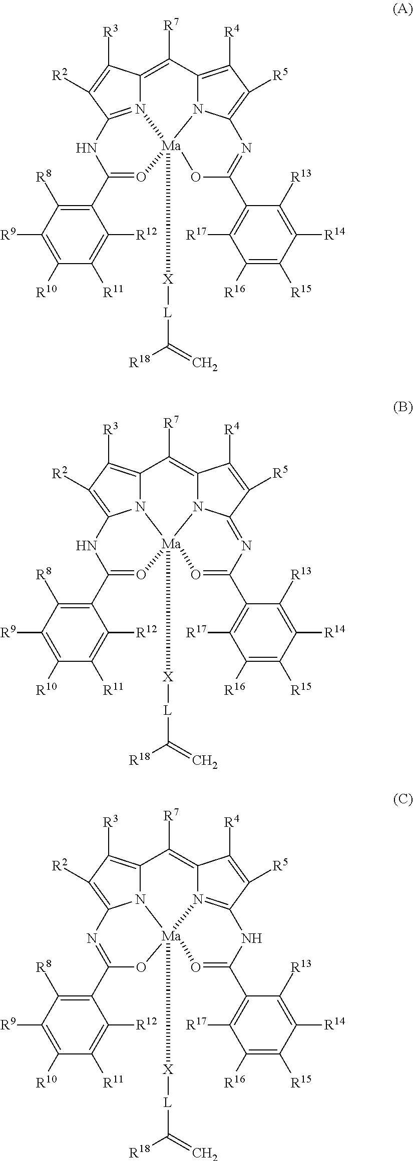

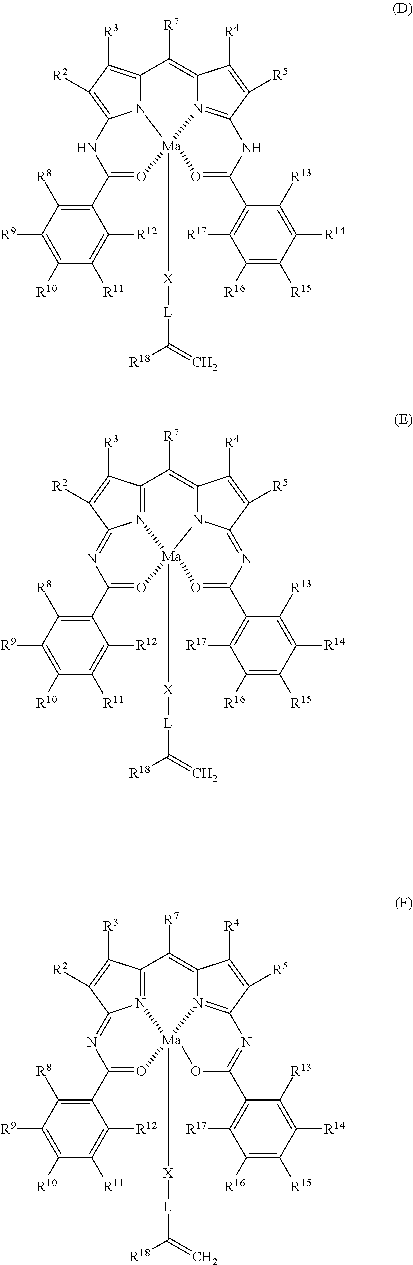

R² to R⁵ and R⁷ to R¹⁸, Ma, X, and L in Formulae (A) to (F) have the same definitions as R² to R⁵ and R⁷ to R¹⁸, Ma, X, and L in Formula (I), respectively.

A molar absorption coefficient of the specific metal complex compound or a tautomer thereof in the present invention is preferably as high as possible from the viewpoint of film thickness. Further, the maximum absorption wavelength λmax is preferably from 520 nm to 580 nm, and more preferably from 530 nm to 570 nm, from the viewpoint of improvement in color purity.

The maximum absorption wavelength and the molar absorption coefficient are measured using a spectrophotometer UV-2400PC (manufactured by Shimadzu Corporation).

Next, specific examples of the specific metal complex compound in the present invention are shown below; however, the present invention is not limited to these examples.

Hereinafter, exemplary compounds of the specific metal complex compound are shown below; however, the present invention is not limited to these exemplary compounds.

Among the exemplary compounds shown below, A-1 to A-7, A-11 to A-14, A-21, A-22, A-25, A-26, A-31, A-32, A-34, A-38, A-39, A-41, A-46, A-47, A-54, and A-57 are particularly preferable, from the viewpoints of synthesis suitability, solubility, and heat resistance.

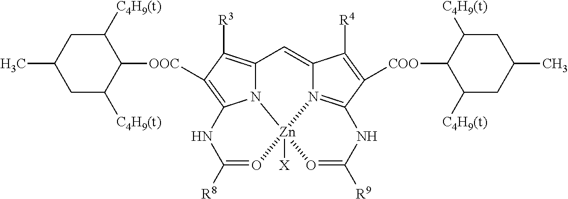

| Compound | | | |
|---|---|---|---|
| No. | R³ = R⁴ | R⁸ = R⁹ | X |
| A-1 | 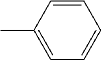 | 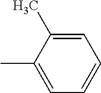 | 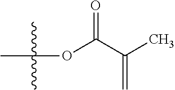 [SMILES: *OC(=O)C(=C)C] |
| A-2 | 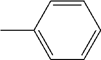 | 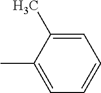 | 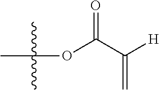 [SMILES: *OC(=O)C=C] |
| A-3 | 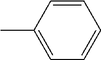 | 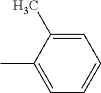 | 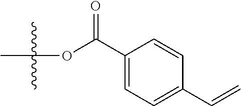 [SMILES: *OC(=O)c1ccc(C=C)cc1] |
| A-4 | 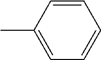 | 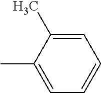 | 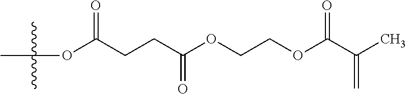 [SMILES: *OC(=O)CCC(=O)OCCOC(=O)C(=C)C] |
| A-5 | 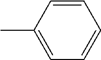 | 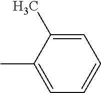 | 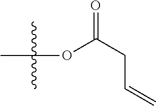 [SMILES: *OC(=O)CC=C] |

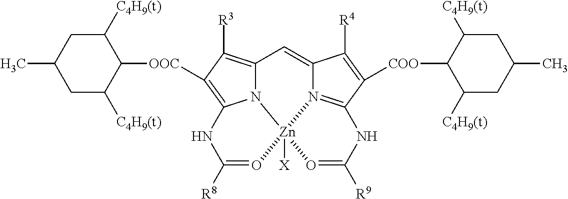

| Compound | | | |
|---|---|---|---|
| No. | R³ = R⁴ | R⁸ = R⁹ | X |
| A-6 | 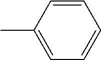 | 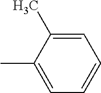 | 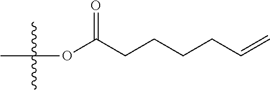 [SMILES: *OC(=O)CCCCC=C] |
| A-7 | 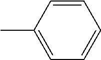 | 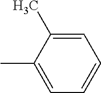 | 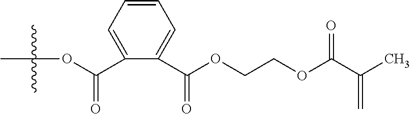 [SMILES: *OC(=O)c1ccccc1C(=O)OCCOC(=O)C(=C)C] |
| A-8 | 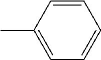 | 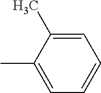 | 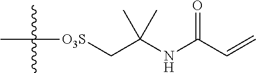 |
| A-9 | 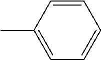 | 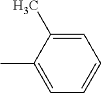 | 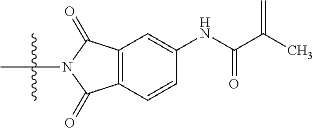 [SMILES: *N1C(=O)c2ccc(NC(=O)C(=C)C)cc2C1=O] |
| A-10 | 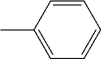 | 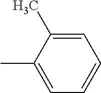 | 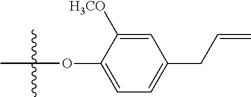 [SMILES: *Oc1ccc(CC=C)cc1OC] |

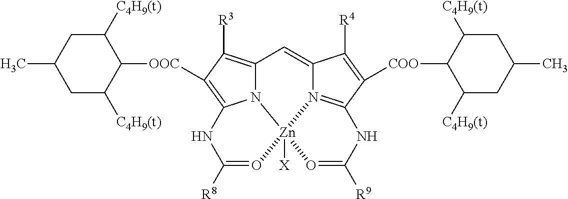

| Compound | | | |
|---|---|---|---|
| No. | R³ = R⁴ | R⁸ = R⁹ | X |
| A-11 | 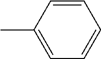 | 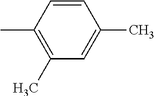 | 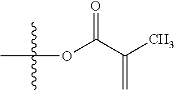 [SMILES: *OC(=O)C(=C)C] |
| A-12 | 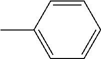 | 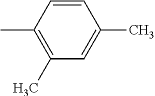 | 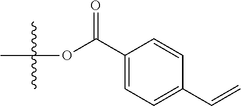 [SMILES: *OC(=O)c1ccc(C=C)cc1] |
| A-13 | 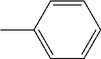 | 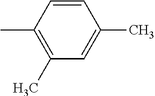 | 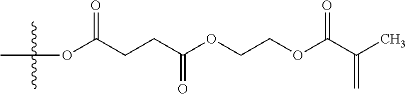 [SMILES: *OC(=O)CCC(=O)OCCOC(=O)C(=C)C] |
| A-14 | 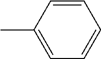 | 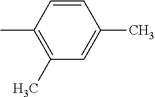 | 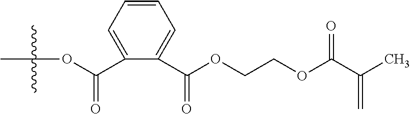 [SMILES: *OC(=O)c1ccccc1C(=O)OCCOC(=O)C(=C)C] |
| A-15 | 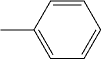 | 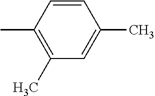 | 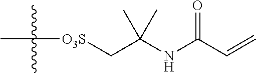 |

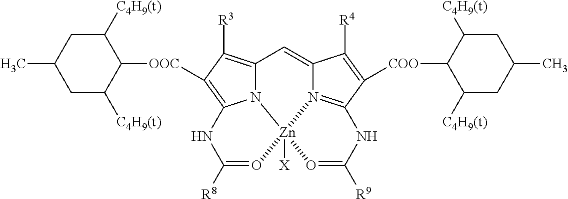

| Compound | | | |
|---|---|---|---|
| No. | R³ = R⁴ | R⁸ = R⁹ | X |
| A-16 | 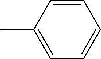 | 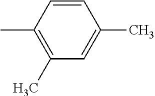 | 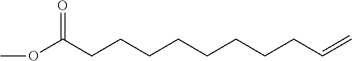 |
| A-17 | 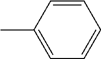 | 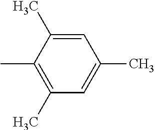 | 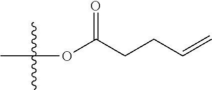 [SMILES: *OC(=O)CCC=C] |
| A-18 | 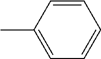 | 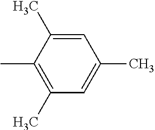 | 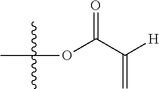 [SMILES: *OC(=O)C=C] |
| A-19 | 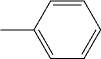 | 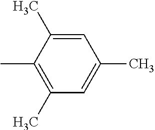 | 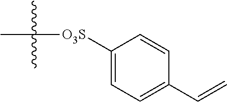 |
| A-20 | 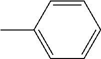 | 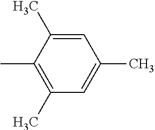 | 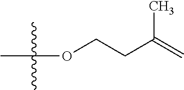 [SMILES: *OCCC(=C)C] |

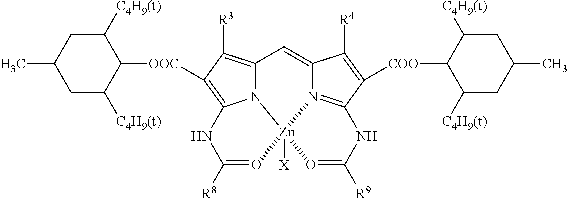

| Compound | | | |
|---|---|---|---|
| No. | R³ = R⁴ | R⁸ = R⁹ | X |
| A-21 | 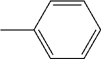 | 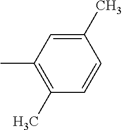 | 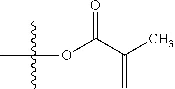 [SMILES: *OC(=O)C(=C)C] |
| A-22 | 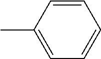 | 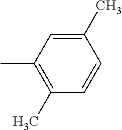 | 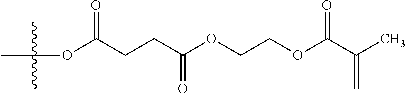 [SMILES: *OC(=O)CCC(=O)OCCOC(=O)C(=C)C] |
| A-23 | 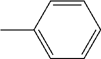 | 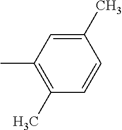 | 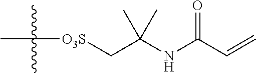 |
| A-24 | 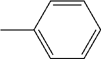 | 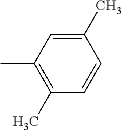 | 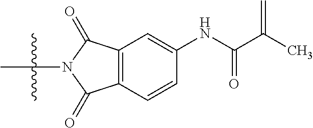 [SMILES: *N1C(=O)c2ccc(NC(=O)C(=C)C)cc2C1=O] |
| A-25 | 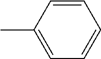 | 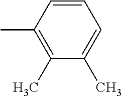 | 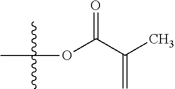 [SMILES: *OC(=O)C(=C)C] |

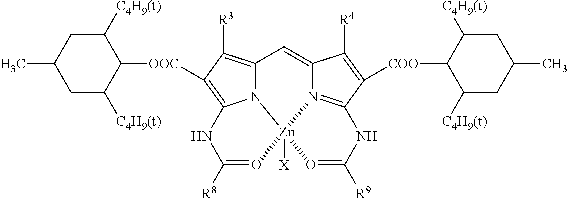

| Compound | | | |
|---|---|---|---|
| No. | R³ = R⁴ | R⁸ = R⁹ | X |
| A-26 | 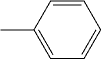 | 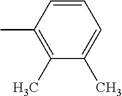 | 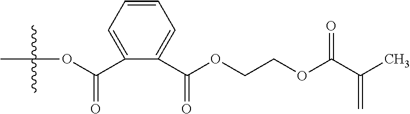 [SMILES: *OC(=O)c1ccccc1C(=O)OCCOC(=O)C(=C)C] |
| A-27 | 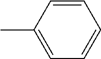 | 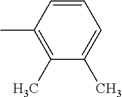 | 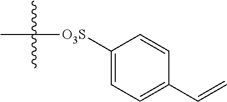 |
| A-28 | 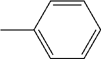 | 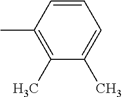 | 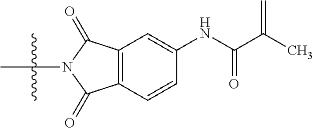 [SMILES: *N1C(=O)c2ccc(NC(=O)C(=C)C)cc2C1=O] |
| A-29 | 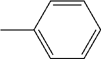 | 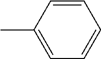 | 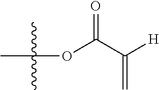 [SMILES: *OC(=O)C=C] |
| A-30 | 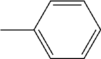 | 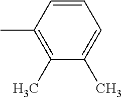 | 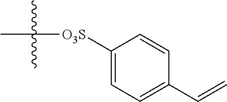 |

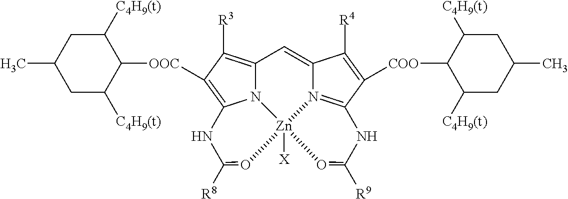

| Compound | | | |
|---|---|---|---|
| No. | R³ = R⁴ | R⁸ = R⁹ | X |
| A-31 | 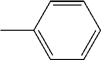 | 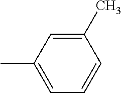 | 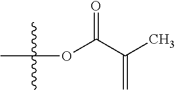 [SMILES: *OC(=O)C(=C)C] |
| A-32 | 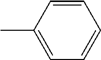 | 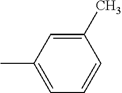 | 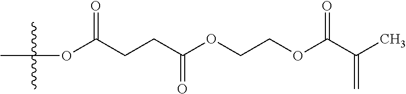 [SMILES: *OC(=O)CCC(=O)OCCOC(=O)C(=C)C] |
| A-33 | 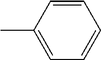 | 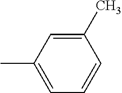 | 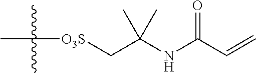 |
| A-34 | 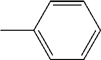 | 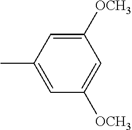 | 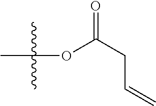 [SMILES: *OC(=O)CC=C] |
| A-35 | 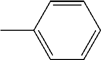 | 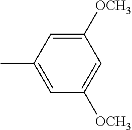 | 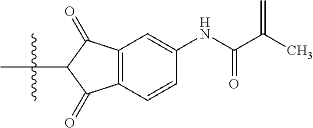 [SMILES: *C1C(=O)c2ccc(NC(=O)C(=C)C)cc2C1=O] |

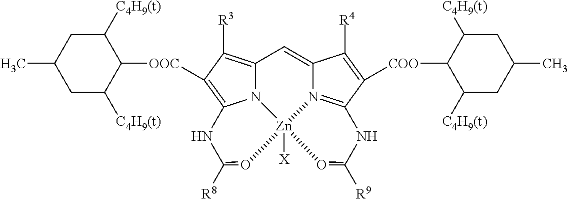

| Compound | | | |
|---|---|---|---|
| No. | R³ = R⁴ | R⁸ = R⁹ | X |
| A-36 | 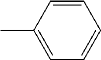 | 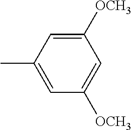 | 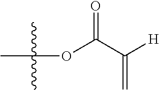 [SMILES: *OC(=O)C=C] |
| A-37 | 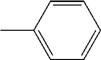 | 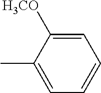 | 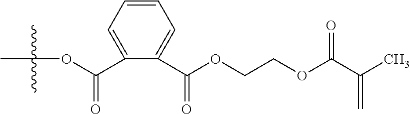 [SMILES: *OC(=O)c1ccccc1C(=O)OCCOC(=O)C(=C)C] |
| A-38 | 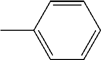 | 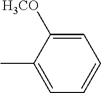 | 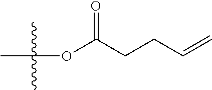 [SMILES: *OC(=O)CCC=C] |
| A-39 | 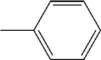 | 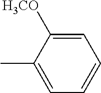 | 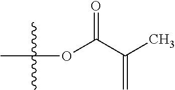 [SMILES: *OC(=O)C(=C)C] |
| A-40 | 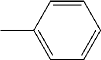 | 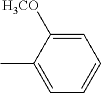 | 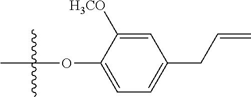 [SMILES: *Oc1ccc(CC=C)cc1OC] |

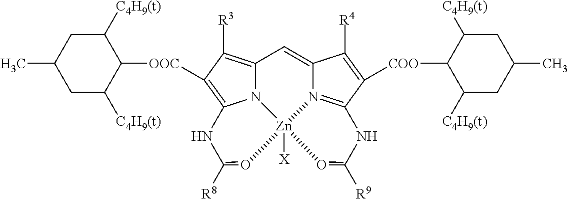

| Compound | | | |
|---|---|---|---|
| No. | R³ = R⁴ | R⁸ = R⁹ | X |
| A-41 | 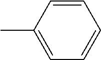 | 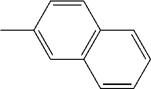 | 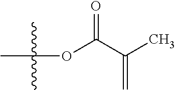 [SMILES: *OC(=O)C(=C)C] |
| A-42 | 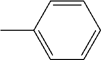 | 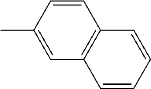 | 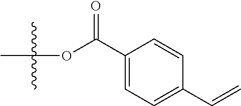 [SMILES: *OC(=O)c1ccc(C=C)cc1] |
| A-43 | 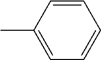 | 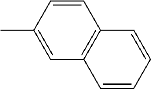 | 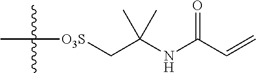 |
| A-44 | 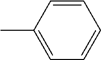 | 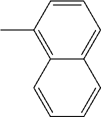 | 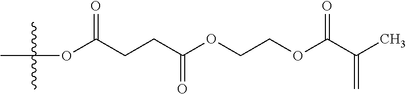 [SMILES: *OC(=O)CCC(=O)OCCOC(=O)C(=C)C] |
| A-45 | 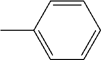 | 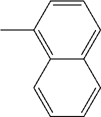 | 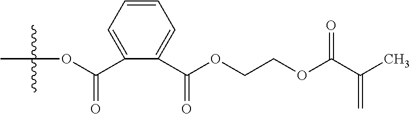 [SMILES: *OC(=O)c1ccccc1C(=O)OCCOC(=O)C(=C)C] |

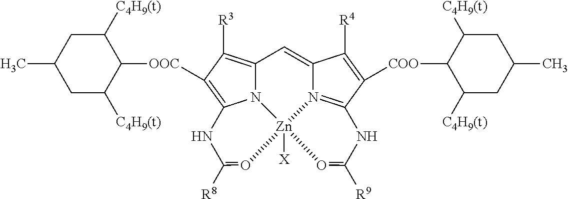

| Compound | | | |
|---|---|---|---|
| No. | R³ = R⁴ | R⁸ = R⁹ | X |
| A-46 | 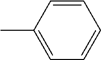 | 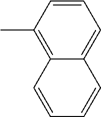 | 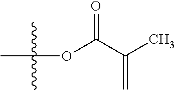 [SMILES: *OC(=O)C(=C)C] |
| A-47 | 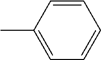 | 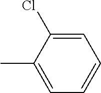 | 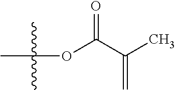 [SMILES: *OC(=O)C(=C)C] |
| A-48 | 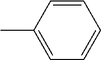 | 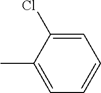 | 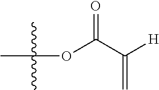 [SMILES: *OC(=O)C=C] |
| A-49 | 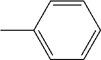 | 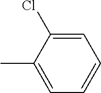 | 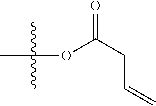 [SMILES: *OC(=O)CC=C] |
| A-50 | 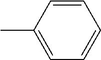 | 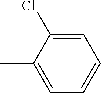 | 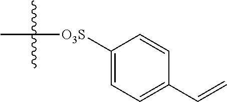 |

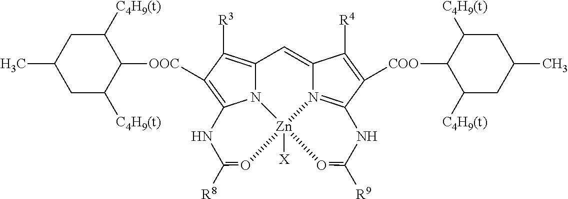

| Compound | | | |
|---|---|---|---|
| No. | R³ = R⁴ | R⁸ = R⁹ | X |
| A-51 | 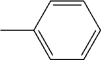 | 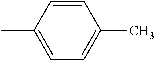 | 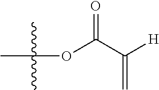 [SMILES: *OC(=O)C=C] |
| A-52 | 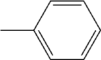 | 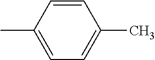 | 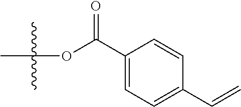 [SMILES: *OC(=O)c1ccc(C=C)cc1] |
| A-53 | 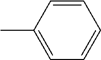 | 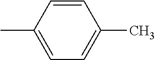 | 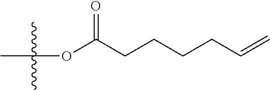 [SMILES: *OC(=O)CCCCC=C] |
| A-54 | 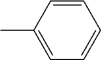 | 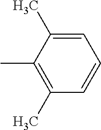 | 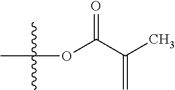 [SMILES: *OC(=O)C(=C)C] |
| A-55 | 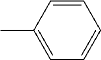 | 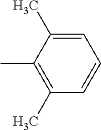 | 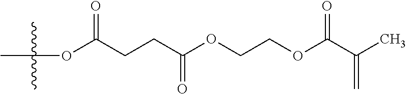 [SMILES: *OC(=O)CCC(=O)OCCOC(=O)C(=C)C] |

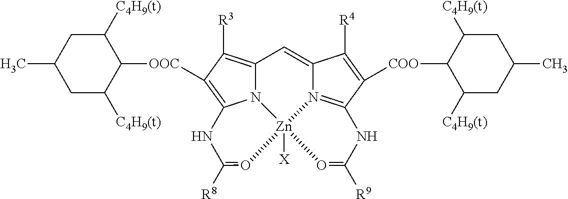

| Compound | | | |
|---|---|---|---|
| No. | R³ = R⁴ | R⁸ = R⁹ | X |
| A-56 | 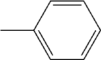 | 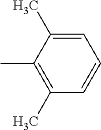 | 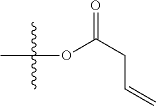 [SMILES: *OC(=O)CC=C] |
| A-57 | 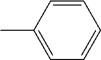 | 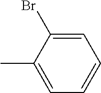 | 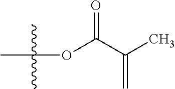 [SMILES: *OC(=O)C(=C)C] |
| A-58 | 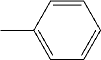 | 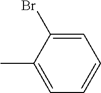 | 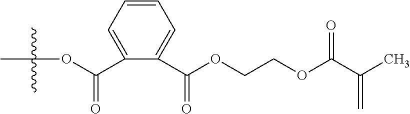 [SMILES: *OC(=O)c1ccccc1C(=O)OCCOC(=O)C(=C)C] |
| A-59 | 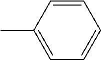 | 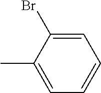 | 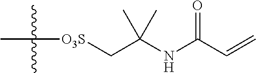 |
| A-60 | 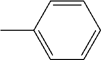 | 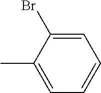 | 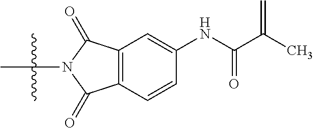 [SMILES: *N1C(=O)c2ccc(NC(=O)C(=C)C)cc2C1=O] |

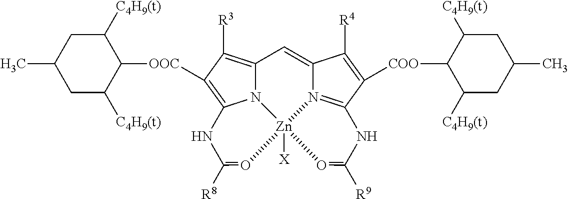

| Compound | | | |
|---|---|---|---|
| No. | R³ = R⁴ | R⁸ = R⁹ | X |
| A-61 | —CH₃ | 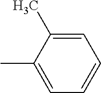 | 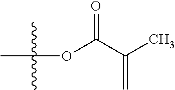 [SMILES: *OC(=O)C(=C)C] |
| A-62 | —CH₃ | 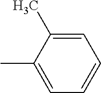 | 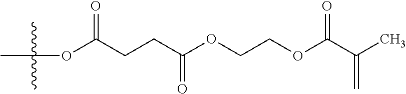 [SMILES: *OC(=O)CCC(=O)OCCOC(=O)C(=C)C] |
| A-63 | —CH₃ | 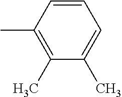 | 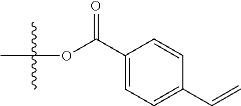 [SMILES: *OC(=O)c1ccc(C=C)cc1] |
| A-64 | —CH₃ | 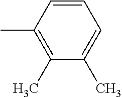 | 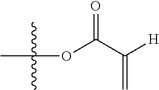 [SMILES: *OC(=O)C=C] |
| A-65 | —CH₃ | 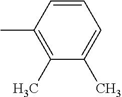 | 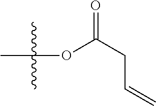 [SMILES: *OC(=O)CC=C] |

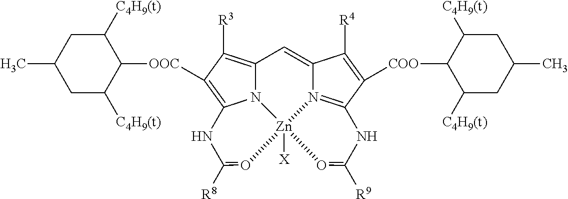

| Compound | | | |
|---|---|---|---|
| No. | R³ = R⁴ | R⁸ = R⁹ | X |
| A-66 | —C₃H₇(iso) | 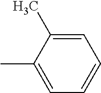 | 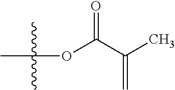 [SMILES: *OC(=O)C(=C)C] |
| A-67 | —C₃H₇(iso) | 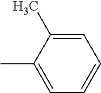 | 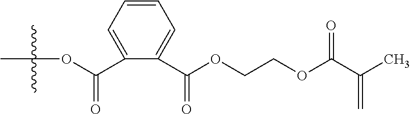 [SMILES: *OC(=O)c1ccccc1C(=O)OCCOC(=O)C(=C)C] |
| A-68 | —C₃H₇(iso) | 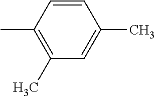 | 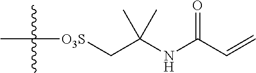 |
| A-69 | —C₃H₇(iso) | 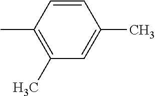 | 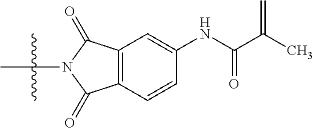 [SMILES: *N1C(=O)c2ccc(NC(=O)C(=C)C)cc2C1=O] |
| A-70 | —C₃H₇(iso) | 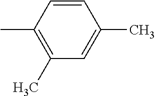 | 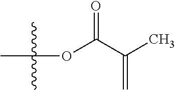 [SMILES: *OC(=O)C(=C)C] |

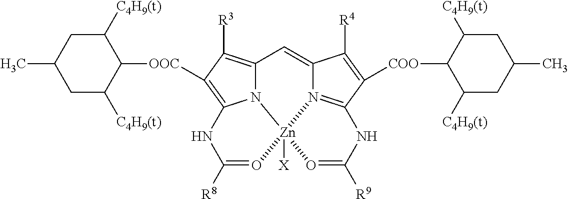

| Compound | | | |
|---|---|---|---|
| No. | R³ = R⁴ | R⁸ = R⁹ | X |
| A-71 | 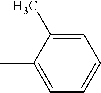 | 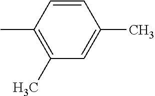 | 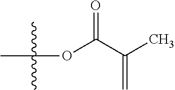 [SMILES: *OC(=O)C(=C)C] |
| A-72 | 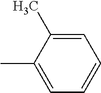 | 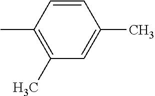 | 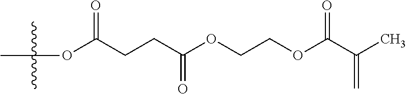 [SMILES: *OC(=O)CCC(=O)OCCOC(=O)C(=C)C] |
| A-73 | 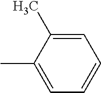 | 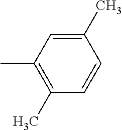 | 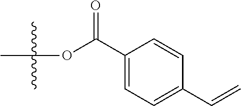 [SMILES: *OC(=O)c1ccc(C=C)cc1] |
| A-74 | 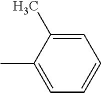 | 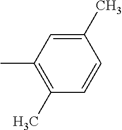 | 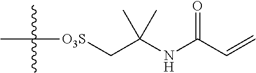 |
| A-75 | 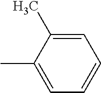 | 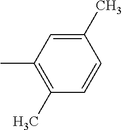 | 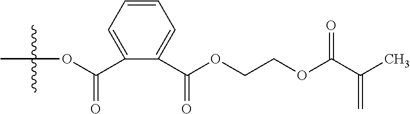 [SMILES: *OC(=O)c1ccccc1C(=O)OCCOC(=O)C(=C)C] |

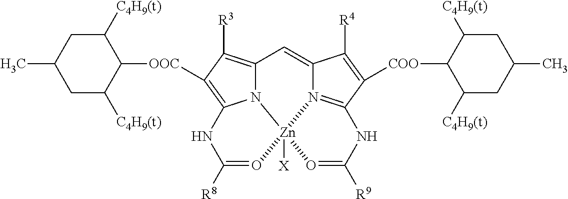

| Compound | | | |
|---|---|---|---|
| No. | R³ = R⁴ | R⁸ = R⁹ | X |
| A-76 | 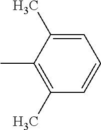 | 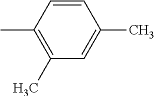 | 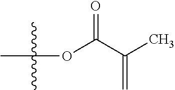 [SMILES: *OC(=O)C(=C)C] |
| A-77 | 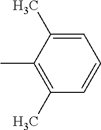 | 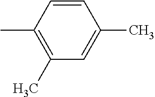 | 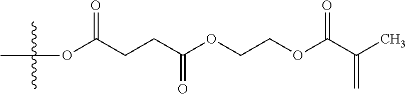 [SMILES: *OC(=O)CCC(=O)OCCOC(=O)C(=C)C] |
| A-78 | 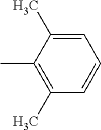 | 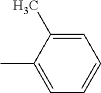 | 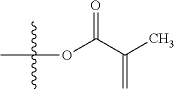 [SMILES: *OC(=O)C(=C)C] |
| A-79 | 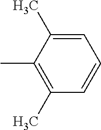 | 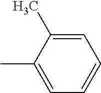 | 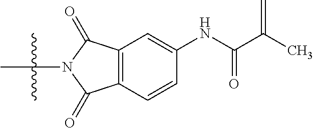 [SMILES: *N1C(=O)c2ccc(NC(=O)C(=C)C)cc2C1=O] |
| A-80 | 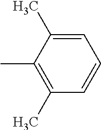 | 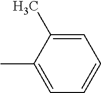 | 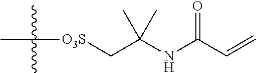 |

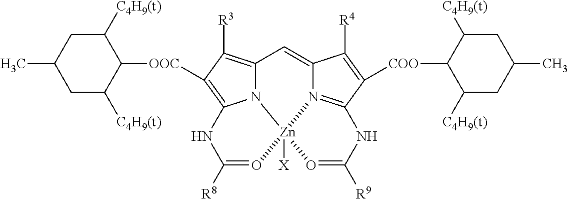

| Compound | | | | | |
|---|---|---|---|---|---|
| No. | R³ | R⁴ | R⁸ | R⁹ | X |
| A-81 | 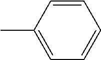 | —CH₃ | 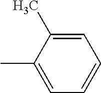 | 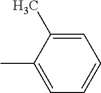 | 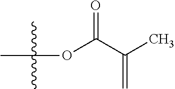 [SMILES: *OC(=O)C(=C)C] |
| A-82 | 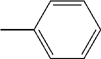 | —CH₃ | 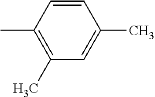 | 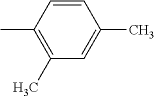 | 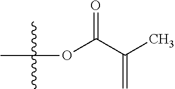 [SMILES: *OC(=O)C(=C)C] |
| A-83 | 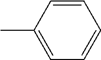 | —CH₃ | 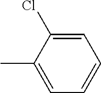 | 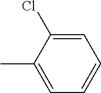 | 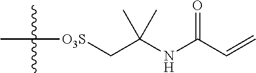 |

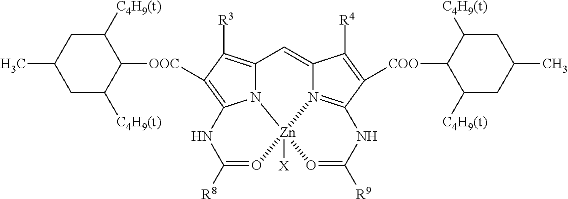

| Com- | | | | | |
|---|---|---|---|---|---|
| pound | | | | | |
| No. | R³ | R⁴ | R⁸ | R⁹ | X |
| A-84 | 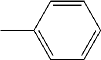 | —C₃H₇(iso) | 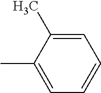 | 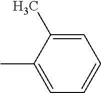 | 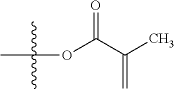 [SMILES: *OC(=O)C(=C)C] |
| A-85 | 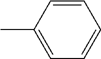 | —C₃H₇(iso) | 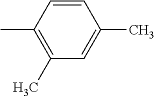 | 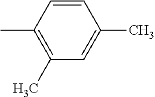 | 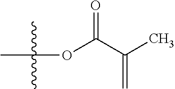 [SMILES: *OC(=O)C(=C)C] |
| A-86 | 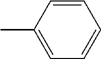 | —C₃H₇(iso) | 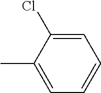 | 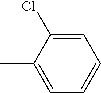 | 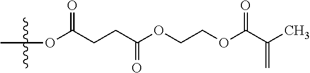 [SMILES: *OC(=O)CCC(=O)OCCOC(=O)C(=C)C] |

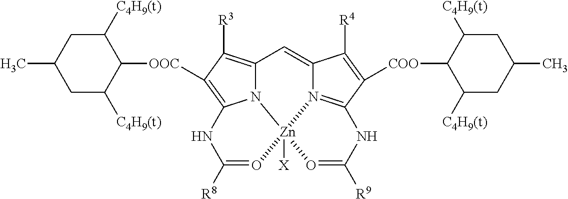

| Com- | | | | | |
|---|---|---|---|---|---|
| pound | | | | | |
| No. | R³ | R⁴ | R⁸ | R⁹ | X |
| A-87 | —C₃H₇(iso) | —C₃H₇(iso) | 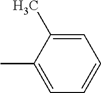 | 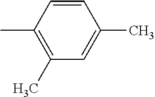 | 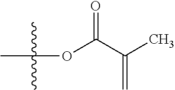 [SMILES: *OC(=O)C(=C)C] |
| A-88 | —C₃H₇(iso) | —C₃H₇(iso) | 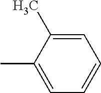 | 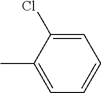 | 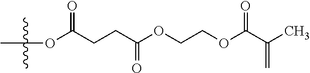 [SMILES: *OC(=O)CCC(=O)OCCOC(=O)C(=C)C] |
| A-89 | 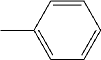 | 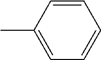 | 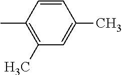 | 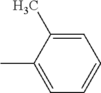 | 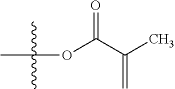 [SMILES: *OC(=O)C(=C)C] |

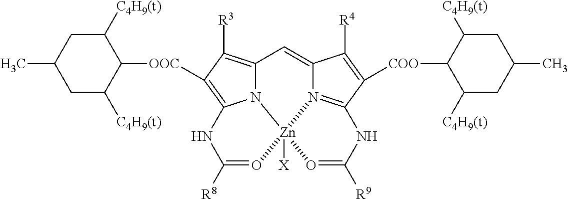

| Com- | | | | | |
|---|---|---|---|---|---|
| pound | | | | | |
| No. | R³ | R⁴ | R⁸ | R⁹ | X |
| A-90 | 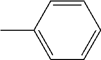 | 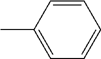 | 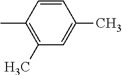 | 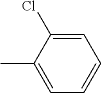 | 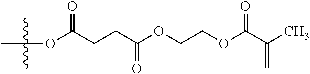 [SMILES: *OC(=O)CCC(=O)OCCOC(=O)C(=C)C] |
| A-91 | 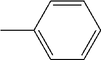 | 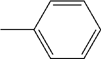 | 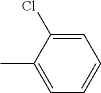 | 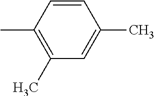 | 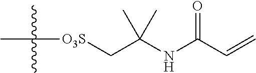 |
| A-92 | 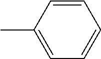 | 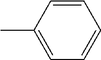 | 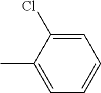 | 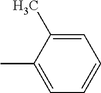 | 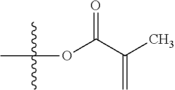 [SMILES: *OC(=O)C(=C)C] |

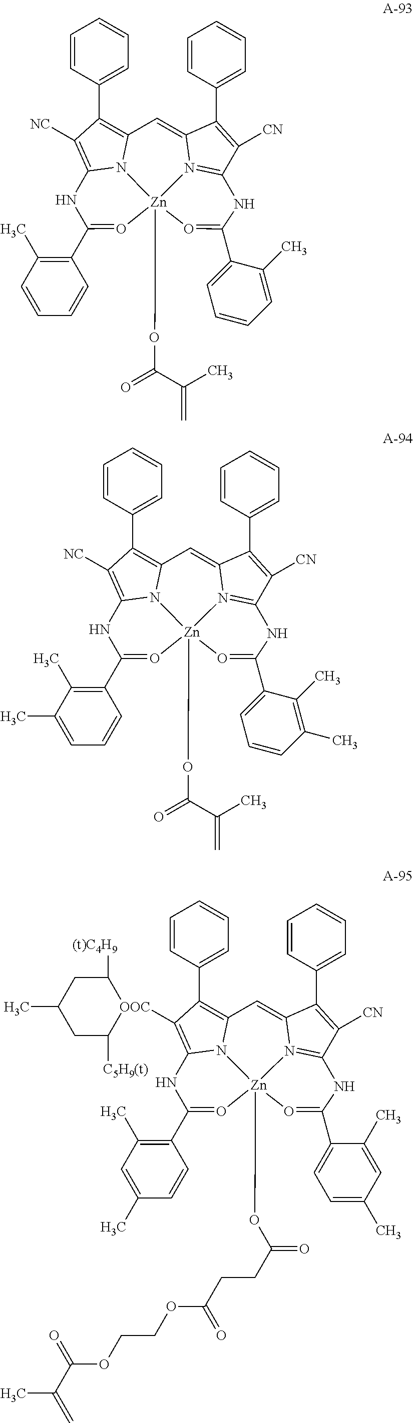

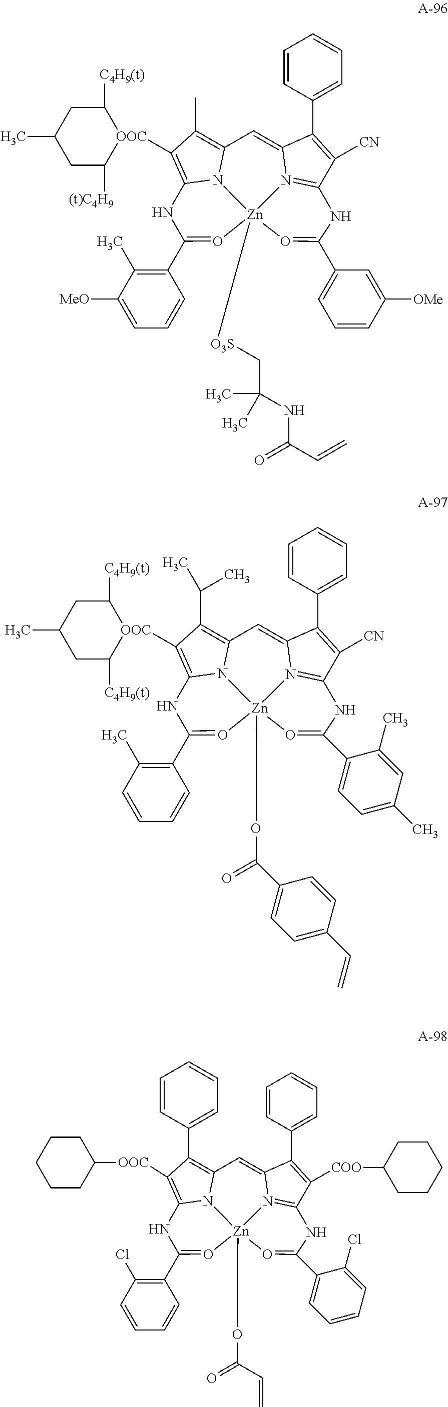

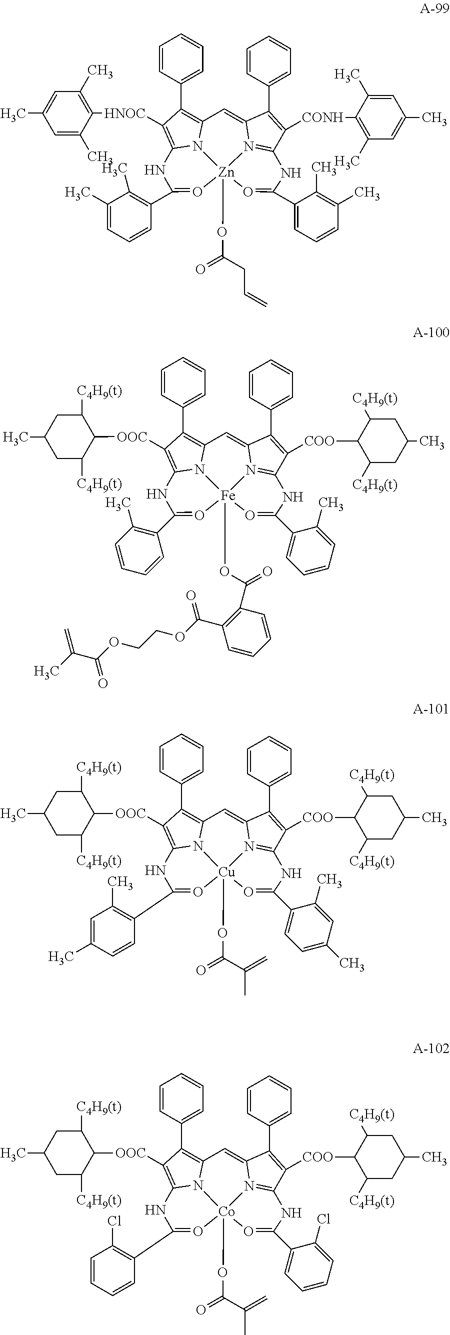

The specific metal complex compounds can be synthesized by a method described in U.S. Pat. Nos. 4,774,339 and 5,443,896, JP-A Nos. 2001-240761, 2002-155052, and 2008-076044, Japanese Patent No. 3614586, Aust. J. Chem., 1965, 11, 1835-1845, J. H. Boger et al., Heteroatom Chemistry, vol. 1, No. 5, 389 (1990), and the like.

In the colored composition according to the present invention, one of the specific metal complex compounds may be contained alone, or two or more of the specific metal complex compounds may be used in combination.

The content of the specific metal complex compound in the colored composition varies depending on the molecular weight and a molar absorption coefficient thereof, but is preferably from 0.1% by mass to 30% by mass and more preferably from 0.5% by mass to 20% by mass, with respect to the total solid content of the colored composition, on the basis of mass.

When the content of the specific metal complex compound is within the above range, a good color density (for example, a color density suitable for liquid crystal display) is obtained and patterning of pixels becomes good, which is thus advantageous.

In the colored composition according to the present invention, in addition to the specific metal complex compound, a dye having other structure or a pigment may be used in combination, as long as the effects of the present invention are not impaired.

(Dye Having Other Structure)

The colored composition according to the present invention may contain a dye having other structure, in addition to the specific metal complex compound. The dye having other structure is not particularly limited, and a known dye can be used. Examples of the dye include those described in JP-A Nos. S64-90403, S64-91102, H1-94301, and H6-11614, Japanese Patent No. 2592207, U.S. Pat. Nos. 4,808,501, 5,667,920, and 5,059,500, JP-A Nos. H5-333207, H6-35183, H6-51115, H6-194828, H8-211599, H4-249549, H10-123316, H11-302283, H7-286107, 2001-4823, H8-15522, H8-29771, H8-146215, H11-343437, H8-62416, 2002-14220, 2002-14221, 2002-14222, 2002-14223, H8-302224, H8-73758, H8-179120, H8-151531, and H6-230210, and the like.

As the chemical structure of the dye having other structure, dyes of pyrazole azo type, anilino azo type, triphenylmethane type, anthraquinone type, anthrapyridone type, benzylidene type, oxonol type, pyrazolotriazole azo type, pyridone azo type, cyanine type, phenothiazine type, pyrrolopyrazole azomethine type, xanthene type, squarilium type, phthalocyanine type, benzopyran type, indigo type, or the like can be used. Among them, a xanthene dye and a squarilium dye are preferable in view of hue.

In the colored composition according to the present invention, one type of dye may be contained alone, or two or more types of dyes may be used in combination.

The content of dye in the colored composition is preferably from 0.1% by mass to 30% by mass and more preferably from 0.5% by mass to 20% by mass, with respect to the total solid content of the colored composition, on the basis of mass.

When the content of dye is within the above range, a good color density (for example, a color density suitable for liquid crystal display) is obtained and patterning of pixels becomes good, which is thus advantageous.

Further, in the colored composition according to the present invention, in a case in which a specific metal complex compound and a dye having other structure are used in combination, it is preferable that the amount of the dye having a structure other than the specific metal complex compound is from 1% by mass to 200% by mass, and more preferably from 10% by mass to 150% by mass, with respect to the amount of the specific metal complex compound.

(Pigment)

In the colored composition according to the present invention, the above-described dye and a pigment can be used in combination.

The pigment is preferably a pigment having an average primary particle diameter of from 10 nm to 30 nm. In the above embodiment, a colored composition having excellent hue and contrast is obtained.

As the pigment, various inorganic pigments and organic pigments, which are conventionally known, can be used, but it is preferable to use an organic pigment from the viewpoint of reliability.

In the present invention, examples of the organic pigment include organic pigments described in paragraph 0093 of JP-A No. 2009-256572.

In particular,

C. I. Pigment Red 177, 224, 242, 254, 255, and 264;

C. I. Pigment Yellow 138, 139, 150, 180, and 185;

C. I. Pigment Orange 36, 38 and 71;

C. I. Pigment Green 7, 36, and 58;

C. I. Pigment Blue 15:6; and

C. I. Pigment Violet 23

are preferable from the viewpoint of color reproducibility; however, the present invention is not limited to these.

These organic pigments may be used alone, or various organic pigments may be used in combination in order to enhance the color purity.

In the case of using a pigment, the content of the pigment in the colored composition of the present invention is preferably from 0.5% by mass to 50% by mass, and more preferably from 1% by mass to 30% by mass, with respect to the total solid content of the composition. The content of the pigment being within the range described above is effective to ensure excellent color characteristics.

—Pigment Dispersant—

In a case in which the colored composition according to the present invention contains a pigment together with the specific metal complex compound, the colored composition may contain a pigment dispersant.

Examples of the pigment dispersant, which may be used in the present invention, may include polymer dispersants [for example, polyamidoamine or a salt thereof, polycarboxylic acid or a salt thereof, a high molecular weight unsaturated acid ester, a modified polyurethane, a modified polyester, a modified poly(meth)acrylate, a (meth)acryl-based copolymer, and a naphthalenesulfonic acid-formalin condensate], surfactants such as polyoxyethylene alkyl phosphoric acid ester, polyoxyethylene alkyl amine, and alkanolamine, and pigment derivatives.

The polymer dispersant may be further classified into a straight chain polymer, a terminal modified type polymer, a graft type polymer, and a block type polymer, on the basis of the structure.

Examples of a terminal modified type polymer which has an anchoring site to the pigment surface include polymers having a phosphoric acid group at the terminal described in JP-A No. H3-112992, Japanese Patent Application National Publication (JP-A) No. 2003-533455, and the like; polymers having a sulfonic acid group at the terminal described in JP-A No. 2002-273191 and the like; and polymers having a partial skeleton of an organic dye or a heterocycle described in JP-A No. H9-77994 and the like. Further, polymers obtained by introducing two or more anchoring sites to the pigment surface (acid group, basic group, partial skeleton of an organic dye, heterocycle, or the like) into the polymer terminal described in JP-A No. 2007-277514 also have excellent dispersion stability and are preferable.

Examples of a graft type polymer which has an anchoring site to the pigment surface include polyester dispersants, and specifically, a reaction product of poly(lower alkyleneimine) and polyester described in JP-A No. S54-37082, JP-A No. H8-507960, JP-A No. 2009-258668, and the like; a reaction product of polyallylamine and polyester described in JP-A No. H9-169821 and the like; a copolymer of a macromonomer and a nitrogen atom-containing monomer described in JP-A Nos. H10-339949 and 2004-37986 and the like; a graft type polymer having a partial skeleton of an organic dye or a heterocycle described in JP-A Nos. 2003-238837, 2008-9426, and 2008-81732; and a copolymer of a macromonomer and an acid group-containing monomer described in JP-A No. 2010-106268 and the like. In particular, an amphoteric dispersing resin having a basic group and an acidic group described in JP-A No. 2009-203462 is particularly preferable, from the viewpoints of dispersibility and dispersion stability of the pigment dispersion and developability exhibited by a colored composition using the pigment dispersion.

As the macromonomer which is used in the production of a graft type polymer having an anchoring site to the pigment surface by radical polymerization, a known macromonomer can be used, and examples thereof include MACROMONOMER AA-6 (polymethyl methacrylate in which the terminal group is a methacryloyl group), AS-6 (polystyrene in which the terminal group is a methacryloyl group), AN-6S (a copolymer of styrene and acrylonitrile in which the terminal group is a methacryloyl group), and AB-6 (polybutyl acrylate in which the terminal group is a methacryloyl group), manufactured by TOAGOSEI CO., LTD.; PLACCEL FM5 (∈-caprolactone 5 mol equivalent adduct of 2-hydroxyethyl methacrylate), FA10L (∈-caprolactone 10 mol equivalent adduct of 2-hydroxyethyl acrylate), manufactured by Daicel Chemical Industries, Ltd.; and a polyester based macromonomer described in JP-A No. H2-272009. Above all, particularly, a polyester based macromonomer which has excellent flexibility and excellent solvent affinity is particularly preferable from the viewpoints of dispersibility and dispersion stability of the pigment dispersion and developability exhibited by a colored composition using the pigment dispersion, and further, a polyester based macromonomer represented by Formula (I) described in JP-A No. H2-272009 is most preferable.

As a block type polymer which has an anchoring site to the pigment surface, block type polymers described in JP-A Nos. 2003-49110 and 2009-52010, and the like are preferable.

The pigment dispersant which may be used in the present invention is also available as a commercially available product, and specific examples thereof include “DA-7301” manufactured by Kusumoto Chemicals, Ltd., “DISPERBYK-101 (polyamidoamine phosphoric acid salt), 107 (carboxylic acid ester), 110 (copolymer containing an acid group), 130 (polyamide), 161, 162, 163, 164, 165, 166, and 170 (high molecular weight copolymer)” and “BYK-P104 and P105 (high molecular weight unsaturated polycarboxylic acid)”, manufactured by BYK Chemie; “EFKA 4047, 4050 to 4010 to 4165 (polyurethane type), EFKA 4330 to 4340 (block copolymer), 4400 to 4402 (modified polyacrylate), 5010 (polyesteramide), 5765 (high molecular weight polycarboxylic acid salt), 6220 (fatty acid polyester), 6745 (phthalocyanine derivative), and 6750 (azo pigment derivative)”, manufactured by EFKA; “AJISPER PB821, PB822, PB880, and PB881”, manufactured by Ajinomoto-Fine-Techno Co., Ltd.; “FLORENE TG-710 (urethane oligomer)” and “POLYFLOW No. 50E and No. 300 (acryl-based copolymer)”, manufactured by Kyoeisha Chemical Co., Ltd.; “DISPERLON KS-860, 873SN, 874, #2150 (aliphatic polyvalent carboxylic acid), #7004 (polyether ester), DA-703-50, DA-705, and DA-725”, manufactured by Kusumoto Chemicals, Ltd.; “DEMOL RN, N (naphthalenesulfonic acid-formalin polycondensate), MS, C, and SN-B (aromatic sulfonic acid-formalin polycondensate)”, “HOMOGENOL L-18 (high molecular weight polycarboxylic acid)”, “EMULGEN 920, 930, 935, and 985 (polyoxyethylene nonyl phenyl ether)”, and “ACETAMINE 86 (stearylamine acetate)”, manufactured by Kao Corporation; “SOLSPERSE 5000 (phthalocyanine derivative), 22000 (azo pigment derivative), 13240 (polyesteramine), 3000, 17000, 27000 (polymer having a functional moiety at the terminal portion),

24000, 28000, 32000, and 38500 (graft type polymer)”, manufactured by The Lubrizol Corp., “NIKKOL T106 (polyoxyethylene sorbitan monooleate) and MYS-IEX (polyoxyethylene monostearate)”, manufactured by Nikko Chemicals Co., Ltd.; HINOACT T-8000E and the like, manufactured by Kawaken Fine Chemicals Co., Ltd.; ORGANOSILOXANE POLYMER KP341, manufactured by Shin-Etsu Chemical Co., Ltd.; “W001: cationic surfactant”, nonionic surfactants such as polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, or sorbitan fatty acid ester, and anionic surfactants such as “W004, W005, and W017”, available from Yusho Co., Ltd.; “EFKA-46, EFKA-47, EFKA-47EA, EFKA POLYMER 100, EFKA POLYMER 400, EFKA POLYMER 401, and EFKA POLYMER 450”, manufactured by Morishita Industries Co., Ltd.; polymer dispersants such as “DISPERSE AID 6, DISPERSE AID 8, DISPERSE AID 15, and DISPERSE AID 9100”, manufactured by San Nopco Limited; “ADEKA PLURONIC L31, F38, L42, L44, L61, L64, F68, L72, P95, F77, P84, F87, P94, L101, P103, F108, L121, and P-123”, manufactured by ADEKA Corporation; and “IONET (trade name) S-20”, manufactured by Sanyo Chemical Industries Co., Ltd.

These pigment dispersants may be used alone, or two or more of them may be used in combination. In the present invention, it is particularly preferable to use a pigment derivative and a polymer dispersant in combination. Further, the pigment dispersant according to the invention may be used in combination with an alkali-soluble resin together with the above terminal modified type polymer, graft type polymer, or block type polymer, having an anchoring site to the pigment surface. Examples of the alkali-soluble resin include a (meth)acrylic acid copolymer, an itaconic acid copolymer, a crotonic acid copolymer, a maleic acid copolymer, a partially esterified maleic acid copolymer, an acidic cellulose derivative having a carboxylic acid in the side chain, and a resin obtained by modifying an acid anhydride to a polymer having a hydroxyl group; and among them, a (meth)acrylic acid copolymer is particularly preferable. Further, a copolymer of N-substituted maleimide monomer described in JP-A No. H10-300922, an ether dimer copolymer described in JP-A No. 2004-300204, and an alkali-soluble resin having a polymerizable group described in JP-A No. H7-319161 are also preferable.

The content of the pigment dispersant in the colored composition is preferably from 1 part by mass to 80 parts by mass, more preferably from 5 parts by mass to 70 parts by mass, and even more preferably from 10 parts by mass to 60 parts by mass, with respect to 100 parts by mass of pigment.

Specifically, in the case of using a polymer dispersant, the amount of the polymer dispersant used is preferably in a range of from 5 parts to 100 parts, and more preferably in a range of from 10 parts to 80 parts, with respect to 100 parts by mass of pigment, in terms of mass.

Moreover, in the case of using a pigment derivative in combination, the amount of the pigment derivative used is preferably in a range of from 1 part to 30 parts, more preferably in a range of from 3 parts to 20 parts, and particularly preferably in a range of from 5 parts to 15 parts, with respect to 100 parts by mass of pigment, in terms of mass.

<Other Components>

The colored composition according to the present invention may further contain other components described below, as long as the effects of the present invention are not impaired.

(Anthraquinone Compound)

The colored composition according to the present invention may contain an anthraquinone compound.

By the inclusion of an anthraquinone compound, the contrast of a color filter which is obtained by using the colored composition of the present invention can be enhanced effectively.

The anthraquinone compound according to the invention is a compound having an absorption maximum at 400 nm to 700 nm, and in the present invention, the anthraquinone compound is preferably an anthraquinone compound having an absorption maximum at 500 nm to 700 nm, and particularly preferably having an absorption maximum at 550 nm to 700 nm. As long as the anthraquinone compound has such an absorption maximum, there is no particular limitation on the structure, and the anthraquinone compound has excellent effect on the improvement of contrast.

Among the anthraquinone compounds according to the invention, a diaminoanthraquinone compound represented by the following Formula (IX) is preferable.

Among the diaminoanthraquinone compounds, from the viewpoint of absorption characteristics, a compound represented by Formula (X) below is more preferable, and from the viewpoint of thermal stability, a compound represented by Formula (XI) below is more preferable, and further, from the viewpoint of making the absorption characteristics and thermal stability be compatible, a compound represented by Formula (XII) below or Formula (XIII) below is particularly preferable.

First, the compound represented by the following Formula (IX) is described.

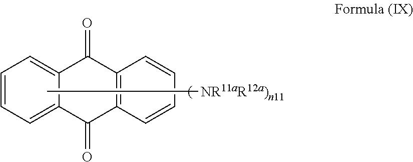

In Formula (IX), R^{11a} and R^{12a} each independently represent a hydrogen atom, an alkyl group, an aryl group, or a heterocyclic group; and R^{11a} and R^{12a} do not represent a hydrogen atom at the same time. n¹¹ represents an integer of from 1 to 4.

The alkyl group represented by R^{11a} or R^{12a} is preferably an alkyl group having from 1 to 30 carbon atoms, more preferably from 1 to 20 carbon atoms, and particularly preferably from 1 to 10 carbon atoms, and examples thereof include methyl, ethyl, iso-propyl, tert-butyl, n-octyl, n-decyl, n-hexadecyl, cyclopropyl, cyclopentyl, and cyclohexyl.

The aryl group represented by R^{11a} or R^{12a} is preferably an aryl group having from 6 to 30 carbon atoms, more preferably from 6 to 20 carbon atoms, and particularly preferably from 6 to 12 carbon atoms, and examples thereof include phenyl, o-methylphenyl, p-methylphenyl, 2,6-dimethylphenyl, 2,6-diethylphenyl biphenyl, 2,6-dibromophenyl, naphthyl, anthranyl, and phenanthryl.

The heterocyclic group represented by R^{11a} or R^{12a} is preferably a heterocyclic group having from 1 to 30 carbon atoms, and more preferably from 1 to 12 carbon atoms, and examples of the heteroatom include a nitrogen atom, an oxygen atom, and a sulfur atom. Examples of the heterocyclic group include imidazolyl, pyridyl, quinolyl, furyl, thienyl, benzoxazolyl, benzimidazolyl, benzothiazolyl, naphthothiazolyl, a carbazolyl group, and an azepinyl group.

Moreover, the alkyl group, aryl group, heterocyclic group represented by R^{11a} or R^{12a} may further have a substituent.

Examples of the substituent in the case of having a substituent include an alkyl group (preferably an alkyl group having from 1 to 30 carbon atoms, more preferably from 1 to 20 carbon atoms, and particularly preferably from 1 to 10 carbon atoms; examples thereof include methyl, ethyl, iso-propyl, tert-butyl, n-octyl, n-decyl, n-hexadecyl, cyclopropyl, cyclopentyl, and cyclohexyl.), an alkenyl group (preferably an alkenyl group having from 2 to 30 carbon atoms, more preferably from 2 to 20 carbon atoms, and particularly preferably from 2 to 10 carbon atoms; examples thereof include vinyl, allyl, 2-butenyl, and 3-pentenyl.), an alkynyl group (preferably an alkynyl group having from 2 to 30 carbon atoms, more preferably from 2 to 20 carbon atoms, and particularly preferably from 2 to 10 carbon atoms; examples thereof include propargyl and 3-pentynyl.), an aryl group (preferably an aryl group having from 6 to 30 carbon atoms, more preferably from 6 to 20 carbon atoms, and particularly preferably from 6 to 12 carbon atoms; examples thereof include phenyl, p-methylphenyl, biphenyl, naphthyl, anthranyl, and phenanthryl.),

an amino group (preferably an amino group having from 0 to 30 carbon atoms, preferably from 0 to 20 carbon atoms, and particularly preferably from 0 to 10 carbon atoms; an alkylamino group, an arylamino group, and a heterocyclic amino group are included. Specific examples include amino, methylamino, dimethylamino, diethylamino, dibenzylamino, diphenylamino, and ditolylamino.), an alkoxy group (preferably an alkoxy group having from 1 to 30 carbon atoms, more preferably from 1 to 20 carbon atoms, and particularly preferably from 1 to 10 carbon atoms; examples thereof include methoxy, ethoxy, butoxy, and 2-ethylhexyloxy.), an aryloxy group (preferably an aryloxy group having from 6 to 30 carbon atoms, more preferably from 6 to 20 carbon atoms, and particularly preferably from 6 to 12 carbon atoms; examples thereof include phenyloxy, 1-naphthyloxy, and 2-naphthyloxy.), an aromatic heterocyclic oxy group (preferably an aromatic heterocyclic oxy group having from 1 to 30 carbon atoms, more preferably from 1 to 20 carbon atoms, and particularly preferably from 1 to 12 carbon atoms; examples thereof include pyridyloxy, pyrazyloxy, pyrimidyloxy, and quinolyloxy.),

an acyl group (preferably an acyl group having from 1 to 30 carbon atoms, more preferably from 1 to 20 carbon atoms, and particularly preferably from 1 to 12 carbon atoms; examples thereof include acetyl, benzoyl, formyl, and pivaloyl.), an alkoxycarbonyl group (preferably an alkoxycarbonyl group having from 2 to 30 carbon atoms, more preferably from 2 to 20 carbon atoms, and particularly preferably from 2 to 12 carbon atoms; examples thereof include methoxycarbonyl and ethoxycarbonyl.), an aryloxycarbonyl group (preferably an aryloxycarbonyl group having from 7 to 30 carbon atoms, more preferably from 7 to 20 carbon atoms, and particularly preferably from 7 to 12 carbon atoms; examples thereof include phenyloxycarbonyl.), an acyloxy group (preferably an acyloxy group having from 2 to 30 carbon atoms, more preferably from 2 to 20 carbon atoms, and particularly preferably from 2 to 10 carbon atoms; examples thereof include acetoxy and benzoyloxy.), an acylamino group (preferably an acylamino group having from 2 to 30 carbon atoms, more preferably from 2 to 20 carbon atoms, and particularly preferably from 2 to 10 carbon atoms; examples thereof include acetylamino and benzoylamino.), an alkoxycarbonylamino group (preferably an alkoxycarbonylamino group having from 2 to 30 carbon atoms, more preferably from 2 to 20 carbon atoms, and particularly preferably from 2 to 12 carbon atoms; examples thereof include methoxycarbonylamino.),

an aryloxycarbonylamino group (preferably an aryloxycarbonylamino group having from 7 to 30 carbon atoms, more preferably from 7 to 20 carbon atoms, and particularly preferably from 7 to 12 carbon atoms; examples thereof include phenyloxycarbonylamino.), a sulfonylamino group (preferably a sulfonylamino group having from 1 to 30 carbon atoms, more preferably from 1 to 20 carbon atoms, and particularly preferably from 1 to 12 carbon atoms; examples thereof include methanesulfonylamino and benzenesulfonylamino.), a sulfamoyl group (preferably a sulfamoyl group having from 0 to 30 carbon atoms, more preferably from 0 to 20 carbon atoms, and particularly preferably from 0 to 12 carbon atoms; examples thereof include sulfamoyl, methylsulfamoyl, dimethylsulfamoyl, and phenylsulfamoyl.),

a carbamoyl group (preferably a carbamoyl group having from 1 to 30 carbon atoms, more preferably from 1 to 20 carbon atoms, and particularly preferably from 1 to 12 carbon atoms; examples thereof include carbamoyl, methylcarbamoyl, diethylcarbamoyl, and phenylcarbamoyl.), an alkylthio group (preferably an alkylthio group having from 1 to 30 carbon atoms, more preferably from 1 to 20 carbon atoms, and particularly preferably from 1 to 12 carbon atoms; examples thereof include methylthio and ethylthio.), an arylthio group (preferably an arylthio group having from 6 to 30 carbon atoms, more preferably from 6 to 20 carbon atoms, and particularly preferably from 6 to 12 carbon atoms; examples thereof include phenylthio.),

an aromatic heterocyclic thio group (preferably an aromatic heterocyclic thio group having from 1 to 30 carbon atoms, more preferably from 1 to 20 carbon atoms, and particularly preferably from 1 to 12 carbon atoms; examples thereof include pyridylthio, 2-benzimidazolylthio, 2-benzoxazolylthio, and 2-benzothiazolylthio.), a sulfonyl group (preferably a sulfonyl group having from 1 to 30 carbon atoms, more preferably from 1 to 20 carbon atoms, and particularly preferably from 1 to 12 carbon atoms; examples thereof include mesyl and tosyl.), a sulfinyl group (preferably a sulfinyl group having from 1 to 30 carbon atoms, more preferably from 1 to 20 carbon atoms, and particularly preferably from 1 to 12 carbon atoms; examples thereof include methanesulfinyl and benzenesulfinyl.), a ureido group (preferably a ureido group having from 1 to 30 carbon atoms, more preferably from 1 to 20 carbon atoms, and particularly preferably from 1 to 12 carbon atoms; examples thereof include ureido, methylureido, and phenylureido.), a phosphoric acid amido group (preferably a phosphoric acid amido group having from 1 to 30 carbon atoms, more preferably from 1 to 20 carbon atoms, and particularly preferably from 1 to 12 carbon atoms; examples thereof include diethylphosphoric acid amido and phenylphosphoric acid amido.),

a hydroxyl group, a mercapto group, a halogen atom (for example, a fluorine atom, a chlorine atom, a bromine atom, or an iodine atom), a cyano group, a sulfo group, a carboxyl group, a nitro group, a hydroxamic acid group, a sulfino group, a hydrazino group, an imino group, a heterocyclic group (preferably a heterocyclic group having from 1 to 30 carbon atoms, and more preferably from 1 to 12 carbon atoms; examples of the heteroatom include a nitrogen atom, an oxygen atom, and a sulfur atom. Specific examples include imidazolyl, pyridyl, quinolyl, furyl, thienyl, piperidyl, morpholino, benzoxazolyl, benzimidazolyl, benzothiazolyl, a carbazolyl group, and an azepinyl group.), and a silyl group (preferably a silyl group having from 3 to 40 carbon atoms, more preferably from 3 to 30 carbon atoms, and particularly preferably from 3 to 24 carbon atoms; examples thereof include trimethylsilyl and triphenylsilyl.). These substituents may be further substituted.

In Formula (IX) above, n¹¹ represents an integer of from 1 to 4; and in a case in which n¹¹ represents an integer of from 2 to 4, plural NR^{11a}R^{12a}s may be the same or different.

Next, the compound represented by Formula (X) is described.

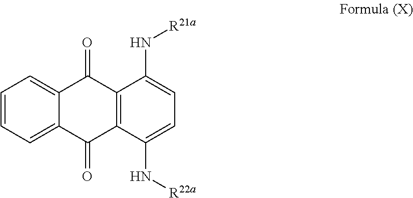

In Formula (X), R^{21a} and R^{22a} each independently represent an alkyl group or an aryl group.

The alkyl group represented by R^{21a} or R^{22a} is preferably an alkyl group having from 1 to 30 carbon atoms, more preferably from 1 to 20 carbon atoms, and particularly preferably from 1 to 10 carbon atoms, and examples thereof include methyl, ethyl, iso-propyl, tert-butyl, n-octyl, n-decyl, n-hexadecyl, cyclopropyl, cyclopentyl, and cyclohexyl.

The aryl group represented by R^{21a} or R^{22a} is preferably an aryl group having from 6 to 30 carbon atoms, more preferably from 6 to 20 carbon atoms, and particularly preferably from 6 to 12 carbon atoms, and examples thereof include phenyl, o-methylphenyl, p-methylphenyl, 2,6-dimethylphenyl, 2,6-diethylphenyl biphenyl, 2,6-dibromophenyl, naphthyl, anthranyl, and phenanthryl.

Further, the alkyl group and aryl group represented by R^{21a} or R^{22a} may further have a substituent, and examples of the substituent include the examples described above as the substituent of the alkyl group, aryl group and heterocyclic group represented by R^{11a} or R^{12a} in Formula (IX) above. Above all, preferable examples of the substituent include an alkyl group, an aryl group, an amino group, an alkoxy group, an aryloxy group, an acyl group, an alkoxycarbonyl group, an aryloxycarbonyl group, an acyloxy group, an acylamino group, a sulfonylamino group, a sulfamoyl group, a sulfonyl group, a ureido group, a hydroxyl group, a halogen atom, a sulfo group, and a carboxyl group. Details and preferable embodiments of these substituents are described above.

Next, the compound represented by Formula (XI) is described.

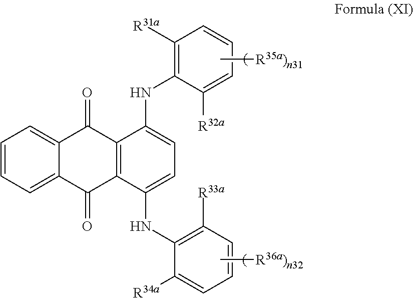

In Formula (XI), R^{31a}, R^{32a}, R^{33a}, and R^{34a} each independently represent an alkyl group or a halogen atom.

The alkyl group represented by R^{31a}, R^{32a}, R^{33a}, or R^{34a} is preferably an alkyl group having from 1 to 10 carbon atoms, more preferably from 1 to 5 carbon atoms, and particularly preferably 1 or 2 carbon atoms, and examples thereof include methyl, ethyl, iso-propyl, tert-butyl, n-octyl, n-decyl, n-hexadecyl, cyclopropyl, cyclopentyl, and cyclohexyl.

Examples of the halogen atom represented by R^{31a}, R^{32a}, R^{33a}, or R^{34a} include a fluorine atom, a chlorine atom, a bromine atom, and an iodine atom; and a chlorine atom and a bromine atom are preferable.

In Formula (XI), R^{35a} and R^{36a} each independently represent an alkyl group, an alkoxy group, an aryloxy group, a sulfo group or a salt thereof, an aminosulfonyl group, an alkoxysulfonyl group, or a phenoxysulfonyl group.

The alkyl group represented by R^{35a} or R^{36a} has the same definition as the alkyl group represented by R^{31a}, R^{32a}, R^{33a}, or R^{34a}, and preferable embodiments are also the same.

The alkoxy group represented by R^{35a} or R^{36a} is preferably an alkoxy group having from 1 to 30 carbon atoms, more preferably from 1 to 20 carbon atoms, and particularly preferably from 1 to 10 carbon atoms, and examples thereof include methoxy, ethoxy, butoxy, and 2-ethylhexyloxy.

The aryl oxy group represented by R^{35a} or R^{36a} is preferably an aryloxy group having from 6 to 30 carbon atoms, more preferably from 6 to 20 carbon atoms, and particularly preferably from 6 to 12 carbon atoms, and examples thereof include phenyloxy, 1-naphthyloxy, and 2-naphthyloxy.

The sulfo group or salt thereof represented by R^{35a} or R^{36a} is preferably a group derived from a sulfonic acid group or a sulfonic acid salt. The sulfonic acid salt is preferably a quaternary ammonium salt or a salt of amine, and particularly preferably a sulfonic acid salt having from 4 to 30 carbon atoms (preferably 10 to 30 carbon atoms, and more preferably from 15 to 30 carbon atoms).

The aminosulfonyl group represented by R^{35a} or R^{36a} is preferably an aminosulfonyl group having from 1 to 30 carbon atoms, more preferably from 2 to 20 carbon atoms, and particularly preferably from 2 to 15 carbon atoms, and specific examples thereof include an ethylaminosulfonyl group, a propylaminosulfonyl group, an isopropylaminosulfonyl group, a butylaminosulfonyl group, an isobutylaminosulfonyl group, a sec-butylaminosulfonyl group, a pentylaminosulfonyl group, an isopentylaminosulfonyl group, a hexylaminosulfonyl group, a cyclohexylaminosulfonyl group, a 2-ethylhexyl aminosulfonyl group, a decylaminosulfonyl group, a dodecylaminosulfonyl group, and a phenylaminosulfonyl group, and as dialkylaminosulfonyl groups, a dimethylaminosulfonyl group, a diethylaminosulfonyl group, a dipropylaminosulfonyl group, a diisopropylaminosulfonyl group, a dibutylaminosulfonyl group, a di-sec-butylaminosulfonyl group, a di-sec-propylaminosulfonyl group, a dihexylaminosulfonyl group, a methylethylaminosulfonyl group, a methylbutylaminosulfonyl group, an ethylbutylaminosulfonyl group, and a phenylmethylaminosulfonyl group. Above all, a dialkylaminosulfonyl group in which the alkyl moiety has from 4 to 15 carbon atoms is particularly preferable.

The alkoxysulfonyl group represented by R^{35a} or R^{36a} is preferably an alkoxysulfonyl group having from 1 to 30 carbon atoms, more preferably from 2 to 20 carbon atoms, even more preferably from 2 to 15 carbon atoms, and particularly preferably from 4 to 15 carbon atoms, and specific examples thereof include a butyloxysulfonyl group, a hexyloxysulfonyl group, a decyloxysulfonyl group, and a dodecyloxysulfonyl group.

The phenoxysulfonyl group represented by R^{35a} or R^{36a} is preferably a phenoxysulfonyl group having from 6 to 30 carbon atoms, more preferably from 6 to 20 carbon atoms, and particularly preferably from 6 to 15 carbon atoms, and specific examples thereof include a phenoxysulfonyl group and a tolylsulfonyl group.

R^{35a} and R^{36a} may further have a substituent, and examples of the substituent include the examples described above as the substituent of the alkyl group, aryl group and heterocyclic group represented by R^{11a} or R^{12a} in Formula (IX) above.

In Formula (XI), n³¹ and n³² each represent an integer of from 0 to 2; and in a case in which n³¹ or n³² represents 2, plural R^{35a}s or plural R^{36a}s may be the same as or different from each other.

Among the diaminoanthraquinone compounds described above, a compound selected from the group consisting of a compound represented by Formula (XII) described below and a compound represented by Formula (XIII) described below is preferable.

(Compound Represented by Formula (XII))

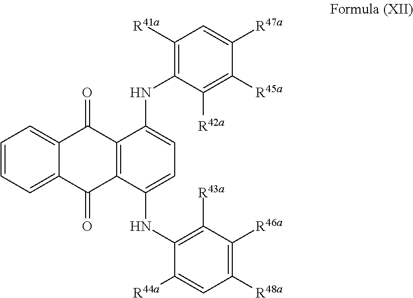

In Formula (XII), R^{41a}, R^{42a}, R^{43a}, and R^{44a} each independently represent an alkyl group or a halogen atom; and the alkyl group and the halogen atom have the same definitions as the alkyl group and the halogen atom represented by R^{31a}, R^{32a}, R^{33a}, or R^{34a} in Formula (XI) above, respectively, and preferable embodiments are also the same.

R^{45a}, R^{46a}, R^{47a}, and R^{48a} in Formula (XII) above each independently represent an alkyl group, a sulfo group or a salt thereof, or an aminosulfonyl group. One of R^{45a} and R^{47a} and one of R^{46a} and R^{48a} each represent a sulfo group or a salt thereof, or an aminosulfonyl group. The alkyl group, the sulfo group or salt thereof, and the aminosulfonyl group represented by R^{45a}, R^{46a}, R^{47a}₅ and R^{48a} have the same definitions as the alkyl group, the sulfo group or salt thereof, and the aminosulfonyl group represented by R^{35a} or R^{36a} in Formula (XI) above, and preferable embodiments are also the same.

(Compound Represented by Formula (XIII))

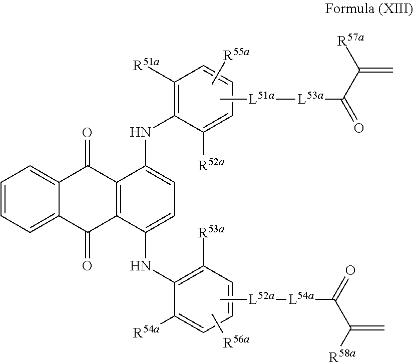

In Formula (XIII), R^{51a}, R^{52a}, R^{53a}, and R^{54a} each independently represent an alkyl group or a halogen atom; and the alkyl group and the halogen atom have the same definitions as the alkyl group and the halogen atom represented by R^{31a}, R^{32a}, R^{33a}, and R^{34a} in Formula (XI) above, respectively, and preferable embodiments are also the same.

In Formula (XIII) above, R^{55a} and R^{56a} each independently represent a hydrogen atom or an alkyl group, and the alkyl group has the same definition as the alkyl group represented by R^{31a}, R^{32a}, R^{33a}, and R^{34a} in Formula (XI) above, and preferable embodiments are also the same.

Further, R^{57a} and R^{58a} each independently represent a hydrogen atom or an alkyl group, and the alkyl group is preferably an alkyl group having from 1 to 10 carbon atoms, more preferably an alkyl group having from 1 to 5 carbon atoms, and particularly preferably a methyl group.

In Formula (XIII), L^{51a} and L^{52a} each independently represent a divalent linking group, and preferably represent an alkylene group having from 1 to 10 carbon atoms, an arylene group having from 6 to 20 carbon atoms, —O—, —S—, —NR—, —SO₂—, —CO—, or a divalent linking group formed by combining two or more of these. L^{51a} and L^{52a} more preferably represent an alkylene group having from 1 to 10 carbon atoms, a phenylene group having from 6 to 12 carbon atoms, an aminosulfonyl group, or a divalent linking group formed by combining two or more of these, and particularly preferably represent an alkylene group having from 1 to 10 carbon atoms, an aminosulfonyl group, or a divalent linking group formed by combining two or more of these.

The alkylene group having from 1 to 10 carbon atoms or a divalent linking group formed by combining this group with —O— or the like may be unsubstituted or may have a substituent, and examples include ethylene, propylene, a butylene group, an ethyleneoxy group, a propyleneoxy group, an ethyleneaminosulfonyl group, a propyleneaminosulfonyl group, a butyleneaminosulfonyl group, a pentyleneaminosulfonyl group, and a 1-methylethylenesulfonyl group. Above all, an alkyleneaminosulfonyl group having from 2 to 10 carbon atoms (examples: an ethyleneaminosulfonyl group, a propyleneaminosulfonyl group, a butyleneaminosulfonyl group, and a pentyleneaminosulfonyl group) is preferable.

The arylene group having from 6 to 20 carbon atoms or a divalent linking group formed by combining this group with —O— or the like may be unsubstituted or may have a substituent, and examples include phenylene, biphenylene, and a phenyleneaminosulfonyl group, and above all, an aryleneaminosulfonyl group having from 6 to 12 carbon atoms (example: phenyleneaminosulfonyl group and the like) is preferable.

Moreover, R in —NR— represents a hydrogen atom or an alkyl group having from 1 to 10 carbon atoms. Specific examples of the alkyl group include a methyl group, an ethyl group, a propyl group, an isopropyl group, a butyl group, an isobutyl group, a sec-butyl group, and a 2-ethylhexyl group.

In Formula (XIII), L^{53a} and L^{54a} each independently represent an oxygen atom or an —NH— group.

Among the above compounds, a preferable anthraquinone compound in the present invention is a compound selected from the group consisting a diaminoanthraquinone compound represented by Formula (XII) above and a diaminoanthraquinone compound represented by Formula (XIII) above, and further, the following cases are particularly preferable. Namely,

in Formula (XII) above, a case is preferable, in which R^{41a}, R^{42a}, R^{43a}, and R^{44a} each represent a methyl group, an ethyl group, or a bromine atom, R^{45a} and R^{46a} each represent an aminosulfonyl group having from 2 to 15 carbon atoms, and R^{47a} and R^{48a} each represent a methyl group; and

in Formula (XIII) above, a case is preferable, in which R^{51a}, R^{52a}, R^{53a}, and R^{54a} each represent a methyl group, an ethyl group, or a bromine atom, R^{55a} and R^{56a} each represent a hydrogen atom or a methyl group, R^{57a} and R^{58a} each represent a hydrogen atom or a methyl group, L^{51a} and L^{52a} each represent an alkyleneaminosulfonyl group having from 1 to 10 carbon atoms, an aralkyleneaminosulfonyl group having from 7 to 12 carbon atoms, or an alkyleneoxy group having from 2 to 10 carbon atoms, and L^{53a} and L^{54a} each represent an oxygen atom.

In the above case, when the dye compound described below and the dipyrromethene metal complex compound represented by Formula (I) are used in combination, the effects of the present invention is more effectively exhibited, which is thus preferable.

Specific examples of the anthraquinone compound according to the invention are shown below. However, the present invention is not limited to these.

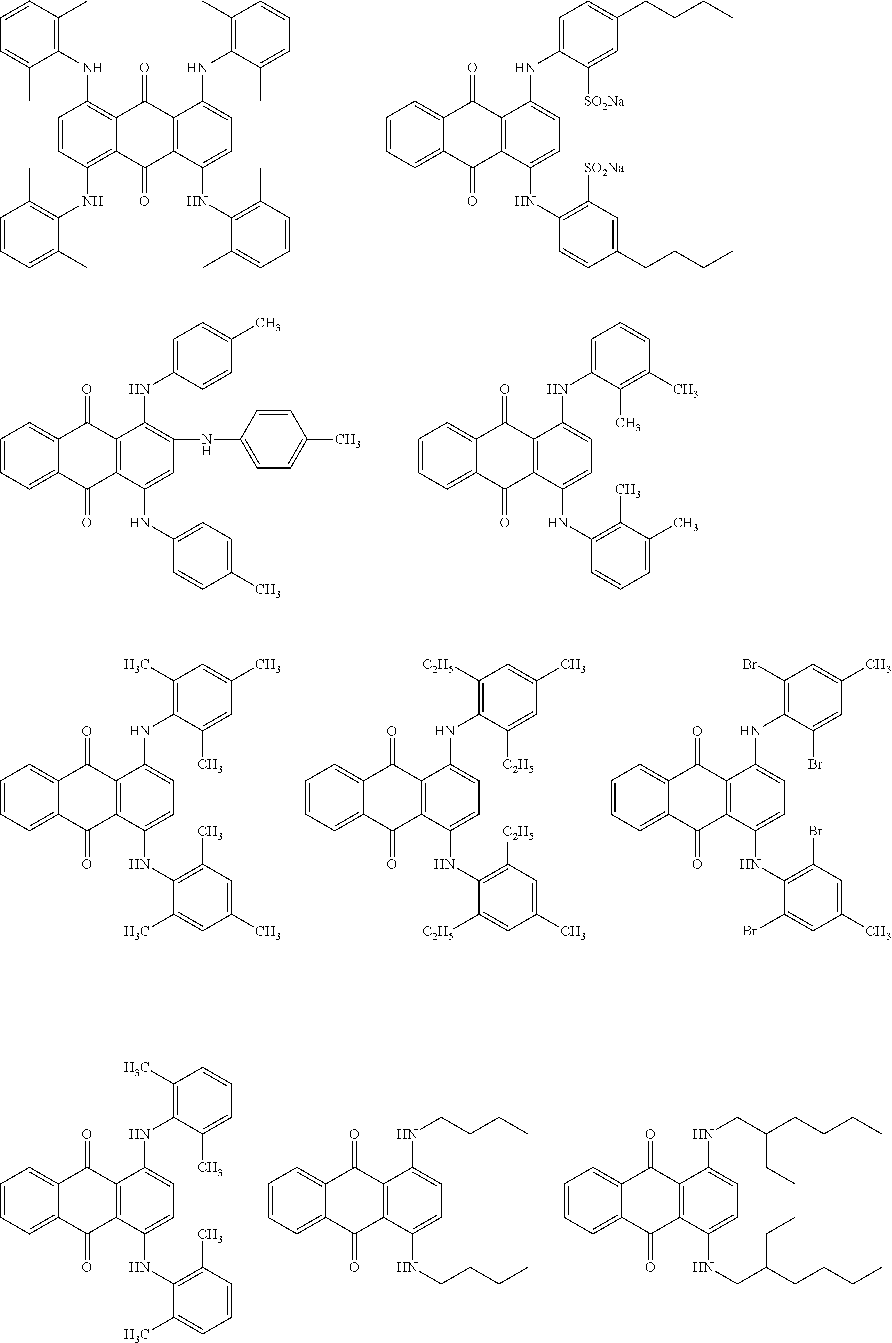

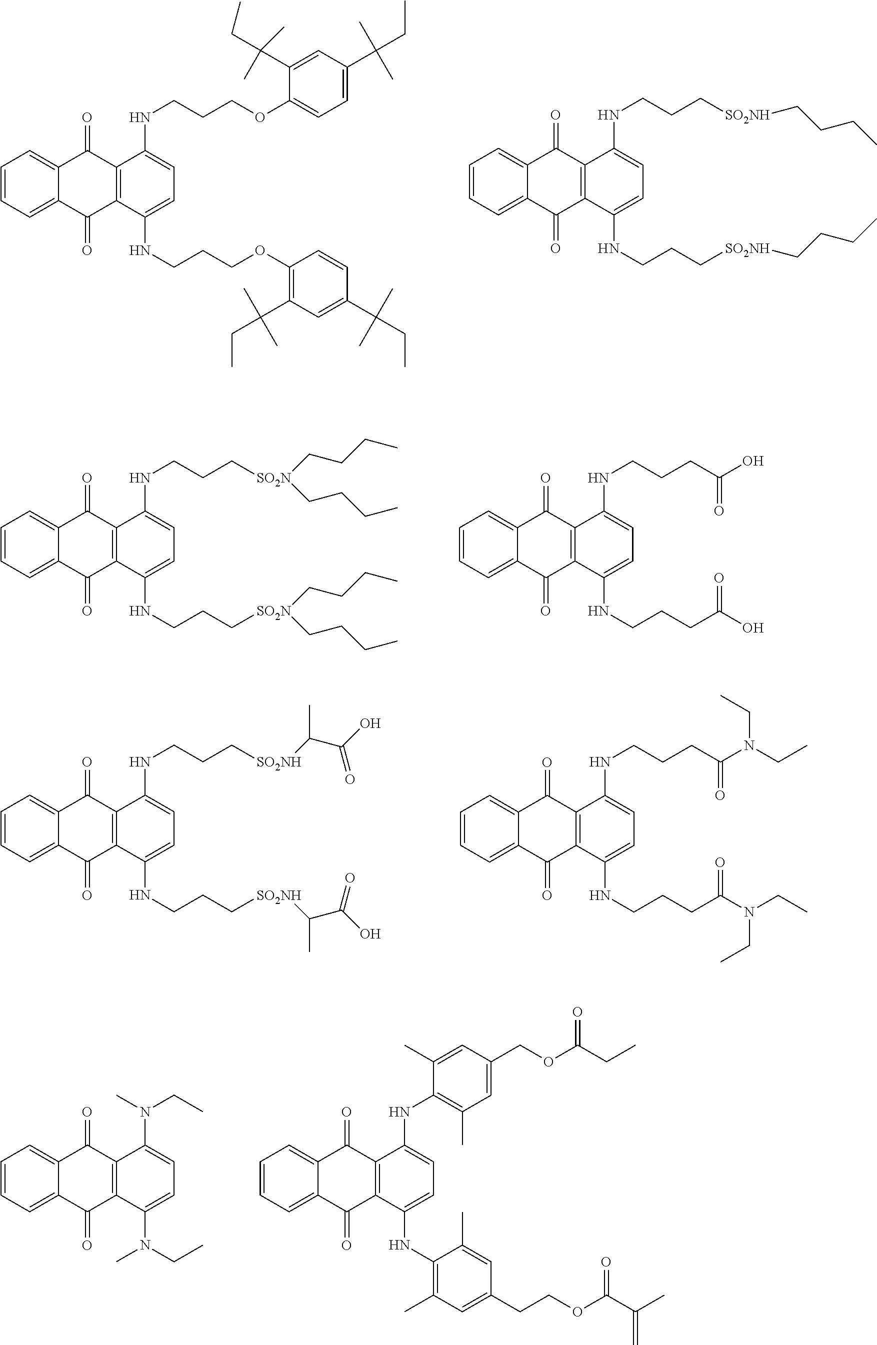

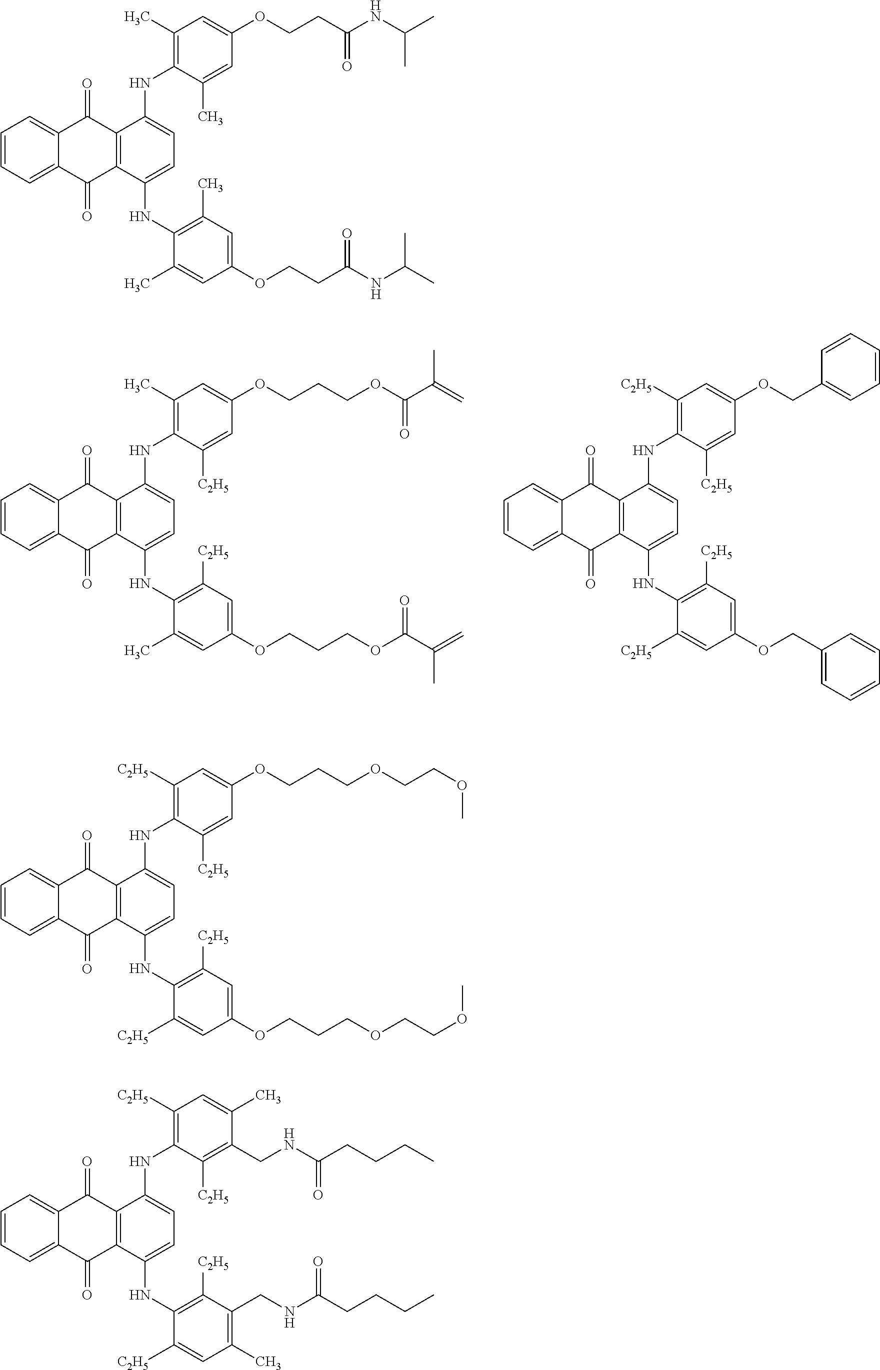 [SMILES: Cc1cc(OCCC(=O)NC(C)C)cc(C)c1Nc1ccc(Nc2c(C)cc(OCCC(=O)NC(C)C)cc2C)c2c1C(=O)c1ccccc1C2=O ; C=C(C)C(=O)OCCCOc1cc(C)c(Nc2ccc(Nc3c(C)cc(OCCCOC(=O)C(=C)C)cc3CC)c3c2C(=O)c2ccccc2C3=O)c(CC)c1 ; CCc1cc(OCc2ccccc2)cc(CC)c1Nc1ccc(Nc2c(CC)cc(OCc3ccccc3)cc2CC)c2c1C(=O)c1ccccc1C2=O ; CCc1cc(OCCCOCCOC)cc(CC)c1Nc1ccc(Nc2c(CC)cc(OCCCOCCOC)cc2CC)c2c1C(=O)c1ccccc1C2=O ; CCCCC(=O)NCc1c(C)cc(CC)c(Nc2ccc(Nc3c(CC)cc(C)c(CNC(=O)CCCC)c3CC)c3c2C(=O)c2ccccc2C3=O)c1CC]

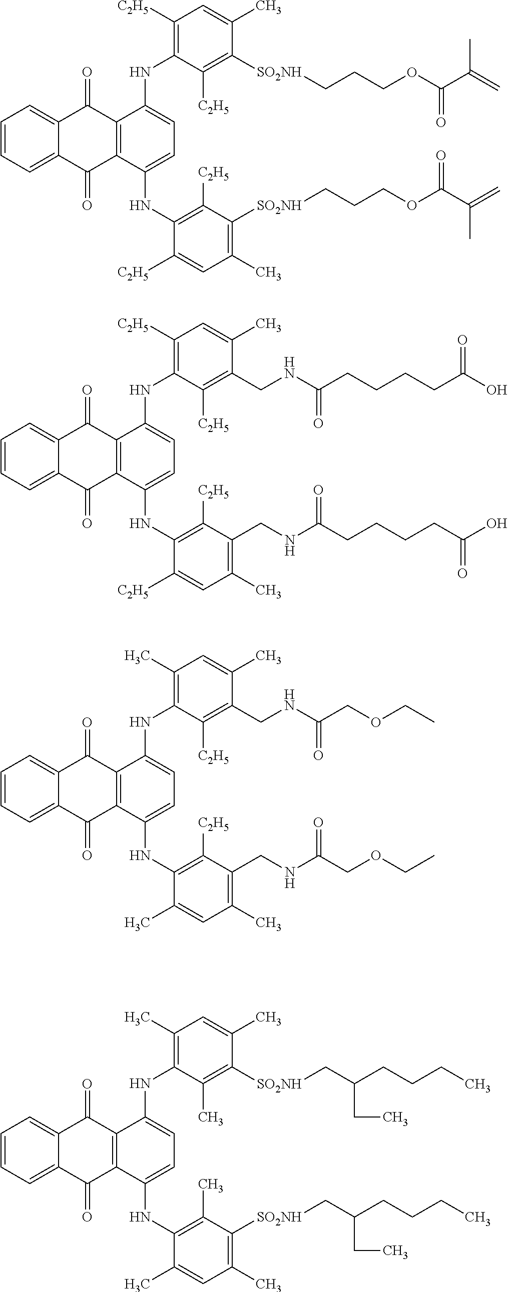

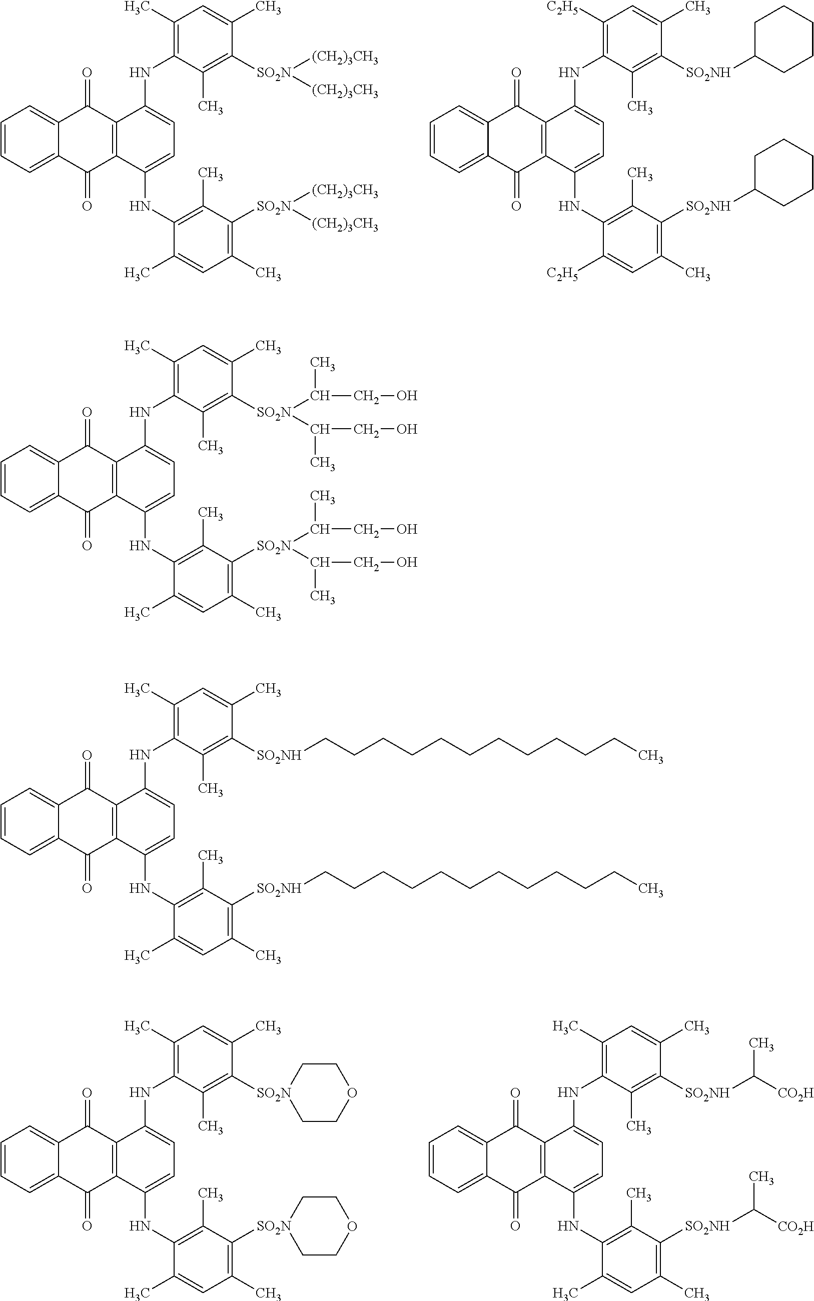

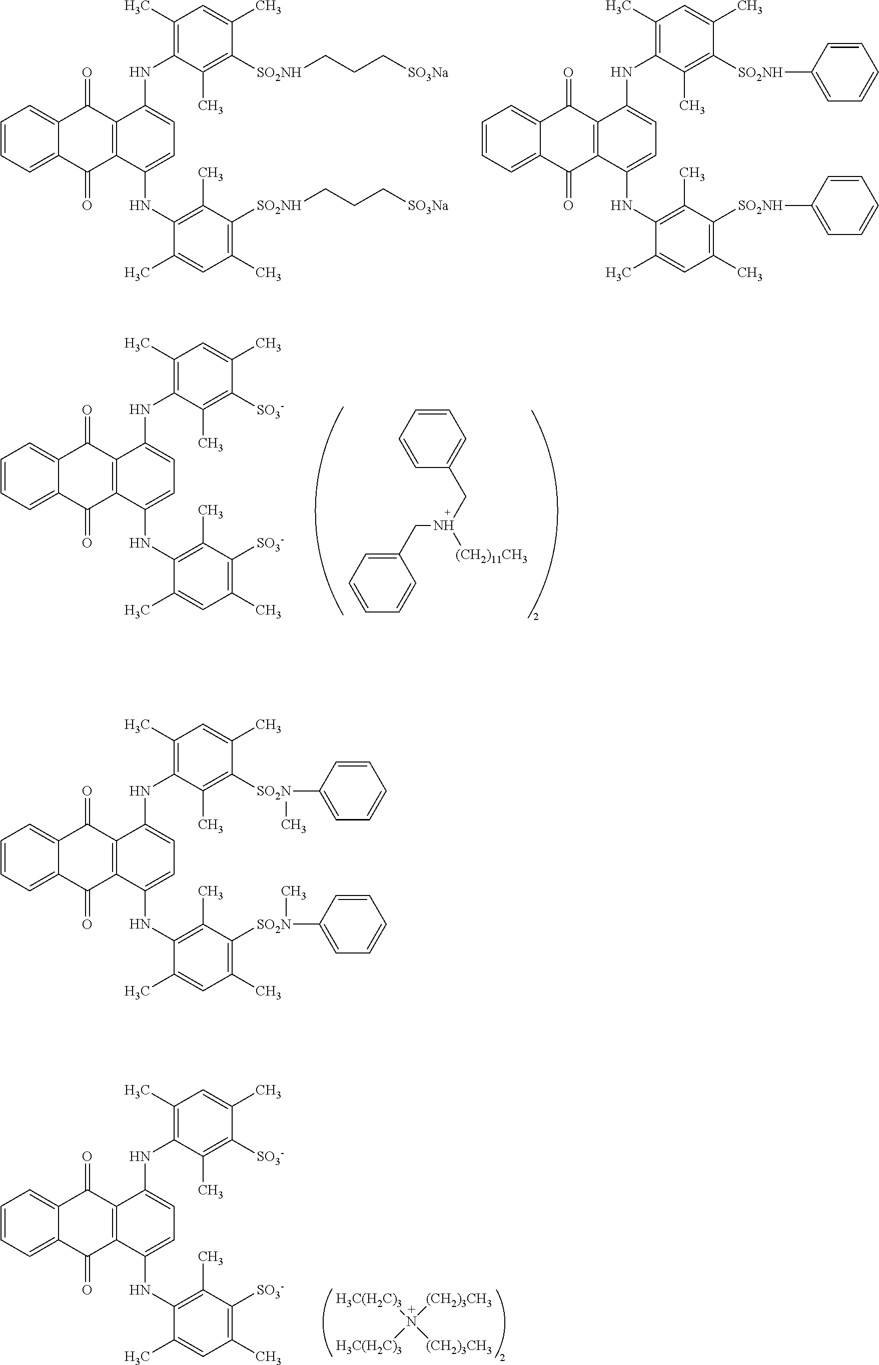

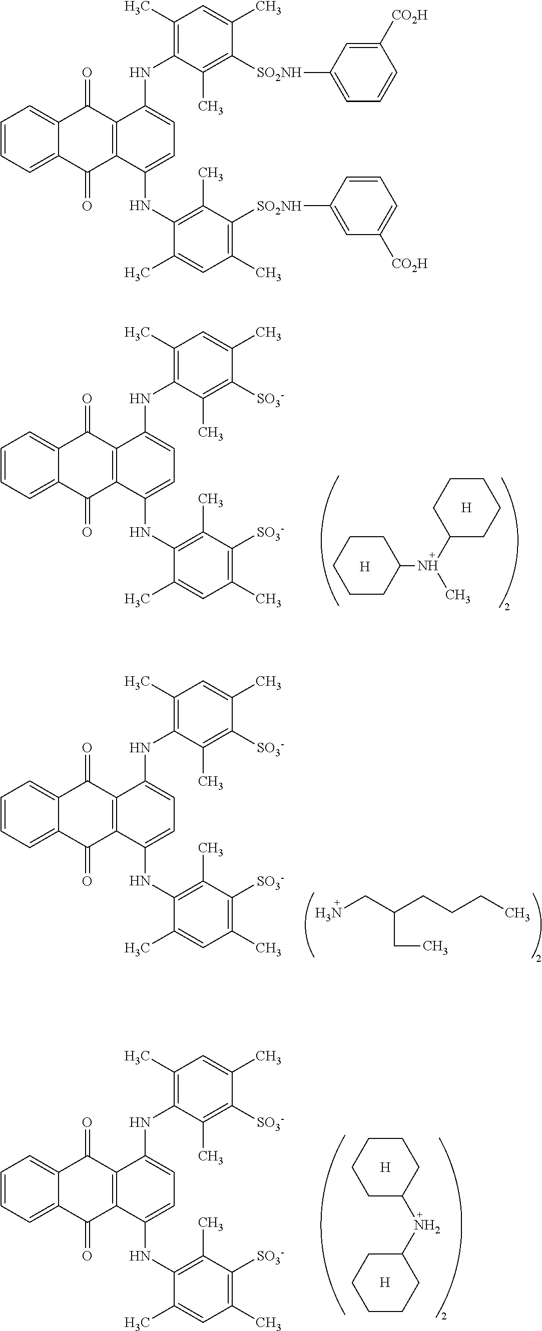

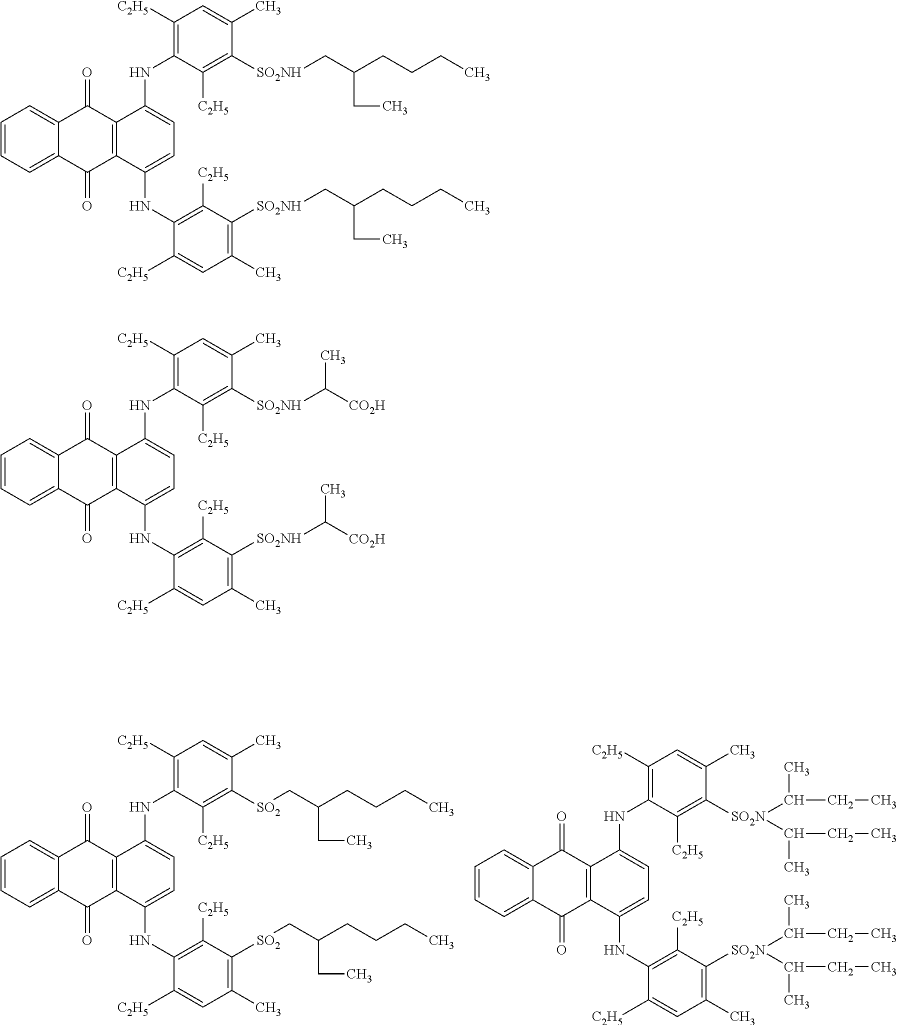

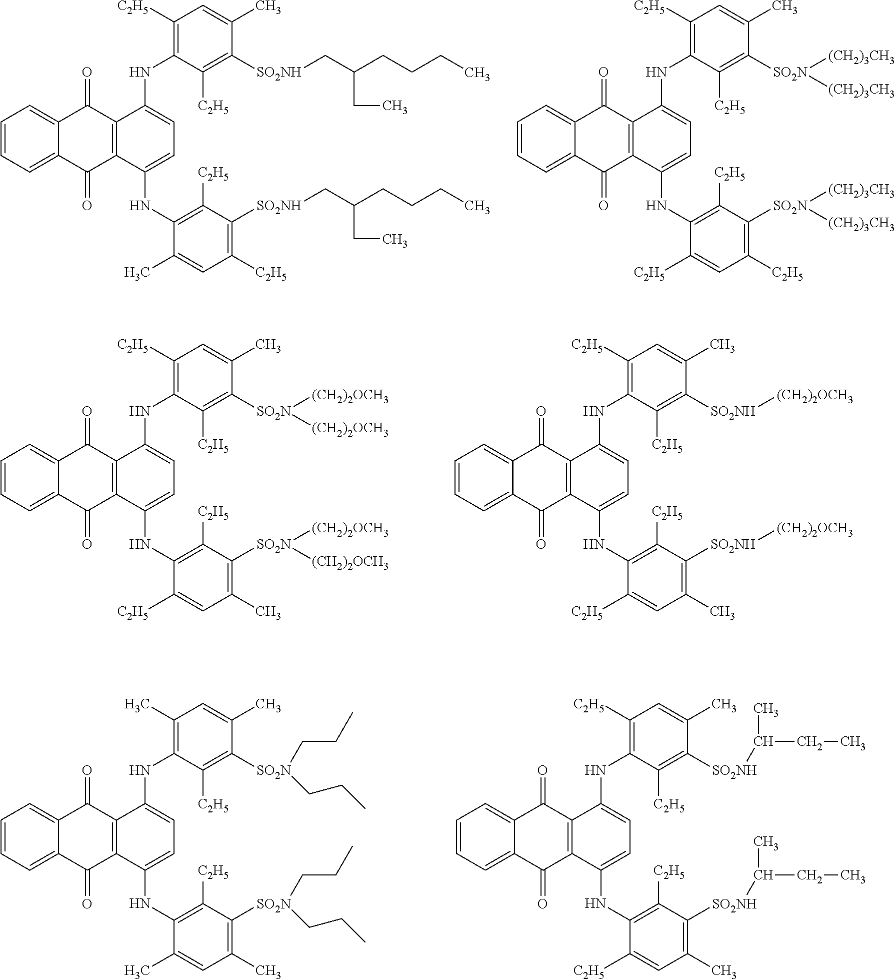

The ratio of the amount of the anthraquinone compound with respect to the total amount of all the dye compounds including the anthraquinone compound and the specific metal complex compound is preferably 50% by mass or less, more preferably in a range of from 2% by mass to 50% by mass, and even more preferably in a range of from 10% by mass to 50% by mass. When the ratio of the amount of the anthraquinone compound is 50% by mass or less, the hue of the colored image is good, and the contrast can be more effectively enhanced while maintaining the fastness.

(Polymerizable Compound)

It is preferable that the colored composition according to the present invention contains at least one polymerizable compound. The polymerizable compound is, for example, a polymerizable compound having at least one ethylenically unsaturated double bond, and can be selected and used from the components that form known compositions, and examples thereof include components described in paragraphs [0010] to [0020] of JP-A No. 2006-23696 and components described in paragraphs [0027] to [0053] of JP-A No. 2006-64921.

Further, urethane addition-polymerizable compounds produced by using an addition reaction of isocyanate and a hydroxyl group are also preferable, and urethane acrylates such as those described in JP-A No. S51-37193, Japanese Patent Application Publication (JP-B) Nos. H2-32293 and H 2-16765 and urethane compounds having an ethylene oxide skeleton described in JP-B Nos. S58-49860, S56-17654, S62-39417, and S62-39418 are also preferable.

Other examples may include polyfunctional acrylates or methacrylates, such as polyester acrylates such as those described in JP-A No. S48-64183, and JP-B Nos. S49-43191 and S52-30490, or epoxy acrylates obtained by reacting an epoxy resin and (meth)acrylic acid. Further, those introduced as a photocurable monomer and oligomer in Journal of the Adhesion Society of Japan, vol. 20, No. 7, pages 300 to 308 (1984) can also be used.

Specifically, preferable examples may include pentaerythritol tri(meth)acrylate, pentaerythritol tetra(meth)acrylate, dipentaerythritol penta(meth)acrylate, dipentaerythritol hexa(meth)acrylate, tri((meth)acryloyloxy ethyl)isocyanurate, EO-modified pentaerythritol tetra(meth)acrylate, EO-modified dipentaerythritol hexa(meth)acrylate, and the like, and further, as commercially available products, NK ESTER, A-TMMT, NK ESTER A-TMM-3, NK OLIGO UA-32P, and NK OLIGO UA-7200 (all manufactured by Shin-Nakamura Chemical Co., Ltd.), ARONIX M-305, ARONIX M-306, ARONIX M-309, ARONIX M-450, ARONIX M-402, and TO-1382 (all manufactured by TOAGOSEI CO., LTD.), V#802 (manufactured by Osaka Organic Chemical Industry Ltd.), and KAYARAD D-330, KAYARAD D-320, KAYARAD D-310, and KAYARAD DPHA (all manufactured by Nippon Kayaku Co., Ltd.).

These polymerizable compounds may be used alone or in a combination of two or more of them.

The content of the polymerizable compound (in the case of using two or more polymerizable compounds, the total content) with respect to the total solid content of the colored composition is preferably from 10% by mass to 80% by mass, more preferably from 15% by mass to 75% by mass, and particularly preferably from 20% by mass to 60% by mass.

(Alkali-Soluble Binder)

The alkali-soluble binder is not particularly limited as long as it has alkali solubility and may be preferably selected from the viewpoints of heat resistance, developability, availability and the like.

It is preferable that the alkali-soluble binder is a linear organic high molecular weight polymer, which is soluble in an organic solvent and can be developed in an aqueous weak alkaline solution. Examples of such a linear organic high molecular weight polymer include polymers that have a carboxylic acid in the side chain, for example, a methacrylic acid copolymer, an acrylic acid copolymer, an itaconic acid copolymer, a crotonic acid copolymer, a maleic acid copolymer, a partially esterified maleic acid copolymer, or the like, such as those described in JP-A No. S59-44615, JP-B Nos. S54-34327, S58-12577, and S54-25957, and JP-A No. S59-53836 and S59-71048; and also, acidic cellulose derivatives that have a carboxylic acid in the side chain are useful.

Besides those described above, as the alkali-soluble binder in the present invention, those obtained by addition of an acid anhydride to a polymer having a hydroxyl group, a polyhydroxystyrene-based resin, a polysiloxane-based resin, poly(2-hydroxyethyl(meth)acrylate), polyvinylpyrrolidone, polyethylene oxide, polyvinyl alcohol, and the like are also useful. Further, the linear organic high molecular weight polymer may be a polymer obtained by copolymerization using a monomer having hydrophilicity. Examples thereof include alkoxyalkyl(meth)acrylate, hydroxyalkyl(meth)acrylate, glycerol (meth)acrylate, (meth)acrylamide, N-methylol acrylamide, secondary or tertiary alkylacrylamide, dialkylaminoalkyl(meth)acrylate, morpholine(meth)acrylate, N-vinylpyrrolidone, N-vinylcaprolactam, vinylimidazole, vinyltriazole, methyl(meth)acrylate, ethyl(meth)acrylate, branched or straight chain propyl(meth)acrylate, branched or straight chain butyl(meth)acrylate, and phenoxyhydroxypropyl(meth)acrylate. In addition, as a monomer having hydrophilicity, monomers including a tetrahydrofurfuryl group, a phosphoric acid group, a phosphoric acid ester group, a quaternary ammonium salt group, an ethyleneoxy chain, a propyleneoxy chain, a sulfonic acid group or a group derived from a salt thereof, a morpholinoethyl group, or the like are also useful.

Moreover, the alkali-soluble binder may have a polymerizable group in the side chain in order to improve the crosslinking efficiency, and for example, polymers having, in the side chain, an allyl group, a (meth)acryloyl group, an allyloxyalkyl group, or the like are also useful. Examples of polymers having the above-described polymerizable group include, as commercially available products, DIANAL NR series (manufactured by Mitsubishi Rayon Co., Ltd.); PHOTOMER 6173 (COOH group-containing polyurethane acrylic oligomer, manufactured by Diamond Shamrock Co., Ltd.); VISCOAT R-264 and KS RESIST 106 (all manufactured by Osaka Organic Chemical Industry Co., Ltd.); CYCLOMER P series and PLACCEL CF200 series (all manufactured by Daicel Chemical Industries, Ltd.); and EBECRYL 3800 (manufactured by DAICEL-CYTEC COMPANY LTD.). Further, for increasing the strength of the cured film, an alcohol-soluble nylon, polyether of 2,2-bis-(4-hydroxyphenyl)-propane and epichlorohydrin, and the like are also useful.

Among these alkali-soluble binders, from the viewpoint of heat resistance, a polyhydroxystyrene-based resin, a polysiloxane-based resin, an acryl-based resin, an acrylamide-based resin, and an acryl/acrylamide copolymer resin are preferable; and from the viewpoint of control of developability, an acryl-based resin, an acrylamide-based resin, and an acryl/acrylamide copolymer resin are preferable.

Preferable examples of the acrylic resin include copolymers formed by using a monomer selected from the group consisting of benzyl(meth)acrylate, (meth)acrylic acid, hydroxyethyl(meth)acrylate, (meth)acrylamide, and the like, and as commercially available products, DIANAL NR series (manufactured by Mitsubishi Rayon Co., Ltd.), KS RESIST-106 (manufactured by Osaka Organic Chemical Industry Co., Ltd.), and CYCLOMER P series and PLACCEL CF200 series (all manufactured by Daicel Chemical Industries, Ltd.).

The alkali-soluble binder is preferably a polymer having a weight average molecular weight (the value in terms of polystyrene, measured by GPC method) of from 1000 to 2×10⁵, more preferably a polymer having a weight average molecular weight of from 2000 to 1×10⁵, and particularly preferably a polymer having a weight average molecular weight of from 5000 to 5×10⁴, from the viewpoints of developability, liquid viscosity, and the like. The alkali-soluble binders may be used alone or in a combination of two or more of them.

(Photopolymerization Initiator)

It is preferable that the colored composition according to the present invention contains at least one photopolymerization initiator. The photopolymerization initiator is not particularly limited as long as it has an ability of initiating the polymerization of the polymerizable compound, and is preferably selected from the viewpoints of properties, initiation efficiency, an absorption wavelength, availability, cost, and the like.

The photopolymerization initiator is a compound that is photo-sensitized by light exposure, and initiates and accelerates polymerization of polymerizable compounds. A compound that responds to actinic ray having a wavelength of 300 nm or greater, and initiates and accelerates polymerization of polymerizable compounds is preferable. Further, a photopolymerization initiator that does not directly respond to actinic ray having a wavelength of 300 nm or greater can also be used preferably, in combination with a sensitizer.

Specific examples include oxime ester compounds, organic halogenated compounds, oxydiazole compounds, carbonyl compounds, ketal compounds, benzoin compounds, acridine compounds, organic peroxide compounds, azo compounds, coumarin compounds, azide compounds, metalocene compounds, hexaarylbiimidazole compounds, organic boric acid compounds, disulfonic acid compounds, onium salt compounds, acyl phosphine (oxide), benzophenone compounds, acetophenone compounds, and derivatives thereof. Among them, from the viewpoint of sensitivity, oxime ester compounds and hexaarylbiimidazole compounds are preferable.

Examples of the oxime ester compound, which can be used, include compounds described in JP-A Nos. 2000-80068 and 2001-233842, JP-A No. 2004-534797, WO 2005/080337, WO 2006/018973, JP-A Nos. 2007-210991, 2007-231000, 2007-269779, and 2009-191061, and WO 2009/131189 pamphlet.

Specific examples include
2-(O-benzoyloxime)-1-[4-(phenylthio)phenyl]-1,2-butanedione,
2-(O-benzoyloxime)-1-[4-(phenylthio)phenyl]-1,2-pentanedione,
2-(O-benzoyloxime)-1-[4-(phenylthio)phenyl]-1,2-hexanedione,
2-(O-benzoyloxime)-1-[4-(phenylthio)phenyl]-1,2-heptanedione,
2-(O-benzoyloxime)-1-[4-(phenylthio)phenyl]-1,2-octanedione,
2-(O-benzoyloxime)-1-[4-(methylphenylthio)phenyl]-1,2-butanedione,
2-(O-benzoyloxime)-1-[4-(ethylphenylthio)phenyl]-1,2-butanedione,
2-(O-benzoyloxime)-1-[4-(butylphenylthio)phenyl]-1,2-butanedione,
1-(O-acetyloxime)-1-[9-ethyl-6-(2-methylbenzoyl)-9H-carbazol-3-yl]ethanone,
1-(O-acetyloxime)-1-[9-methyl-6-(2-methylbenzoyl)-9H-carbazol-3-yl]ethanone,
1-(O-acetyloxime)-1-[9-propyl-6-(2-methylbenzoyl)-9H-carbazol-3-yl]ethanone,
1-(O-acetyloxime)-1-[9-ethyl-6-(2-ethylbenzoyl)-9H-carbazol-3-yl]ethanone,
1-(O-acetyloxime)-1-[9-ethyl-6-(2-buytlbenzoyl)-9H-carbazol-3-yl]ethanone,
2-(benzoyloxyimino)-1-[4-(phenylthio)phenyl]-1-octanone, and
2-(acetoxyimino)-4-(4-chlorophenylthio)-1-[9-ethyl-6-(2-methylbenzoyl)-9H-carbazol-3-yl]-1-butanone. However, the present invention is not limited to these.

Further, in the present invention, a compound represented by the following Formula (III) is also preferable as an oxime compound, from the viewpoints of sensitivity, stability over time, and coloration at the time of post-heating.

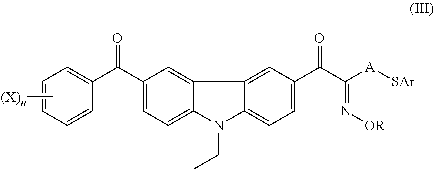

In Formula (III), R and X each independently represent a monovalent substituent, A represents a divalent organic group, and Ar represents an aryl group. n represents an integer of from 0 to 5.

Specific examples of the organic halogenated compound include compounds described in Wakabayashi, et al., “Bull Chem. Soc. Japan”, 42, 2924 (1969), U.S. Pat. No. 3,905,815, JP-B No. S46-4605, JP-A Nos. S48-36281, S55-32070, S60-239736, S61-169835, S61-169837, S62-58241, S62-212401, S63-70243, and S63-298339, M. P. Hutt, “Journal of Heterocyclic Chemistry”, 1 (No. 3), (1970), and the like; and particularly, examples thereof include oxazole compounds and s-triazine compounds substituted with a trihalomethyl group.

Examples of the hexaarylbiimidazole compound include various compounds described in JP-B No. H6-29285, U.S. Pat. Nos. 3,479,185, 4,311,783, and 4,622,286, and the like; and specific examples include
2,2′-bis(o-chlorophenyl)-4,4′,5,5′-tetraphenylbiimidazole,
2,2′-bis(o-bromophenyl)-4,4′,5,5′-tetraphenylbiimidazole,
2,2′-bis(o,p-dichlorophenyl)-4,4′,5,5′-tetraphenylbiimidazole,
2,2′-bis(o-chlorophenyl)-4,4′,5,5′-tetra(m-methoxyphenyl)biimidazole,
2,2′-bis(o,o′-dichlorophenyl)-4,4′,5,5′-tetraphenylbiimidazole,
2,2′-bis(o-nitrophenyl)-4,4′,5,5′-tetraphenylbiimidazole,
2,2′-bis(o-methylphenyl)-4,4′,5,5′-tetraphenylbiimidazole, and
2,2′-bis(o-trifluorophenyl)-4,4′,5,5′-tetraphenylbiimidazole.

One of the photopolymerization initiators may be used, or two or more of them may be used in combination. Further, in the case of using an initiator that does not have absorption in the exposure wavelength, it is necessary to use a sensitizer.

The total content of the photopolymerization initiator is preferably from 0.5% by mass to 30% by mass, more preferably from 2% by mass to 20% by mass, and most preferably from 5% by mass to 18% by mass, with respect to the total solid content of the colored composition. When the content is within this range, the sensitivity at the time of exposure is high, and color characteristics are also good.

(Sensitizer)

A sensitizer may also be added to the colored composition according to the present invention. Examples of a typical sensitizer which may be used in the present invention include those disclosed in Crivello [J. V. Crivello, Adv. in Polymer Sci, 62, 1 (1984)], and specific examples may include pyrene, perylene, acridine, thioxanthone, 2-chlorothioxanthone, benzoflavin, N-vinylcarbazole, 9,10-dibutoxyanthracene, anthraquinone, benzophenone, coumarin, ketocoumarin, phenanthrene, camphorquinone, and phenothiazine derivatives. It is preferable that the sensitizer is added at a proportion of from 50% by mass to 200% by mass with respect to the photopolymerization initiator.

(Chain Transfer Agent)

A chain transfer agent may also be added to the colored composition according to the present invention. Examples of the chain transfer agent which may be used in the present invention include N,N-dialkylamino benzoic acid alkyl esters such as N,N-dimethylamino benzoic acid ethyl ester, mercapto compounds having a heterocycle such as 2-mercaptobenzothiazole, 2-mercaptobenzoxazole, 2-mercaptobenzimidazole, N-phenyl mercaptobenzimidazole, and 1,3,5-tris(3-mercaptobutyloxyethyl)-1,3,5-triazine-2,4,6(1H, 3H, 5H)-trione, and aliphatic polyfunctional mercapto compounds such as pentaerythritol tetrakis(3-mercaptobutyrate) and 1,4-bis(3-mercaptobutyryloxy)butane.

One of the chain transfer agents may be used alone, or two or more of them may be used in combination.

From the viewpoint of reducing the variations in sensitivity, the addition amount of the chain transfer agent is preferably in a range of from 0.01% by mass to 15% by mass, more preferably from 0.1% by mass to 10% by mass, and particularly preferably from 0.5% by mass to 5% by mass, with respect to the total solid content of the colored composition according to the present invention.

(Polymerization Inhibitor)

The colored composition according to the present invention may include a polymerization inhibitor.

The polymerization inhibitor is a substance that carries out hydrogen donation (or hydrogen conferment), energy donation (or energy conferment), electron donation (or electron conferment), or the like, with respect to polymerization initiating species such as radicals or the like generated in the colored composition due to light or heat, and serves to deactivate the polymerization initiating species, thereby playing a role of preventing unintentional initiation of polymerization. Polymerization initiators described in paragraphs 0154 to 0173 of JP-A No. 2007-334322 and the like can be used.

Above all, p-methoxyphenol is preferable as the polymerization inhibitor.

The content of the polymerization inhibitor in the colored composition according to the invention is preferably from 0.0001% by mass to 5% by mass, more preferably from 0.001% by mass to 5% by mass, and particularly preferably from 0.001% to 1% by mass, with respect to the total mass of the polymerizable compound.

(Organic Solvent)

The colored composition according to the present invention may contain an organic solvent.

Basically, the organic solvent is not particularly limited as long as the organic solvent satisfies solubility of respective components which exist in the composition and coating property when a colored composition is prepared, and specifically, the organic solvent is preferably selected in view of the solubility of solid matters, coating property, and safety.

Examples of the organic solvent include esters, for example, ethyl acetate, n-butyl acetate, isobutyl acetate, amyl formate, isoamyl acetate, isobutyl acetate, butyl propionate, isopropyl butyrate, ethyl butyrate, butyl butyrate, methyl lactate, ethyl lactate, alkyl oxyacetate esters (examples: methyl oxyacetate, ethyl oxyacetate, and butyl oxyacetate (specific examples include methyl methoxyacetate, ethyl methoxyacetate, butyl methoxyacetate, methyl ethoxyacetate, ethyl ethoxyacetate, and the like.)), 3-oxypropionic acid alkyl esters, 2-oxypropionic acid alkyl esters, methyl 2-oxy-2-methylpropionate, ethyl 2-oxy-2-methylpropionate, methyl pyruvate, ethyl pyruvate, propyl pyruvate, methyl acetoacetate, ethyl acetoacetate, methyl 2-oxobutanoate, and ethyl 2-oxobutanoate.

Further, examples of ethers include diethylene glycol dimethyl ether, tetrahydrofuran, ethylene glycol monomethyl ether, ethylene glycol monoethyl ether, methylcellosolve acetate, ethylcellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl ether acetate, propylene glycol monopropyl ether acetate, methyl 3-ethoxypropionate, and ethyl 3-ethoxypropionate.

Examples of ketones include methyl ethyl ketone, cyclohexanone, 2-heptanone, and 3-heptanone.

Preferable examples of aromatic hydrocarbons include toluene and xylene.

It is also preferable to mix two or more of these organic solvents, from the viewpoints of solubility of the respective components and solubility of the alkali-soluble binder in a case in which an alkali-soluble binder is included, improvement in coated surface state, and the like. In this case, a mixed solution formed from two or more selected from the group consisting of methyl 3-ethoxypropionate, ethyl 3-ethoxypropionate, ethylcellosolve acetate, ethyl lactate, diethylene glycol dimethyl ether, butyl acetate, methyl 3-methoxypropionate, 2-heptanone, cyclohexanone, ethylcarbitol acetate, butylcarbitol acetate, propylene glycol methyl ether, and propylene glycol methyl ether acetate is particularly preferable.

The content of the organic solvent in the colored composition is preferably adjusted to an amount that gives the total solid concentration in the composition of from 5% by mass to 80% by mass, more preferably an amount that gives the total solid concentration of from 5% by mass to 60% by mass, and particularly preferably an amount that gives the total solid concentration of from 10% by mass to 60% by mass.

(Surfactant)

The colored composition according to the present invention may contain a surfactant.

As the surfactant, any of an anionic surfactant, a cationic surfactant, a nonionic surfactant, or an amphoteric surfactant may be used, but a preferable surfactant is a nonionic surfactant. Specific examples include nonionic surfactants described in paragraph 0058 of JP-A No. 2009-098616, and among them, a fluorocarbon surfactant is preferable.

Examples of surfactants besides above which can be used in the present invention include, as commercially available products, MEGAFACE F142D, MEGAFACE F172, MEGAFACE F173, MEGAFACE F176, MEGAFACE F177, MEGAFACE F183, MEGAFACE F479, MEGAFACE F482, MEGAFACE F554, MEGAFACE F780, MEGAFACE F781, MEGAFACE F781-F, MEGAFACE R30, MEGAFACE R08, MEGAFACE F-472SF, MEGAFACE BL20, MEGAFACE R-61, and MEGAFACE R-90 (all manufactured by DIC Corporation), FLUORAD FC-135, FLUORAD FC-170C, FLUORAD FC-430, FLUORAD FC-431, and NOVEC FC-4430 (all manufactured by Sumitomo 3M Limited), ASAHI GUARD AG7105, 7000, 950, and 7600, SURFLON S-112, SURFLON S-113, SURFLON S-131, SURFLON S-141, SURFLON S-145, SURFLON S-382, SURFLON SC-101, SURFLON SC-102, SURFLON SC-103, SURFLON SC-104, SURFLON SC-105, and SURFLON SC-106 (all manufactured by Asahi Glass Co., Ltd.), FTOP EF351, FTOP 352, FTOP 801, and FTOP 802 (all manufactured by Mitsubishi Materials Electronic Chemicals Co., Ltd.), and FTERGENT 250 (manufactured by Neos Corporation).

Furthermore, preferable examples of the surfactant may include copolymers which include structural unit A and structural unit B, which are represented by the following Formula (I), and have a weight average molecular weight (Mw) of from 1,000 to 10,000, in terms of polystyrene, as measured by gel permeation chromatography using tetrahydrofuran as a solvent.

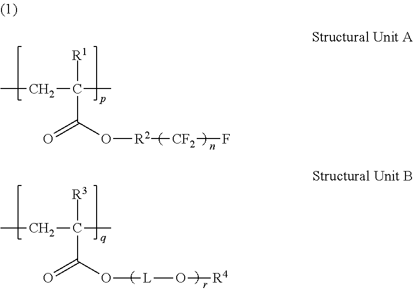

(In Formula (I), R¹ and R³ each independently represent a hydrogen atom or a methyl group; R² represents a straight chain alkylene group having from 1 to 4 carbon atoms; R⁴ represents a hydrogen atom or an alkyl group having from 1 to 4 carbon atoms; L represent an alkylene group having from 3 to 6 carbon atoms; p and q each represent a mass percent representing a polymerization ratio; p represents a numerical value of from 10% by mass to 80% by mass; q represents a numerical value of from 20% by mass to 90% by mass; r represents an integer of from 1 to 18; and n represents an integer of from 1 to 10.)

L preferably represents a branched alkylene group represented by the following Formula (2). R⁵ in Formula (2) represents an alkyl group having from 1 to 4 carbon atoms, and from the viewpoints of mutual solubility and wettability with respect to the surface to be coated, an alkyl group having from 1 to 3 carbon atoms is preferable, and an alkyl group having 2 or 3 carbon atoms is more preferable. It is preferable that the sum of p and q, (p+q), is p+q=100, namely, 100% by mass.

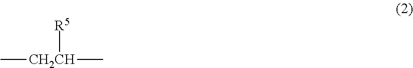

The weight average molecular weight (Mw) of the above copolymer is more preferably from 1,500 to 5,000.

One of these surfactants may be used alone, or two or more of them may be mixed and used. The addition amount of the surfactant in the colored composition according to the invention is preferably from 0.01% by mass to 2.0% by mass of solid matters, and particularly preferably from 0.02% by mass to 1.0% by mass of solid matters. When the addition amount is within this range, coating property and uniformity of the cured film are good.

(Adhesion Improving Agent)

The colored composition according to the present invention may contain an adhesion improving agent.

The adhesion improving agent is a compound that improves adhesion between a cured film and an inorganic material to be formed into a base material, for example, a silicon compound such as glass, silicon, silicon dioxide, or silicon nitride, gold, copper, aluminum, or the like. Examples of the adhesion improving agent include silane coupling agents and thiol compounds. A silane coupling agent as the adhesion improving agent is used for the purpose of modifying the interface and is not particularly limited, and known compounds can be used.

The silane coupling agent is preferably a silane coupling agent described in paragraph 0048 of JP-A No. 2009-98616, and among them, γ-glycidoxypropyltrialkoxysilane and γ-methacryloyloxy propyl trialkoxysilane are more preferable. One of these silane coupling agents may be used alone, or two or more of them may be used in combination.

The content of the adhesion improving agent in the colored composition according to the invention is preferably from 0.1% by mass to 20% by mass, and more preferably from 0.2% by mass to 5% by mass, with respect to the total solid content of the colored composition.

(Crosslinking Agent)

By supplementary using a crosslinking agent in the colored composition according to the invention, the hardness of the colored cured film formed by curing the colored composition can also be further increased.

The crosslinking agent is not particularly limited as long as it can undergo curing of a film through a crosslinking reaction, and examples thereof include (a) an epoxy resin, (b) a melamine compound, a guanamine compound, a glycoluril compound, or a urea compound, which is substituted with at least one substituent selected from the group consisting of a methylol group, an alkoxymethyl group, and an acyloxymethyl group, and (c) a phenol compound, a naphthol compound, or a hydroxyanthracene compound, which is substituted with at least one substituent selected from the group consisting of a methylol group, an alkoxymethyl group, and an acyloxymethyl group. Above all, a polyfunctional epoxy resin is preferable.

For details about the specific examples of the crosslinking agent and the like, description in paragraphs [0134] to [0147] of JP-A No. 2004-295116 can be referred to.

(Development Accelerator)

For promoting the alkali solubility of the unexposed region and realizing further improvement in developability of the colored composition, it is possible to further add a development accelerator. The development accelerator is preferably a low molecular weight organic carboxylic acid compound having a molecular weight of 1000 or less, or a low molecular weight phenol compound having a molecular weight of 1000 or less.

Specific examples include aliphatic monocarboxylic acids such as formic acid, acetic acid, propionic acid, butyric acid, valeric acid, pivalic acid, caproic acid, diethylacetic acid, enanthic acid, and caprylic acid; aliphatic dicarboxylic acids such as oxalic acid, malonic acid, succinic acid, glutaric acid, adipic acid, pimelic acid, suberic acid, azelaic acid, sebacic acid, brassylic acid, methylmalonic acid, ethylmalonic acid, dimethylmalonic acid, methylsuccinic acid, tetramethylsuccinic acid, and citraconic acid; aliphatic tricarboxylic acids such as tricarballylic acid, aconitic acid, and camphoronic acid; aromatic monocarboxylic acids such as benzoic acid, toluic acid, cumic acid, hemellitic acid, and mesitylenic acid; aromatic polycarboxylic acids such as phthalic acid, isophthalic acid, terephthalic acid, trimellitic acid, trimesic acid, mellophanic acid, and pyromellitic acid; phenylacetic acid, hydroatropic acid, hydrocinnamic acid, mandelic acid, phenylsuccinic acid, atropic acid, cinnamic acid, methyl cinnamate, benzyl cinnamate, cinnamylidene acetic acid, coumalic acid, and umbellic acid.

(Other Additives)

As necessary, the colored composition according to the present invention may contain various other additives, for example, fillers, polymer compounds other than the polymer compounds described above, ultraviolet absorbents, antioxidants, aggregation inhibitors, or the like. Examples of these additives may include those described in paragraphs [0155] to [0156] of JP-A No. 2004-295116.

The colored composition according to the present invention may contain a light stabilizer described in paragraph [0078] of JP-A No. 2004-295116 or a thermal polymerization inhibitor described in paragraph [0081] of JP-A No. 2004-295116.

<Preparation of Colored Composition>

There is no particular limitation as to the preparation embodiment of the colored composition according to the invention; however, for example, the colored composition may be prepared by mixing the specific metal complex compound, the polymerizable compound, the photopolymerization initiator, and various additives which may be optionally used in combination.

Further, in the preparation of the colored composition according to the invention, after mixing the respective components, the resulting mixture is preferably subjected to filtration, for the purpose of removing foreign matters, reducing defects, or the like. As the filter, the one that is conventionally used for filtration or the like can be used without any particular limitation. Specific examples include filters formed from a fluororesin such as PTFE (polytetrafluoroethylene), a polyamide-based resin such as nylon-6 or nylon-6,6, a polyolefin resin (including high-density or super-high-molecular-weight polyolefin) such as polyethylene, polypropylene (PP), or the like. Among these materials for filters, a polyamide-based resin such as nylon-6 or nylon-6,6 and polypropylene (including high-density polypropylene) are preferable.

A pore size of the filter is suitably from about 0.01 μm to about 7.0 μm, preferably from about 0.01 μm to about 2.5 μm, and more preferably from about 0.01 μm to about 2.0 μm. When the pore size is within this range, fine foreign matters, which inhibit preparation of a homogeneous colored composition in the post process, are certainly removed, and it becomes possible to form a homogeneous and smooth colored composition.

In the case of using a filter, different filters may be used in combination. In this process, filtering using the first filter may be carried out once, or may be carried out two or more times. Further, filters having different pore sizes, the pore sizes each being within the above range, may be used in combination to prepare a first filter including plural filters, with which first filtering may be conducted. For the “pore size” used herein, nominal values of filter manufacturers may be referred to. As a commercially available filter, it is possible to select from various filters provided by, for example, Nihon Pall Ltd., ADVANTEC MFS INC., Nihon Entegris K.K. (former, Nihon Mykrolis K.K.), Kitz Microfilter Corporation, and the like.

As the second filter, those formed from the same material as the material used in the above-described first filter can be used.

Further, for example, filtering with the first filter may be conducted only for a pigment dispersion, and a colored composition may be prepared by mixing the pigment dispersion with other components, followed by conducting second filtering for the colored composition.

The colored composition according to the invention can be applied to various uses, for example, in color filters for solid-state imaging devices, color filters for liquid crystal display devices, printing inks, inkjet inks, or the like.

In particular, since the colored cured film obtained by curing the colored composition according to the invention has high color purity, can be formed into a thin layer having a high absorption coefficient, and has excellent fastness (especially, heat resistance and light resistance), as well as exhibits an excellent voltage holding ratio when voltage is applied to a liquid crystal display device to which the colored cured film is applied, the colored cured film is useful for the formation of colored pixels in a color filter for a liquid crystal display device and in a color filter for a solid-state imaging device.

<<Color Filter and Production Method Thereof>>

The color filter according to the present invention is configured such that a colored region (colored cured film) formed from the colored composition according to the present invention is provided on an arbitrary support.

The colored region on the support is configured to include colored films of, for example, red (R), green (G), blue (B), and the like, which form respective pixels of the color filter.

The color filter according to the invention may be formed by any method, as long as the method makes it possible to form a cured patterned colored region (a colored cured film) containing the specific metal complex compound. The color filter according to the present invention is preferably produced by the method for producing a color filter according to the present invention.

The method for producing a color filter according to the present invention includes a process (hereinafter, may also referred to as “process (A)”) of applying the colored composition according to the present invention onto a support to form a colored composition layer, and a process (hereinafter, may also referred to as “process (B)”) of pattern-wise exposing (preferably, through a mask) and developing the formed colored composition layer to form a patterned colored region (a colored cured film).

Through performing these processes for plural times, a colored pattern formed from pixels of respective colors (three colors or four colors) is formed, and a color filter can be obtained.

Further, as to the method for producing a color filter according to the present invention, particularly, in a preferable embodiment, a process (hereinafter, may also referred to as “process (C)”) of irradiating the patterned colored region formed in the process (B) with ultraviolet ray, and/or a process (hereinafter, may also referred to as “process (D)”) of performing a heating treatment with respect to the colored region that has been irradiated with ultraviolet ray are (is) further provided.

According to such a method, a color filter, which may be used for a liquid crystal display device or a solid-state imaging device, can be produced with little difficulty in the process, high quality, and low cost.

Hereinafter, the method for producing a color filter according to the present invention is more specifically described.

—Process (A)—

In the method for producing a color filter according to the present invention, first, the above-described colored composition according to the present invention is applied onto a substrate, directly or through other layer, by a desired method, thereby forming a coated film (a colored composition layer) formed from the colored composition, and then, as necessary, preliminary curing (prebaking) is carried out, and the colored composition layer is subjected to drying.

Examples of the support include non-alkali glass, soda glass, PYREX (registered trademark) glass, and quartz glass, which are used for liquid crystal display devices or the like, and substances obtained by adhering a transparent conductive film to these supports, as well as photoelectric conversion element substrates used for solid-state imaging devices or the like, for example, a silicone substrate and a plastic substrate. Further, on these substrates, a black matrix that isolates respective pixels may be formed, or a transparent resin layer may be provided in order to accelerate adhesion or the like. Moreover, the support may have thereon, as necessary, an undercoat layer, for the purpose of improving adhesion to a layer to be positioned above, preventing diffusion of substances, or flattening the surface.

Further, it is preferable that a plastic substrate has a gas barrier layer and/or a solvent resistant layer on the surface.

In addition, a color filter can be produced by using, as a support, a substrate for driving on which a thin film transistor (TFT) for a thin film transistor (TFT) type color liquid crystal display device is arranged (hereinafter, referred to as “substrate for driving TFT type liquid crystal”); and forming, also on this substrate for driving, a colored pattern formed by using the colored composition according to the present invention.

Examples of a substrate in the substrate for driving TFT type liquid crystal may include glass, silicone, polycarbonate, polyester, aromatic polyamide, polyamideimide, and polyimide. Optionally, these substrates may be appropriately subjected to pretreatment, such as a chemical treatment using a silane coupling agent or the like, a plasma treatment, ion plating, sputtering, a gas phase reaction method, vacuum deposition, or the like. For example, it is possible to use a substrate which is obtained by forming a passivation film such as silicon nitride film or the like on a surface of a substrate for driving TFT type liquid crystal.

Examples of a method of applying the colored composition according to the invention onto a support include coating methods such as rotary coating, slit coating, cast coating, roll coating, bar coating, and ink jetting.

In process (A), the method of applying the colored composition according to the present invention onto a support is not particularly limited; however, a method of using a slit nozzle (hereinafter, referred to as a “slit nozzle coating method”), such as a slit-and-spin method or a spinless coating method, is preferable.

In the slit nozzle coating method, although the conditions of the slit-and-spin coating method and spinless coating method vary depending on the size of the coated substrate, for example, in the case of coating a glass substrate of the fifth generation (1100 mm×1250 mm) by a spinless coating method, the discharge amount of the colored composition from a slit nozzle is generally from 500 microliter/sec to 2000 microliter/sec, and preferably from 800 microliter/sec to 1500 microliter/sec, and the coating speed is generally from 50 mm/sec to 300 mm/sec, and preferably from 100 mm/sec to 200 mm/sec.

Further, the solid content of the colored composition used in process (A) is generally from 10% by mass to 20% by mass, and preferably from 13% by mass to 18% by mass.

In process (A), generally, a prebaking treatment is performed after the formation of the colored composition layer. Depending on needs, a vacuum treatment may be performed before prebaking The condition of vacuum drying is such that the degree of vacuum is generally from 0.1 torr to 1.0 torr, and preferably from about 0.2 torr to about 0.5 torr.

Regarding the conditions of prebaking, the conditions of heating at 70° C. to 130° C., for about 0.5 minutes to about 15 minutes using a hot plate or an oven are described.

The thickness of the colored composition layer formed from the colored composition is selected as appropriately according to the intended use. In a color filter for a liquid crystal display device, the thickness of the colored composition layer is preferably in a range of from 0.2 μm to 5.0 μm, more preferably in a range of from 1.0 μm to 4.0 μm, and most preferably in a range of from 1.5 μm to 3.5 μm. Further, in a color filter for a solid-state imaging device, the thickness of the colored composition layer is preferably in a range of from 0.2 μm to 5.0 μm, more preferably in a range of from 0.3 μm to 2.5 μm, and most preferably in a range of from 0.3 μm to 1.5 μm.

The thickness of the colored composition layer is a film thickness after prebaking

—Process (B)—

Subsequently, in the method for producing a color filter according to the invention, the coated film (colored composition layer) which is formed on a support as described above and is formed from the colored composition is exposed to light, for example, through a photo-mask. Preferable examples of light or radiation capable of being applied to exposure include g-line, h-line, i-line, j-line, KrF light, and ArF light; and particularly, i-line is preferable. In a case in which i-line is used as the irradiation light, it is preferable to irradiate at an exposure amount of from 100 mJ/cm² to 10000 mJ/cm².

Other examples of the exposure ray, which can be used, include ultrahigh pressure, high pressure, medium pressure, and low pressure mercury lamps, chemical lamps, carbon arc lamps, xenon lamps, metal halide lamps, any laser light sources of visible or ultraviolet, fluorescent lamps, tungsten lamps, and sunlight.

—Exposure Process Using Laser Light Source—

In the exposure system using a laser light source, it is preferable to use an ultraviolet laser as the light source.

The irradiation light is preferably an ultraviolet laser having a wavelength in a range of from 300 nm to 380 nm, and more preferably an ultraviolet laser having a wavelength in a range of from 300 nm to 360 nm, from the viewpoint that the wavelength corresponds with the photosensitive wavelength of the resist. Specifically, the third high harmonic wave (355 nm) of Nd:YAG laser, which is a relatively low-cost solid laser having particularly large output, or an excimer laser of XeCl (308 nm) or XeF (353 nm) can be preferably used.

The exposure amount for the object to be exposed (pattern) is preferably in a range of from 1 mJ/cm² to 100 mJ/cm², and more preferably in a range of from 1 mJ/cm² to 50 mJ/cm². The exposure amount within this range is preferable from the viewpoint of productivity of pattern formation.

The exposure equipment is not particularly limited, and examples of commercially available products, which can be used, include CALLISTO (manufactured by V Technology Co., Ltd.), EGIS (manufactured by V Technology Co., Ltd.), and DF2200G (manufactured by Dainippon Screen Mfg. Co., Ltd.). Further, other equipments besides the above equipments can also be used preferably.

In the case of producing a color filter for a liquid crystal display device, exposure mainly using h-line or i-line by using a proximity exposure apparatus or a mirror projection exposure apparatus is preferably employed. Further, in the case of producing a color filter for a solid-state imaging device, it is preferable to mainly use i-line by using a stepper-type exposure apparatus. In addition, in the case of producing a color filter using a substrate for driving a TFT type liquid crystal, as the photo-mask to be used, a photo-mask which is provided with a pattern for forming a through-hole or a U-shaped depression, in addition to a pattern for forming pixels (a colored pattern), is used.

The colored composition layer, that has been exposed as described above, may be subjected to heating.

Further, the exposure may be carried out in a chamber in a nitrogen flow, in order to suppress oxidation fading of the coloring material in the color composition layer.

Subsequently, the colored composition layer after exposure is subjected to development using a developing solution. As a result of this operation, a negative type or positive type colored pattern (resist pattern) can be formed. In the development process, the uncured portion of the coated film after exposure is dissolved in the developing solution, so that only the cured portion remains on the substrate.

Any developing solution can be used as long as the developing solution dissolves the uncured portion of the coated film (colored composition layer) of the colored composition and does not dissolve the cured portion. For example, a combination of various organic solvents or an aqueous alkaline solution can be used.

Examples of the organic solvent which can be used for development include the above-described solvents which can be used for the preparation of the colored composition according to the present invention.

Examples of the aqueous alkaline solution include aqueous alkaline solutions which are obtained by dissolving an alkaline compound such as sodium hydroxide, potassium hydroxide, sodium carbonate, sodium hydrogencarbonate, sodium silicate, sodium metasilicate, aqueous ammonium, ethylamine, diethylamine, dimethylethanolamine, tetramethylammonium hydroxide, tetraethylammonium hydroxide, choline, pyrrole, piperidine, and 1,8-diazabicyclo-[5,4,0]-7-undecene, such that the concentration is from 0.001% by mass to 10% by mass, and preferably from 0.01% by mass to 1% by mass. In a case in which the developing solution is an aqueous alkaline solution, the alkali concentration is preferably adjusted to give a pH of from 11 to 13, and more preferably a pH of from 11.5 to 12.5.

To the aqueous alkaline solution, for example, an appropriate amount of a water-soluble organic solvent such as methanol or ethanol, a surfactant, or the like may be further added.

The development temperature is generally from 20° C. to 30° C., and the development time is from 20 seconds to 90 seconds.

The development system may be any of a dipping system, a shower system, a spray system, or the like, which may be used in combination with a swing system, a spinning system, an ultrasonic system, or the like. Before contact with the developing solution, the surface to be developed may be moistened with water or the like in advance, thereby enabling prevention of development unevenness. Further, development can be carried out by inclining the substrate.

Moreover, in the case of producing a color filter for a solid-state imaging device, paddle development may also be used.

After the development treatment, a rinse treatment for washing and removing excess developing solution is carried out, and after performing drying, a heating treatment (post-baking) is carried out in order to complete curing.

Generally, the rinse treatment is carried out using pure water; however, for saving liquids, a method of using pure water at the final washing and using used pure water at the early stage of washing, or a method of washing while inclining the substrate or using ultrasonic wave irradiation in combination may be used.

After the rinse treatment, dewatering and drying are performed, and thereafter, generally, a heating treatment at about 200° C. to about 250° C. is performed. This heating treatment (post-baking) can be carried out by a continuous system or a batch system, using a heating means such as a hot plate, a convection oven (a hot air circulation type dryer), or a high frequency heater, such that the coated film that has been developed is heat-treated in the above conditions.

By repeatedly performing the respective processes described above for every color according to the number of desired hues in order, a cured film (colored pattern) colored in plural colors is formed, and a color filter formed from these cured films may be produced.

—Process (C)—

Particularly, in the method for producing a color filter according to the invention, the patterned colored region (colored pixels) that is formed by using the colored composition may be subjected to post-exposure with ultraviolet irradiation.

—Process (D)—

It is preferable that the patterned colored region which has been subjected to post-exposure with ultraviolet irradiation as described above is further subjected to heating treatment. By subjecting the formed colored region to heating treatment (so-called post-bake treatment), the colored region can be further cured. This heating treatment can be carried out by using, for example, a hot plate, any heater, an oven, or the like.

The temperature of the heating treatment is preferably from 100° C. to 300° C., and more preferably from 150° C. to 250° C. The heating time is preferably from about 10 minutes to about 120 minutes.

The patterned colored region thus obtained forms a part of the pixels of the color filter. In the production of a color filter including pixels of plural hues, the above process (A) and process (B) and, as necessary, the process (C) or the process (D) may be repeated according to the number of desired colors.

The process (C) and/or the process (D) may be carried out every after the completion of the formation, exposure, and development of a colored composition layer of a single color (for every color), or the process (C) and/or the process (D) may be carried out once after completion of the formation, exposure, and development of all the colored composition layers of the desired number of colors.

The color filter (the color filter according to the present invention) obtained by the method for forming a color filter according to the present invention is formed by using the colored composition according to the present invention, and thus, when displaying an image, a vivid color, high contrast, excellent fastness (especially, heat resistance and light resistance) and excellent voltage holding ratio are realized.

It is possible to use the color filter according to the present invention in a liquid crystal display device or a solid-state imaging device, and particularly, the color filter according to the present invention is suitable for a liquid crystal display device. When the color filter is used in a liquid crystal display device, that is, the specific metal complex compound according to the present invention is used, while achieving a good hue, display of an image with excellent spectral characteristics and excellent contrast becomes possible, and further, excellent voltage holding ratio can be realized.

As the use of the colored composition of the present invention, the use for the formation of a colored pattern of a color filter is mainly described in the above description; however, the colored composition according to the invention may also be applied to the formation of a black matrix which isolates the colored pattern (pixel) that forms a part of a color filter.

A black matrix on a substrate can be formed by using a colored composition containing a processed pigment of a black pigment such as carbon black or titanium black, performing respective processes of coating, exposure, and development, and then, as needs arise, performing post-baking

<<Liquid Crystal Display Device>>

The liquid crystal display device according to the present invention is equipped with the above-described color filter according to the present invention.

In the case of using the color filter according to the present invention in a liquid crystal display device, while containing a metal complex dye which has excellent spectral characteristics and excellent heat resistance as the coloring agent, lowering of voltage holding ratio in the application of voltage does not occur, and the number of orientation defects of liquid crystal molecules caused by lowering of specific resistance is small, the color tinge of the display image is good, and the display characteristics are excellent.

Therefore, the liquid crystal display device equipped with the color filter according to the present invention can display high quality images with good color tinge of the display image and excellent display characteristics.

The definition of the display device and details of the respective display devices are described in, for example, “Electronic Display Device (written by Akio Sasaki, Kogyo Chosakai Publishing Co., Ltd., 1990)”, “Display Device (written by Sumiaki Ibuki, Sangyo-Tosho Publishing Co., Ltd., 1989)”, and the like. Further, liquid crystal display devices are described in, for example, “Next Generation Liquid Crystal Display Techniques (edited by Tatsuo Uchida, Kogyo Chosakai Publishing Co., Ltd., 1994)”. The liquid crystal display device to which the present invention can be applied is not particularly limited and, for example, the invention is applicable to liquid crystal display devices of various systems described in the above-described “Next Generation Liquid Crystal Display Techniques”.

The color filter according to the present invention may be used for color TFT type liquid crystal display devices. The color TFT type liquid crystal display devices are described in, for example, “Color TFT Liquid Crystal Display (published by Kyoritsu Shuppan Co., Ltd., 1996)”. Further, the present invention is applicable to liquid crystal display devices having enlarged view angle, such as the transverse electric field system such as IPS, or the pixel division system such as MVA, and also to STN, TN, VA, OCS, FFS, R-OCB, and the like.

In addition, it is possible to apply the color filter according to the present invention to the COA (Color-Filter On Array) system which realizes brightness and high definition. There are cases in which COA liquid crystal display devices require the color filter layer to meet ordinary requirements as described above and requirements for interlayer insulating films, specifically, a low dielectric constant and resistance to removing liquid. In the color filter according to the present invention, since the specific metal complex which has excellent hue is used, the color filter exhibits good color purity, and good high transmittance, and the colored pattern (pixel) has excellent color tinge, and thus COA liquid crystal display devices having high resolution and excellent long-term durability can be provided. In order to satisfy a requirement of a low dielectric constant, a resin coated film may be provided on the color filter layer.

These image display systems are described in, for example, “EL, PDP, and LCD Displays—Current Trend of Techniques and Markets—(Investigative Research Department, Toray Research Center, Inc., published in 2001)”, page 43, and the like.

The liquid crystal display device equipped with the color filter according to the present invention includes, in addition to the color filter according to the present invention, various members such as an electrode substrate, a polarizing film, a phase difference film, a backlight, a spacer, a view angle compensation film, and the like. The color filter according to the present invention is applicable to liquid crystal display devices including these known members. These members are described in, for example, “'94 Markets of Peripheral Materials and Chemicals for Liquid Crystal Displays (Kentaro Shima, published by CMC Publishing Co., Ltd. in 1994)” and “2003 Liquid Crystal Related Market and Future Outlook (Volume 2) (Ryokichi Omote, published by Fuji Chimera Research Institute Inc. in 2003)”.

Backlights are described in SID Meeting Digest 1380 (2005) (A. Konno et al.), Monthly Display, December issue, 2005, pages 18 to 24 (Yasuhiro Shima) and pages 25 to 30 (Takaaki Yagi), and the like.

In the case of using the color filter according to the present invention in a liquid crystal display device, when a conventionally known three-wavelength cold-cathode tube is used in combination, a high contrast can be achieved, and in addition, when LED light sources (RGB-LED) of red, green, and blue are used as backlights, a liquid crystal display device which achieves high brightness, high color purity, and good color reproducibility can be provided.

<<Solid-State Imaging Device>>

The solid-state imaging device according to the present invention is equipped with the above-described color filter according to the present invention. The solid-state imaging device according to the present invention is not particularly limited as to its structure, as long as the solid-state imaging device includes the color filter according to the present invention and functions as a solid-state imaging device; however, examples of the structure include the followings.

Namely, the structure includes, on a support, plural photodiodes which form a part of the light-receiving area of the solid-state imaging device (a CCD image sensor, a CMOS image sensor, or the like) and a transfer electrode formed from polysilicon or the like; on the photodiodes and the transfer electrode, a light shielding film which has an opening only at the light-receiving portion of the photodiode and is formed from tungsten or the like; on the light shielding film, a device protective film which is formed so as to cover the entire surface of the light shielding film and the light-receiving portion of the photodiode and is formed from silicon nitride or the like; and, on the device protective film, the color filter according to the present invention.

Further, a light gathering means (for example, a microlens, or the like. Hereinafter, the same applies.) may be provided on the device protective layer and under the color filter (at a nearer side to the support), or a light gathering means may be provided on the color filter.

### EXAMPLES

Hereinafter, the present invention is more specifically described with reference to Examples, but it should be construed that the invention is in no way limited to these Examples as long as not departing from the scope of the present invention. Note that, “part” and “%” are based on mass, unless otherwise noted.

### Synthesis Example 1 Synthesis of Exemplary Compounds A-1, A-4, and A-11

### Synthesis of Dipyrromethene Metal Complex Compound

The above-described exemplary compounds A-1, A-4, and A-11, which are dipyrromethene metal complex compounds in the present invention, were synthesized according to the following Reaction Scheme A.

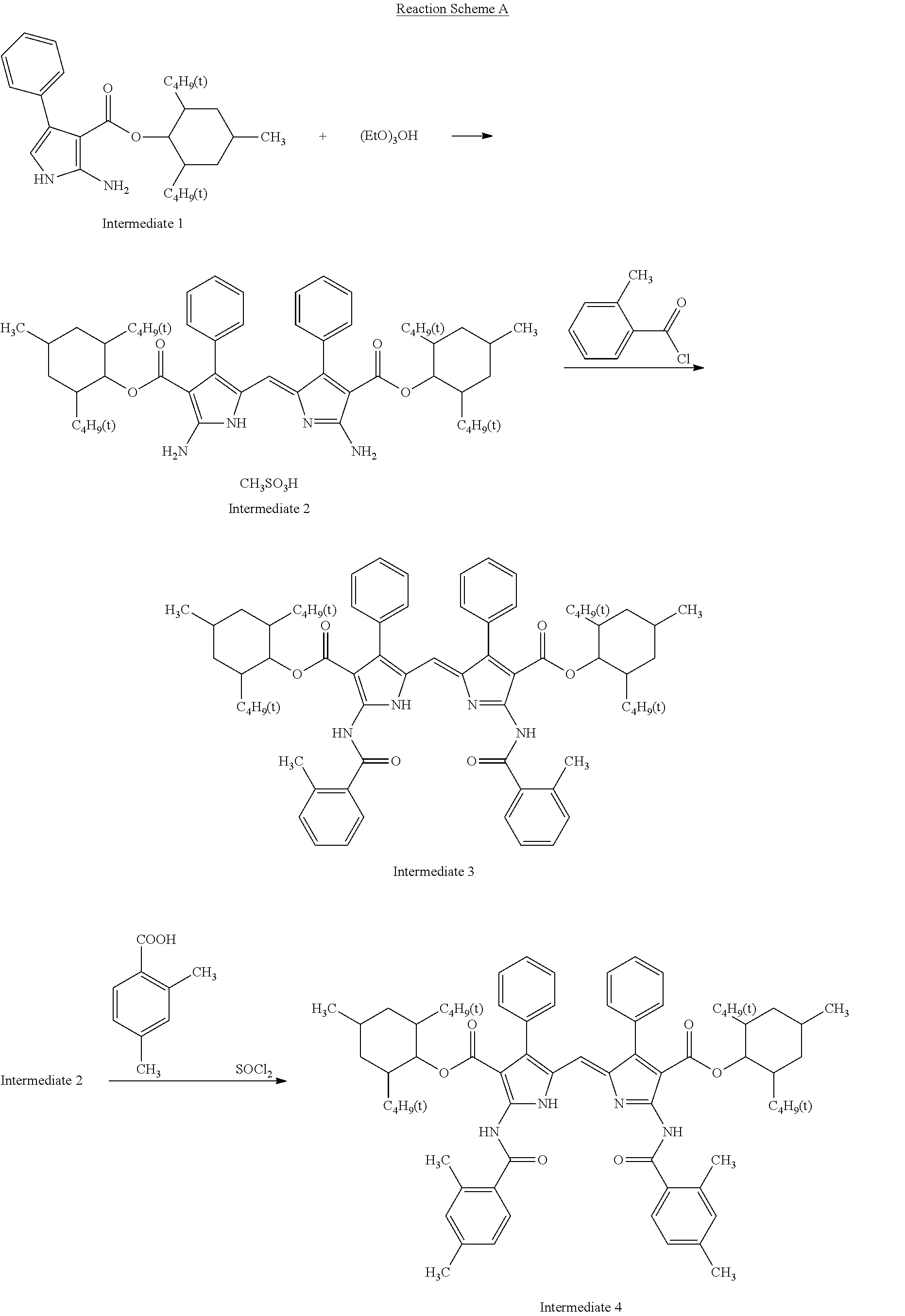

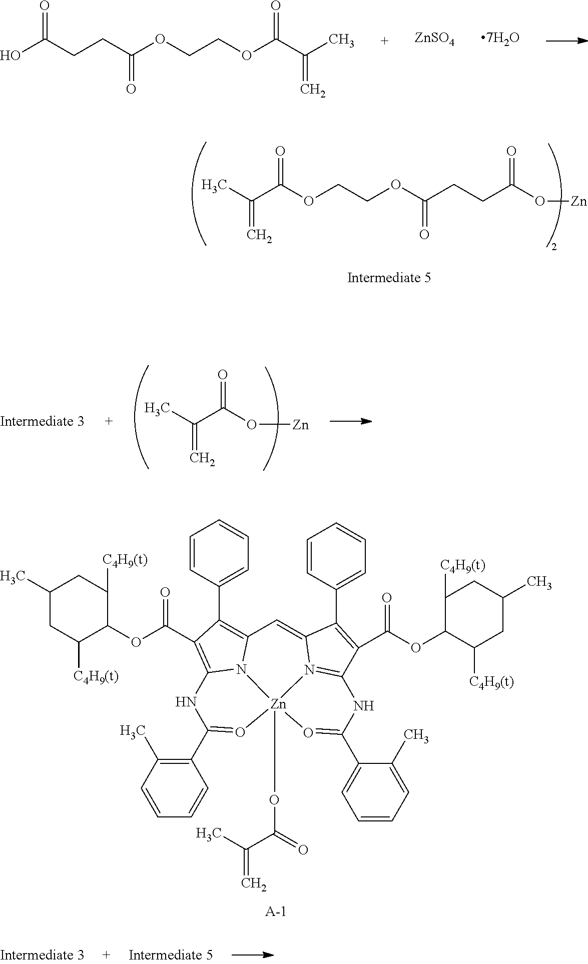

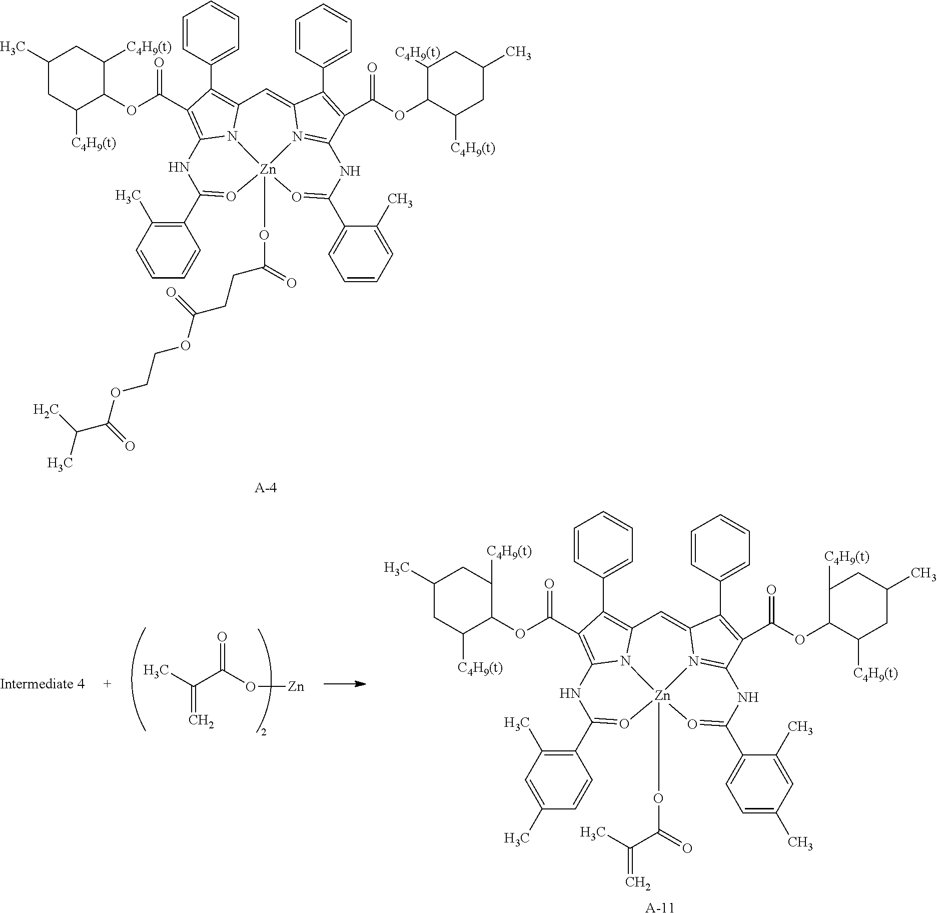

### Synthesis of Intermediate 1

Intermediate 1 was synthesized according to the method described in U.S. Patent Application Publication No. 2008/0076044.

Intermediate 2 to intermediate 5, and exemplary compounds A-1, A-4, and A-11 were synthesized as follows.

### Synthesis of Intermediate 2

1 L of toluene was added to 184.77 g (0.45 mol) of intermediate 1 obtained by the method described in U.S. Patent Application Publication No. 2008/0076044 and 40 g (0.27 mol) of triethyl orthoformate, and the mixture was stirred under cooling in an ice bath. To this solution, 21.62 g (0.225 mol) of methanesulfonic acid were added dropwise, and thereafter, the mixture was stirred while heating at 90° C. for 8 hours. After completion of the reaction, the solvent was distilled off, and the precipitated solids were washed with methanol, and dried. In this way, 152.3 g (yield: 73%) of intermediate 2 were obtained.

Note that, the ¹H-NMR data were as follows. Namely, ¹H-NMR (CDCl₃) was δ: 11.63 (br, 2H), 7.48 (br, 4H), 7.30-7.02 (m, 5H), 7.02-6.99 (m, 5H), 5.84 (s, 2H), 5.73 (s, 1H), 3.00 (s, 3H), 1.25-1.19 (m, 6H), 0.99-0.95 (m, 4H), 0.78 (s, 36H), 0.64 (d, 6H), 0.35-0.28 (m, 4H).

### Synthesis of Intermediate 3

5.5 g (0.135 mol) of sodium hydroxide were dissolved in 20 mL of water and, to the resulting liquid, 20 mL of toluene and 4.6 g (5 mmol) of intermediate 2 were added, and the mixture was stirred at 50° C. To this solution, 1.7 g (11 mmol) of o-toluoyl chloride were added dropwise, and the mixture was stirred at 50° C. for 5 hours. After completion of the reaction, the aqueous layer was removed, and the reaction liquid was washed three times with 20 mL of a 10% aqueous solution of sodium hydroxide, followed by washing once with water. Subsequently, to this solution, 20 mL of acetonitrile were added, and the mixture was stirred for two hours, and then the resulting solids were filtrated and dried. In this way, 2.5 g (yield: 47%) of intermediate 3 were obtained.

Note that, the ¹H-NMR data were as follows. Namely, ¹H-NMR (CDCl₃) was δ: 11.10 (s, 2H), 7.72 (d, 2H), 7.39-7.13 (m, 16H), 6.12 (s, 1H), 5.85 (s, 2H), 2.70 (s, 6H), 1.29-1.08 (m, 6H), 1.02-0.92 (m, 4H), 0.80 (s, 36H), 0.64 (d, 6H), 0.44-0.31 (m, 4H).

### Synthesis of Intermediate 4

8 mL of toluene and 0.79 g (11 mmol) of dimethylformamide were added to 1.65 g (11 mmol) of 2,4-dimethylbenzoic acid, and the mixture was stirred at room temperature. To this solution, 1.3 g (11 mmol) of thionyl chloride were added dropwise, and the mixture was stirred at 50° C. for one hour, thereby obtaining reaction liquid A. Subsequently, 5.5 g (0.135 mol) of sodium hydroxide were dissolved in 20 mL of water, and then, to the resulting liquid, 12 mL of toluene and 4.6 g (5 mmol) of intermediate 2 were added, and the mixture was stirred at room temperature. To this solution, reaction liquid A which had been previously prepared was added dropwise, and the mixture was stirred at room temperature for 10 hours. After completion of the reaction, the aqueous layer was removed, and the reaction liquid was washed three times with 20 mL of a 10% aqueous solution of sodium hydroxide, followed by washing once with water. Subsequently, to this solution, 20 mL of acetonitrile were added, and the mixture was stirred for two hours, and the resulting solids were filtrated and dried. In this way, 2.1 g (yield: 38%) of intermediate 4 were obtained.

Note that, the ¹H-NMR data were as follows. Namely, ¹H-NMR (CDCl₃) was δ: 11.14 (s, 2H), 7.67 (d, 2H), 7.31-7.12 (m, 14H), 6.12 (s, 1H), 5.87 (s, 2H), 2.71 (s, 6H), 2.40 (s, 6H), 1.28-1.12 (m, 6H), 1.01-0.96 (m, 4H), 0.82 (s, 36H), 0.66 (d, 6H), 0.45-0.33 (m, 4H).

### Synthesis of Intermediate 5

25.32 g (0.11 mol) of LIGHT ESTER HO-MS (manufactured by Kyoeisha Chemical Co., Ltd.) were added to 20 mL of methanol, and the mixture was stirred at room temperature. Subsequently, to the resulting liquid, a liquid obtained by dissolving 14.38 g (0.05 mol) of zinc sulfate 7 hydrate in 100 mL of water was added, and the mixture was stirred at room temperature, and thereafter, 19.3 g (0.1 mol) of a 28% methanol solution of sodium methoxide were further added thereto dropwise, and the mixture was stirred at room temperature for two hours. After completion of stirring, the resulting precipitates were separated by filtration, and the resulting residue was washed with water and dried. In this way, 6 g (yield: 23%) of intermediate 5 were obtained.

Note that, the ¹H-NMR data were as follows. Namely, ¹H-NMR (CDCl₃) was δ: 6.13 (s, 2H), 5.60 (s, 2H), 4.36-4.34 (m, 8H), 2.67-2.65 (m, 8H), 1.95 (s, 6H).

(Synthesis of Exemplary Compound A-1)

To 30 mL of tetrahydrofuran, 5.3 g (5 mmol) of intermediate 3 and 1.3 g (5.5 mmol) of zinc methacrylate were added, and the mixture was stirred at room temperature for 3 hours. Subsequently, 100 mL of methanol were added thereto, and the mixture was stirred at room temperature for 12 hours. After completion of stirring, the resulting precipitates were separated by filtration, and the resulting residue was washed with methanol and then dried. In this way, 4.5 g (yield 74%) of exemplary compound A-1 were obtained.

Note that, the ¹H-NMR data were as follows. Namely, ¹H-NMR (CDCl₃) was δ: 11.58 (s, 2H), 7.7 (d, 2H), 7.46-7.15 (m, 16H), 6.35 (s, 1H), 5.92-5.91 (m, 1H), 5.87 (s, 2H), 5.26-5.24 (s, 1H), 2.71 (s, 6H), 1.93 (s, 3H), 1.25-1.16 (m, 6H), 1.0-0.96 (m, 4H), 0.81 (d, 36H), 0.66 (d, 6H), 0.56-0.25 (m, 4H).

Further, with regard to the obtained compound, a molar absorption coefficient (∈) in an ethyl acetate solution was measured using a spectrophotometer UV-1800PC (manufactured by Shimadzu Corporation), and further, the absorbance (Abs) at the maximum absorption wavelength (λmax) was normalized to 1.0 and the absorbance at 450 nm was evaluated. The maximum absorption wavelength λmax of the exemplary compound A-1 was 558 nm and the molar absorption coefficient (∈) was 148000. The results of absorbance (Abs value), maximum absorption wavelength λmax, and molar absorption coefficient (∈) are shown in Table 1 below.

(Synthesis of Exemplary Compound A-4)

To 50 mL of tetrahydrofuran, 5.3 g (5 mmol) of intermediate 3 and 4.2 g (8 mmol) of intermediate 5 were added, and the mixture was stirred under room temperature for 3 hours. Subsequently, 100 mL of methanol were added thereto, and the mixture was stirred at room temperature for 12 hours. After completion of stirring, the solvent was distilled off, and the obtained solids were washed with methanol and then dried. In this way, 2.8 g (yield 41%) of exemplary compound A-4 were obtained.

Note that, the ¹H-NMR data were as follows. Namely, ¹H-NMR (CDCl₃) was δ: 11.62 (s, 2H), 7.74 (d, 2H), 7.49-7.16 (m, 16H), 6.37 (s, 1H), 6.12 (s, 1H), 5.89 (s, 2H), 5.57 (s, 1H), 4.29-4.28 (m, 4H), 2.73 (s, 6H), 2.64-2.63 (m, 4H), 1.93 (s, 3H), 1.25-1.18 (m, 6H), 1.02-0.98 (m, 4H), 0.82 (d, 36H), 0.68 (d, 6H), 0.58-0.27 (m, 4H).

Further, in a manner similar to that in the exemplary compound A-1, the maximum absorption wavelength λmax and the molar absorption coefficient (∈) were measured and, as a result, the maximum absorption wavelength λmax of the exemplary compound A-4 was 558 nm and the molar absorption coefficient (∈) was 136000.

(Synthesis of Exemplary Compound A-11)

To 30 mL of tetrahydrofuran, 6.6 g (6 mmol) of intermediate 4 and 1.6 g (6.6 mmol) of zinc methacrylate were added, and the mixture was stirred under room temperature for 3 hours. Subsequently, 100 mL of methanol were added thereto, and the mixture was stirred at room temperature for 12 hours. After completion of stirring, the resulting precipitates were separated by filtration, and the resulting residue was washed with methanol and then dried. In this way, 5.4 g (yield 72%) of exemplary compound A-11 were obtained.

Note that, the ¹H-NMR data were as follows. Namely, ¹H-NMR (CDCl₃) was δ: 11.57 (s, 2H), 7.61 (d, 2H), 7.28-7.12 (m, 14H), 6.33 (s, 1H), 5.87-5.86 (m, 3H), 5.24 (s, 1H), 2.68 (s, 6H), 2.38 (s, 6H), 1.91 (s, 3H), 1.27-1.16 (m, 6H), 0.99-0.96 (m, 4H), 0.83 (s, 18H), 0.77 (s, 18H), 0.65 (d, 6H), 0.55-0.43 (m, 2H), 0.32-0.20 (m, 2H).

Further, in a manner similar to that in the exemplary compound A-1, the maximum absorption wavelength λmax and the molar absorption coefficient (∈) were measured and, as a result, the maximum absorption wavelength λmax of the exemplary compound A-11 was 560 nm and the molar absorption coefficient (∈) was 134000.

### Synthesis Example 2

Further, exemplary compounds (dipyrromethene metal complex compounds and tautomers thereof) shown in Table 1 were synthesized according to the method similar to that shown in the reaction scheme in Example 1, and identification and measurements of maximum absorption wavelength λmax and molar absorption coefficient (∈) were carried out in a manner similar to that in Example 1. The measurement results are shown in Table 1 together with the results of Synthesis Example 1.

TABLE 1

| | | | Abs Value at 450 nm |
|---|---|---|---|
| Exemplary | | λmax | when normalized to |
| Compound | ε | (nm) | Abs = 1.0 at λmax |
| A-1 | 148000 | 558 | 0.006 |
| A-2 | 132000 | 558 | 0.009 |
| A-3 | 137000 | 558 | 0.006 |
| A-4 | 136000 | 558 | 0.007 |
| A-5 | 135000 | 558 | 0.007 |
| A-6 | 131000 | 558 | 0.010 |
| A-7 | 134000 | 558 | 0.013 |
| A-8 | 132000 | 558 | 0.015 |
| A-9 | 135000 | 558 | 0.012 |
| A-11 | 134000 | 560 | 0.011 |
| A-12 | 138000 | 560 | 0.014 |
| A-13 | 136000 | 560 | 0.008 |
| A-16 | 136000 | 560 | 0.012 |
| A-19 | 132000 | 555 | 0.026 |
| A-21 | 137000 | 559 | 0.016 |
| A-25 | 133000 | 558 | 0.013 |
| A-31 | 129000 | 563 | 0.026 |
| A-34 | 132000 | 565 | 0.013 |
| A-39 | 144000 | 571 | 0.031 |
| A-46 | 125000 | 561 | 0.024 |
| A-47 | 123000 | 558 | 0.013 |
| A-57 | 130000 | 556 | 0.025 |

From the results shown in Table 1, it was understood that the specific metal complex compounds of the present invention exhibited high molar absorption coefficient (∈) and, at the same time, low absorbance at 450 nm, and excellent color separation, and are compounds suitable for a color filter.

Hereinafter, examples and comparative examples for producing a colored composition and a color filter are described.

### Example 1

First, each of the components used for preparing a colored composition are shown below.

(S-1) a pigment dispersion liquid obtained by mixing 12.8 parts of C. I. Pigment Blue 15:6, 7.2 parts of acryl-based pigment dispersant, and 80.0 parts of propylene glycol monomethyl ether acetate, and then sufficiently dispersing the pigment using a bead mill

(T-1) a polymerizable compound: KAYARAD DPHA (manufactured by Nippon Kayaku Co., Ltd.; dipentaerythritol hexaacrylate)

(U-1) a binder resin: a propylene glycol monomethyl ether acetate solution (solid content of 40.0% by mass) of a benzyl methacrylate/methacrylic acid (75/25 [mass ratio]) copolymer (weight average molecular weight: 12,000)

(V-1) a photopolymerization initiator:

2-(benzoyloxyimino)-1-[4-(phenylthio)phenyl]-1-octanone

(V-2) a photopolymerization initiator:

2-(acetoxyimino)-4-(4-chlorophenylthio)-1-[9-ethyl-6-(2-methylbenzoyl)-9H-carbazol-3-yl]-1-butanone

(W-1) a photosensitizer: 4,4′-bis(diethylamino)benzophenone

(X-1) an organic solvent: propylene glycol monomethyl ether acetate

(X-2) an organic solvent: ethyl 3-ethoxypropionate

(Y-1) a surfactant: MEGAFACE F781-F (manufactured by DIC Corporation)

—Preparation of Colored Composition (Coating Liquid)—

The components of the following composition were mixed, thereby preparing colored composition 1.

<Composition>

| | | |
|---|---|---|
| Dipyrromethene metal complex | 6.9 | parts |
| compound: exemplary compound A-1 | | |
| Pigment dispersion liquid: (S-1) | 43.0 | parts |
| Polymerizable compound: (T-1) | 103.4 | parts |
| Binder resin: (U-1) | 212.2 | parts |
| (in terms of solid content: 84.9 parts) | | |
| Photopolymerization initiator: (V-1) | 21.2 | parts |
| Photosensitizer: (W-1) | 3.5 | parts |
| Organic solvent: (X-1) | 71.9 | parts |
| Organic solvent: (X-2) | 3.6 | parts |
| Surfactant: (Y-1) | 0.06 | parts |

—Preparation of Color Filter Using the Colored Composition and Evaluation—

A glass substrate (1737, manufactured by Corning Inc.) having a size of 100 mm×100 mm was coated with the colored composition (color resist liquid) obtained as described above, such that the x value which is an index of color concentration was 0.150, and was dried in an oven at 90° C. for 60 seconds (prebaking). Thereafter, exposure was performed at 200 mJ/cm² (illuminance of 20 mW/cm²) using a high pressure mercury lamp through a photo-mask for resolution evaluation having a mask hole width of from 10 μm to 100 μm, then the coated film after exposure was developed with a 1% aqueous solution of alkali developing solution CDK-1 (manufactured by FUJIFILM Electronic Materials Co., Ltd.), and then the developing solution was washed away by spraying pure water like a shower. Then, the coated film that had been subjected to exposure and development as described above was subjected to heating treatment (post-baking) in an oven at 220° C. for one hour, to form a colored pattern (colored layer) for a color filter on the glass substrate, whereby colored filter substrate 1 (color filter 1) was prepared.

—Evaluation—

With regard to color filter 1 obtained as described above, the following evaluation was performed. The evaluation results are shown in Table 2.

<1. Heat Resistance>

As a heat resistance test, the color filter 1 was heated at 230° C. for 30 minutes using a hot plate, and the color difference, ΔE*ab value, between before and after the heat resistance test was measured using a chromaticity meter MCPD-1000 (manufactured by Otsuka Electronics Co., Ltd.), and evaluation was performed according to the following criteria. The smaller ΔE*ab value indicates that the heat resistance is better.

<Evaluation Criteria>

5: ΔE*ab value <3

4: 3≦ΔE*ab value <5

3: 5≦ΔE*ab value <10

2: 10≦ΔE*ab value <20

1: 20≦ΔE*ab value

<2. Light Resistance>

As a light resistance test, the color filter 1 was irradiated with light of 50,000 lux for 20 hours (equivalent to 1000,000 lux·h) using a xenon lamp, and the color difference, ΔE*ab value, between before and after the light resistance test was measured. The smaller ΔE*ab value indicates that the light resistance is better.

<Evaluation Criteria>

5: ΔE*ab value <3

4: 3≦ΔE*ab value <5

3: 5≦ΔE*ab value <10

2: 10≦ΔE*ab value <20

1: 20≦ΔE*ab value

<3. Brightness>

The brightness of the color filter 1 was measured using a microscopic spectrophotometer OSP-SP200 manufactured by Olympus Optics Corporation, and the brightness was evaluated by Y value. The higher Y value indicates better performance as a color filter for a liquid crystal display device.

<4. Voltage Holding Ratio>

A glass substrate with ITO electrode (trade name: 1737, manufactured by Corning Inc.) was coated with the colored composition 1 such that the dry thickness after drying was 2.0 μm, and was dried in an oven at 90° C. for 60 seconds (prebaking). Thereafter, exposure of 100 mJ/cm² (illuminance: 20 mW/cm²) was performed without using a mask, then development was performed at 25° C. using a 1% aqueous solution of alkali developing solution (trade name: CDK-1, manufactured by FUJIFILM Electronic Materials Co., Ltd.), and then the coated film that had been washed and dried was subjected to heating treatment (post-baking) in an oven at 230° C. for 30 minutes. Subsequently, this substrate with pixels formed thereon and a substrate on which an ITO electrode is merely vapor deposited in a predetermined shape were bonded together using a sealing agent mixed with glass beads having a size of 5 μm, and then, liquid crystal MJ971189 (trade name) manufactured by Merck Ltd. was injected to prepare a liquid crystal cell.

Then, the liquid crystal cell was placed in a constant temperature bath at 70° C. for 48 hours, and thereafter, the voltage holding ratio of the liquid crystal cell was measured using a liquid crystal voltage holding ratio measuring system VHR-1A type (trade name) manufactured by Toyo Corporation.

The lower voltage holding ratio of the liquid crystal cell means that the liquid crystal cell cannot maintain the applied voltage at a predetermined level for a period of 16.7 msec, and that the orientation of liquid crystals cannot be achieved sufficiently.

The higher mark indicates that the voltage holding ratio is better.

<Measurement Conditions>
Distance between electrodes: 5 μm to 15 μm
Pulse amplitude of applied voltage: 5V
Pulse frequency of applied voltage: 60 Hz
Pulse width of applied voltage: 16.67 msec
Voltage holding ratio: potential difference in liquid crystal cell after 16.7 msec/the value of voltage applied at 0 msec×100(%)

<Evaluation Criteria>

5: 90% or higher

4: 85% or higher but lower than 90%

3: 80% or higher but lower than 85%

2: 75% or higher but lower than 80%

1: less than 75%

### Examples 2 to 22

Color filters 2 to 22 were prepared in a manner similar to that in Example 1, except that the exemplary compound A-1 was replaced with the above-described exemplary compound (dipyrromethene metal complex compound) shown in Table 2, and the ratio of the amount of the exemplary compound to the amount of the pigment dispersion liquid (S-1) was adjusted to adjust the chromaticity.

### Example 23

Color filter 23 was obtained in a manner similar to that in Example 1, except that the components of the following composition were mixed to prepare colored composition 23, and the colored composition 23 was used instead of using the colored composition 1.

<Composition>

| | | |
|---|---|---|
| Dipyrromethene metal complex | 6.9 | parts |
| compound: exemplary compound A-1 | | |
| Pigment dispersion liquid: (S-1) | 43.0 | parts |
| Polymerizable compound: (T-1) | 103.4 | parts |
| Binder resin: (U-1) | 212.2 | parts |
| (in terms of solid content: 84.9 parts) | | |
| Photopolymerization initiator: (V-2) | 21.2 | parts |
| Photosensitizer: (W-1) | 3.5 | parts |
| Organic solvent: (X-1) | 71.9 | parts |
| Organic solvent: (X-2) | 3.6 | parts |
| Surfactant: (Y-1) | 0.06 | parts |

### Examples 24 to 26

Color filters 24 to 26 were obtained in a manner similar to that in Example 23, except that the exemplary compound A-1 used in the preparation of colored composition 23 was replaced with the above-described exemplary compound (dipyrromethene metal complex compound) shown in Table 2, and the ratio of the amount of the exemplary compound to the amount of the pigment dispersion liquid (S-1) was adjusted to adjust the chromaticity.

### Example 27

Color filter 27 was obtained in a manner similar to that in Example 1, except that the components of the following composition were mixed to prepare colored composition 27, and the colored composition 27 was used instead of using the colored composition 1.

<Composition>

| | |
|---|---|
| Dipyrromethene metal complex compound: exemplary | 4.7 parts |
| compound A-1 | |
| Pigment dispersion liquid: (S-1) | 42.1 parts |
| Compound (5) described below | 2.3 parts |
| Polymerizable compound: (T-1) | 103.4 parts |
| Binder resin: (U-1) | 212.2 parts |
| (in terms of solid content: 84.9 parts) | |
| Photopolymerization initiator: (V-2) | 21.2 parts |
| Photosensitizer: (W-1) | 3.5 parts |
| Organic solvent: (X-1) | 71.9 parts |
| Organic solvent: (X-2) | 3.6 parts |
| Surfactant: (Y-1) | 0.06 parts |

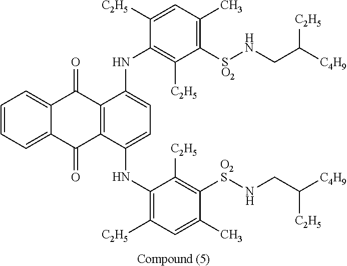

### Example 28

Color filter 28 was obtained in a manner similar to that in Example 27, except that the exemplary compound A-1 used in the preparation of colored composition 27 was replaced with exemplary compound A-11.

### Comparative Examples 1 to 4

Color filters were obtained in a manner similar to that in Example 1, except that the exemplary compound A-1 used in the preparation of colored composition 1 was replaced with the comparative compound shown in Table 2, and the ratio of the amount of the comparative compound to the amount of the pigment dispersion liquid (S-1) was adjusted to adjust the chromaticity.

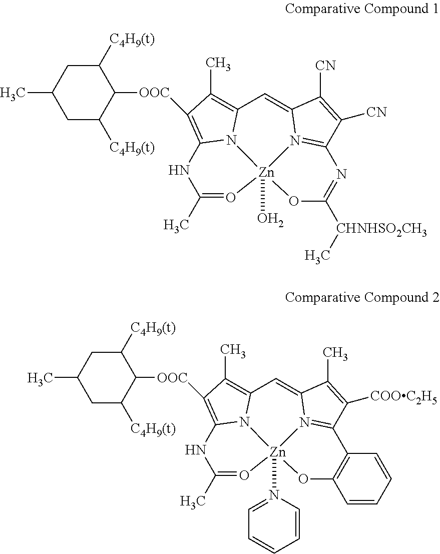

(compound described in JP-A No. 2008-292970)

### Comparative Example 5

A color filter was obtained in a manner similar to that in Example 23, except that the exemplary compound A-2 used in the preparation of colored composition 23 was replaced with C. I. Acid Violet 17.

### Comparative Example 6

A color filter was obtained in a manner similar to that in Example 27, except that the exemplary compound A-3 used in the preparation of colored composition 27 was replaced with C. I. Acid Violet 49.

Using each of the color filters obtained in Examples 2 to 28 and Comparative Examples 1 to 6, evaluation was performed similar to Example 1, and the results are summarized and shown in Table 2.

TABLE 2

| | Exemplary | | | | |
|---|---|---|---|---|---|
| | Compound | | | | Voltage |
| | or Comparative | Heat | Light | | Holding |
| | Compound | Resistance | Resistance | Y Value | Ratio |
| Example 1 | A-1 | 5 | 5 | 10.6 | 5 |
| Example 2 | A-2 | 4 | 5 | 10.5 | 5 |
| Example 3 | A-3 | 5 | 5 | 10.6 | 5 |
| Example 4 | A-4 | 5 | 5 | 10.6 | 5 |
| Example 5 | A-5 | 5 | 5 | 10.6 | 4 |
| Example 6 | A-6 | 4 | 5 | 10.5 | 4 |
| Example 7 | A-7 | 5 | 5 | 10.4 | 5 |
| Example 8 | A-8 | 4 | 5 | 10.4 | 4 |
| Example 9 | A-9 | 5 | 5 | 10.5 | 4 |
| Example 10 | A-11 | 5 | 5 | 10.8 | 5 |
| Example 11 | A-12 | 5 | 5 | 10.7 | 5 |
| Example 12 | A-13 | 4 | 5 | 10.7 | 5 |
| Example 13 | A-16 | 5 | 5 | 10.8 | 5 |
| Example 14 | A-19 | 4 | 5 | 10.3 | 5 |
| Example 15 | A-21 | 5 | 5 | 10.5 | 5 |
| Example 16 | A-25 | 5 | 5 | 10.6 | 5 |
| Example 17 | A-31 | 5 | 5 | 10.2 | 5 |
| Example 18 | A-34 | 5 | 5 | 10.3 | 5 |
| Example 19 | A-39 | 5 | 5 | 10.1 | 5 |
| Example 20 | A-46 | 5 | 5 | 10.6 | 5 |
| Example 21 | A-47 | 4 | 5 | 10.7 | 5 |
| Example 22 | A-57 | 4 | 5 | 10.6 | 5 |
| Example 23 | A-1 | 5 | 5 | 10.6 | 5 |
| Example 24 | A-3 | 5 | 5 | 10.6 | 5 |
| Example 25 | A-4 | 5 | 5 | 10.6 | 5 |
| Example 26 | A-11 | 5 | 5 | 10.8 | 5 |
| Example 27 | A-1 | 5 | 5 | 10.6 | 5 |
| Example 28 | A-11 | 5 | 5 | 10.7 | 5 |
| Comparative | C.I. Acid Violet | 4 | 4 | 8.7 | 1 |
| Example 1 | 17 | | | | |
| Comparative | C.I. Acid Violet | 2 | 1 | 8.5 | 1 |
| Example 2 | 49 | | | | |
| Comparative | Comparative | 4 | 4 | 9.9 | 2 |
| Example 3 | Compound 1 | | | | |
| Comparative | Comparative | 4 | 4 | 9.8 | 2 |
| Example 4 | Compound 2 | | | | |
| Comparative | C.I. Acid Violet | 4 | 4 | 8.6 | 1 |
| Example 5 | 17 | | | | |
| Comparative | C.I. Acid Violet | 2 | 1 | 8.3 | 1 |
| Example 6 | 49 | | | | |

As shown in Table 2, with regard to the brightness (Y value), a great effect on improvement beyond expectation was recognized in Examples 1 to 28, as compared to the comparative examples (Comparative Examples 1 to 2, and 5 to 6) using conventionally known compounds. Further, it was possible to maintain a higher voltage holding ratio in Examples 1 to 28, as compared to the conventionally known dipyrromethene metal complex compounds (Comparative Examples 3 and 4). There has been a problem in that the conventionally known dipyrromethene metal complex compounds exhibit a low voltage holding ratio, since the compounds have a weak coordination force and easily dissociate electrically; however, the dipyrromethene metal complex compounds according to the present invention exhibited a high voltage holding ratio, so that it can be said that the dipyrromethene metal complex compounds are more versatile dyes.

<5. Contrast>

Further, with regard to the colored patterns (colored cured films) obtained in Examples 1, 10, 27, and 28 and Comparative Examples 1 to 4, the contrast and brightness were evaluated according to the following method. Namely, the colored pattern obtained was placed between two sheets of polarizing film, and the values of brightness in a case in which the polarization axes of the two sheets of polarizing film were parallel and in a case in which the polarization axes were perpendicular to each other were measured using a color brightness meter (manufactured by Topcon Corp., model number: BM-5A), and the value obtained by dividing the brightness in a case in which the polarization axes of the two sheets of polarizing film were parallel by the brightness in the case of being parallel to each other was determined as the contrast. The higher contrast indicates better performance as a color filter for a liquid crystal display device. The results are shown in Table 3.

TABLE 3

| | Exemplary Compound | |
|---|---|---|
| | or Comparative Compound | Contrast |
| Example 1 | A-1 | 22000 |
| Example 10 | A-11 | 22000 |
| Example 27 | A-1 | 24000 |
| Example 28 | A-11 | 24500 |
| Comparative Example 1 | C.I. Acid Violet 17 | 16000 |
| Comparative Example 2 | C.I. Acid Violet 49 | 15000 |
| Comparative Example 3 | Comparative compound 1 | 18000 |
| Comparative Example 4 | Comparative compound 2 | 18000 |

As shown in Table 3, also with regard to the contrast, a great effect on improvement was recognized in the colored patterns obtained in Examples 1, 10, 27, and 28, as compared to the comparative examples (Comparative Examples 1 to 4) using conventionally known compounds.

The disclosure of Japanese Patent Application No. 2011-082425 filed on Apr. 4, 2011 is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. A colored composition, comprising at least one selected from the group consisting of a compound represented by the following Formula (I) and a tautomer thereof: 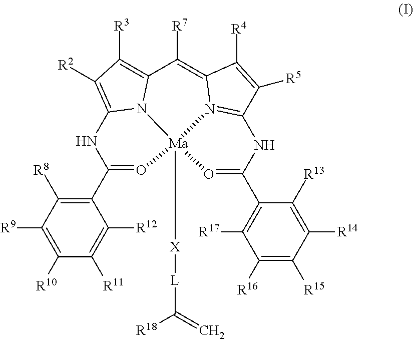
wherein, in Formula (I), R² to R⁵ and R⁸ to R¹⁷ each independently represent a hydrogen atom or a monovalent substituent; pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring; R⁷ represents a hydrogen atom, a halogen atom, an alkyl group, an aryl group, or a heterocyclic group; Ma represents a metal or a metal compound; X represents a group necessary for neutralizing the charge of Ma; L represents a single bond or a divalent linking group; and R¹⁸ represents a hydrogen atom or a methyl group.

2. The colored composition according to claim 1, wherein Ma in Formula (I) represents Fe, Zn, Co, V═O, or Cu.

3. The colored composition according to claim 1, further comprising a polymerizable compound and a photopolymerization initiator.

4. The colored composition according to claim 1, further comprising a pigment or an anthraquinone compound, or both a pigment and an anthraquinone compound.

5. The colored composition according to claim 4, wherein the anthraquinone compound is a compound represented by the following Formula (IX): 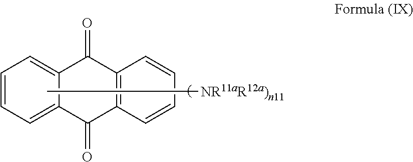
wherein, in Formula (IX), R^{11a} and R^{12a} each independently represent a hydrogen atom, an alkyl group, an aryl group, or a heterocyclic group; R^{11a} and R^{12a} do not represent a hydrogen atom at the same time; and n¹¹ represents an integer of from 1 to 4.

6. The colored composition according to claim 1, wherein the content of the at least one selected from the group consisting of a compound represented by Formula (I) and a tautomer thereof is from 0.1% by mass to 30% by mass with respect to the total solid content of the colored composition.

7. The colored composition according to claim 2, further comprising a polymerizable compound and a photopolymerization initiator.

8. The colored composition according to claim 2, further comprising a polymerizable compound; a photopolymerization initiator; and a pigment or an anthraquinone compound or both a pigment and an anthraquinone compound.

9. The colored composition according to claim 2, further comprising a polymerizable compound; a photopolymerization initiator; and a pigment or an anthraquinone compound or both a pigment and an anthraquinone compound,
wherein the anthraquinone compound is a compound represented by the following Formula (IX): 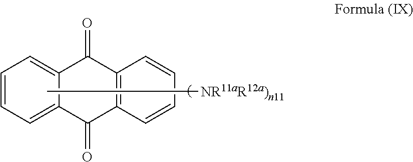
wherein, in Formula (IX), R^{11a} and R^{12a} each independently represent a hydrogen atom, an alkyl group, an aryl group, or a heterocyclic group; R^{11a} and R^{12a} do not represent a hydrogen atom at the same time; and n¹¹ represents an integer of from 1 to 4.

10. The colored composition according to claim 2, further comprising a polymerizable compound; a photopolymerization initiator; and a pigment or an anthraquinone compound or both a pigment and an anthraquinone compound,
wherein the anthraquinone compound is a compound represented by the following Formula (IX): 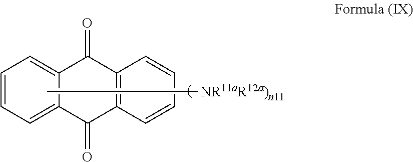
wherein, in Formula (IX), R^{11a} and R^{12a} each independently represent a hydrogen atom, an alkyl group, an aryl group, or a heterocyclic group; R^{11a} and R^{12a} do not represent a hydrogen atom at the same time; and n¹¹ represents an integer of from 1 to 4, and
wherein the content of the at least one selected from the group consisting of a compound represented by Formula (I) and a tautomer thereof is from 0.1% by mass to 30% by mass with respect to the total solid content of the colored composition.

11. A compound represented by the following Formula (I) or a tautomer thereof: 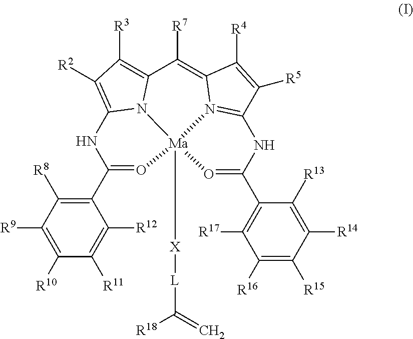
wherein, in Formula (I), R² to R⁵ and R⁸ to R¹⁷ each independently represent a hydrogen atom or a monovalent substituent; pairs of R² and R³, R⁴ and R⁵, R⁸ and R⁹, R⁹ and R¹⁰, R¹⁰ and R¹¹, R¹¹ and R¹², R¹³ and R¹⁴, R¹⁴ and R¹⁵, R¹⁵ and R¹⁶, and R¹⁶ and R¹⁷ may each independently bond to each other to form a 5-membered, 6-membered, or 7-membered saturated ring or unsaturated ring; R⁷ represents a hydrogen atom, a halogen atom, an alkyl group, an aryl group, or a heterocyclic group; Ma represents a metal or a metal compound; X represents a group necessary for neutralizing the charge of Ma; L represents a single bond or a divalent linking group; and R¹⁸ represents a hydrogen atom or a methyl group.

12. A colored cured film obtained by curing the colored composition according to claim 1.

13. A color filter, comprising the colored cured film according to claim 12.

14. A method for producing a color filter, the method comprising a process of applying the colored composition according to claim 1 onto a support to form a colored composition layer, and a process of pattern-wise exposing and developing the formed colored composition layer to form a patterned colored region.

15. A liquid crystal display device, comprising the color filter according to claim 13.

16. A liquid crystal display device, comprising a color filter produced by the method for producing a color filter according to claim 14.

17. A solid-state imaging device, comprising the color filter according to claim 13.

18. A solid-state imaging device, comprising a color filter produced by the method for producing a color filter according to claim 14.
